(19) United States
(12) Patent Application Publication
(10) Pub. No.: US 2009/0146525 A1
(43) Pub. Date: Jun. 11, 2009

(54) Commutator and direct current motor

(75) Inventors: Yoshiki Nakano, Hamamatsu-Shi (JP); Kuniaki Matsumoto, Hamamatsu-Shi (JP)

Correspondence Address: WOLF GREENFIELD & SACKS, P.C., 600 ATLANTIC AVENUE, BOSTON, MA, 02210-2206, US

(73) Assignee: Asmo Co., Ltd, Shizuoka-Ken (JP)

(21) Appl. No.: 12/069,582

(22) Filed: Feb. 11, 2008

(30) Foreign Application Priority Data
Feb. 19, 2007 (JP) JP2007-038503

(51) Int. Cl. H02K 23/38

(52) U.S. Cl. 310/234

(57) ABSTRACT

A segment center line is defined for each segment. Each segment center line extends from the center in the circumferential direction of the radially outer end of the segment to the center in the circumferential direction of the radially inner end of the segment. A portion of each segment center line where there is the center in the circumferential direction of the radially inner end is inclined in a first circumferential direction relative to the radial line. A short-circuit member has a plurality of connection pieces. Each connection piece has an outer short-circuit end, an inner short-circuit end, and a coupling portion. Each coupling portion links the outer short-circuit end to the inner short-circuit end, which is shifted in a second circumferential direction from the outer short-circuit end.

### BACKGROUND OF THE INVENTION

The present invention relates to a commutator, and the commutator has a short-circuit member for connecting segments having the same potential from among a plurality of segments. These segments extend perpendicularly to the axial direction of the commutator. Furthermore, the present invention relates to a direct-current motor provided with such a commutator.

A possible means for miniaturizing a direct-current motor is to miniaturize the commutator of the armature. The commutator has short-circuit members for connecting a plurality of segments so that they have the same potential. Japanese Laid-Open Patent Publication No. 2005-137193 discloses a short-circuit member in plate form. The short-circuit member has a plurality of segments, a plurality of outer short-circuit ends, a plurality of inner short-circuit ends, and a plurality of coupling portions. The outer short-circuit ends and the inner short-circuit ends are respectively electrically connected to the segments. Each coupling portion links one of the outer short-circuit ends to the corresponding inner short-circuit ends, which is shifted from the outer short-circuit end by a predetermined angle in the circumferential direction. The short-circuit member in plate form can be miniaturized in the axial direction, as compared to cases where leads, for example, form a short-circuit member.

The size of the short-circuit member in the above described document in the radial direction can be made substantially the same as the size of the commutator in the radial direction. In order to isolate the coupling portions from each other without fail, it is necessary to secure intervals between the respective coupling portions. Accordingly, the width of the respective coupling portions can be made small simply by reducing the size of the short-circuit member in the radial direction in order to reduce the size of the commutator in the radial direction. In this case, the value of the electrical resistance of the short-circuit member may increase.

### SUMMARY OF THE INVENTION

According to one aspect of the present invention, a commutator against which a power supplying brush slides is provided. The commutator defines an axial direction. The commutator is provided with a plurality of segments which are arranged around the axis. A first circumferential direction and a second circumferential direction, which is opposite to the first circumferential direction, are defined in terms of the circumferential direction. Each of the above described segments has a radially outer end, a radially inner end, and a sliding surface. The above described power supplying brush slides against the above described sliding surface. The above described sliding surface is perpendicular to the above described axial direction. A center line of the segment and a radial line are defined for each of the above described segments. The above described center line of each segment extends from the center of the above described radially outer end in the circumferential direction to the center of the above described radially inner end in the circumferential direction. Each of the above described radial lines extends in the radial direction and passes through the center of the above described radially outer end in the circumferential direction. A portion of the above described center line of a segment which includes the center of the above described radially inner end in the above described circumferential direction is inclined in the above described first circumferential direction relative to the above described radial line. The short-circuit member connects certain segments from among the above described number of segments so that they have the same potential. The above described short-circuit member has a plurality of connection pieces. Each of the above described connection pieces has an outer short-circuit end, an inner short-circuit end, and a coupling portion. The above described outer short-circuit end is connected to the above described radially outer end. The above described inner short-circuit end is connected to the above described radially inner end. Each of the above described coupling portions links the above described outer short-circuit end to the above described inner short-circuit end which is shifted in the above described second circumferential direction relative to the outer short-circuit end.

Furthermore, according to another aspect of the present invention, a direct-current motor is provided with a power supplying-brush and an armature. The armature includes a commutator to which power is supplied from the power supplying brush.

Other aspects and advantages of the invention will become apparent from the following description, taken in conjunction with the accompanying drawings, illustrating by way of example the principles of the invention.

### BRIEF DESCRIPTION OF THE DRAWINGS

The features of the present invention that are believed to be novel are set forth with particularity in the appended claims. The invention, together with objects and advantages thereof, may best be understood by reference to the following description of the presently preferred embodiments together with the accompanying drawings in which:

FIG. 1 is a vertical cross-sectional view of a direct-current motor in accordance with one embodiment of the present invention;

FIG. 2 is a bottom view of the segments shown in FIG. 1;

FIG. 3 is a plan view of the segments and the short-circuit members shown in FIG. 1, showing an upside-down view of FIG. 2;

FIG. 4 is a connection diagram of the direct-current motor of FIG. 1;

FIG. 5 is a vertical cross-sectional view of a direct-current motor in accordance with a first example of the present invention in FIG. 1;

FIG. 6A is an enlarged perspective view of the insulator in FIG. 5 and shows first to second holding projections;

FIG. 6B is a partly enlarged perspective view of a commutator in FIG. 5 including a conducting wire in FIG. 6A;

FIG. 7 is a cross-sectional view of the commutator taken along line A-A in FIG. 8;

FIG. 8 is a bottom elevational view of the commutator in FIG. 7;

FIG. 9 is a plan view of a plurality of segments and short-circuit units included in the commutator in FIG. 7;

FIG. 10 is a connection diagram of the direct-current motor shown in FIG. 5;

FIG. 11A is a perspective view of the short-circuit unit shown in FIG. 9;

FIG. 11B is a perspective view of a plurality of segments shown in FIG. 9;

FIG. 12 is an exploded perspective view of the commutator shown in FIG. 5 and a rotary shaft;

FIG. 13 is a plan view of a commutator in accordance with a second example of the present invention;

FIG. 14 is a bottom elevational view of the commutator in FIG. 13;

FIG. 15A is a cross-sectional view of the commutator taken along line B-B in FIG. 13;

FIG. 15B is a partly enlarged view of FIG. 15A;

FIG. 16 is an exploded perspective view of a first short-circuit group and a second short-circuit group included in the commutator in FIG. 13;

FIG. 17A is a perspective view of a short-circuit unit including a first short-circuit group and a second short-circuit group in FIG. 2;

FIG. 17B is a perspective view of a holding portion included in the commutator in FIG. 13;

FIG. 18 is a vertical cross-sectional view of a direct-current motor in accordance with a third example of the present invention;

FIG. 19 is a cross-sectional view of a line of C-C in FIG. 20;

FIG. 20 is a bottom elevational view of the commutator in FIG. 19;

FIG. 21A is a plan view of a plurality of segments and short-circuit units shown in FIG. 19;

FIG. 21B is an enlarged perspective view of the segment shown in FIG. 21A;

FIG. 22 is a perspective view of a mother member including a plurality of segments in FIG. 21B;

FIG. 23 is a perspective view of a mother member in FIG. 21B mounting the short-circuit unit in FIG. 21A;

FIG. 24 is a perspective view of a holding portion embedding the mother member and the short-circuit unit in FIG. 23 as viewed from the bottom;

FIG. 25 is a vertical cross-sectional view of an another direct-current motor;

FIG. 26 is an exploded perspective view of an armature shown in FIG. 25;

FIG. 27A is a cross-sectional view of a line of D-D in FIG. 28;

FIG. 27B is a partly enlarged view of FIG. 27A;

FIG. 28 is a bottom elevational view of the commutator in FIG. 27A;

FIG. 29A is a perspective view of a short-circuit unit shown in FIG. 27A;

FIG. 29B is a perspective view of a plurality of segments shown in FIG. 27A;

FIG. 30A is a perspective view in which a separating member shown in FIG. 27A is inverted up and down;

FIG. 30B is a partly enlarged view of the separating member in FIG. 30A;

FIG. 30C is a cross-sectional view of a line of E-E in FIG. 30A;

FIG. 31 is a wiring diagram of the direct-current motor in FIG. 25;

FIG. 32 is a plan view of a copper plate including the short-circuit unit shown in FIG. 29A;

FIG. 33 is a plan view of a short-circuit group punched from the copper plate in FIG. 32;

FIG. 34 is a perspective view of a mother member including a plurality of segments in FIG. 29A;

FIG. 35 is a perspective view of the mother member in FIG. 34 mounting the short-circuit unit in FIG. 29A;

FIG. 36 is a perspective view of the short-circuit unit and the mother member in FIG. 35 mounting the separating member in FIG. 30A so as to be inverted up and down;

FIG. 37 is a cross-sectional view of a state in which the separating member, the short-circuit unit and the mother member in FIG. 36 are embedded in a resin within a forming die;

FIG. 38 is a perspective view of a holding portion removed of the forming die in FIG. 37;

FIG. 39 is a perspective view showing a cut position of the mother member by inverting the holding portion in FIG. 38 up and down;

FIG. 40 is a perspective view showing a commutator in accordance with another example of the present invention;

FIG. 41 is an exploded perspective view of the commutator in FIG. 40;

FIG. 42 is a perspective view of a commutator in accordance with further the other example;

FIG. 43 is an exploded perspective view of the commutator in FIG. 42;

FIG. 44 is a perspective view of a commutator in accordance with another example;

FIG. 45 is a perspective view of a short-circuit unit included in the commutator in FIG. 44;

FIG. 46 is an exploded perspective view of the commutator in FIG. 44;

FIG. 47 is a perspective view of a commutator in accordance with another example;

FIG. 48 is a perspective view of a short-circuit unit and a plurality of segments included in the commutator in FIG. 47;

FIG. 49 is a cross-sectional view of a commutator in accordance with another example;

FIG. 50A is a plan view of a plurality of segments and a short-circuit unit included in the commutator in FIG. 49;

FIG. 50B is an enlarged perspective view of the segment shown in FIG. 50A;

FIG. 51 is a perspective view of a mother member including a plurality of segments in FIG. 50A;

FIG. 52 is a perspective view of the mother member in FIG. 51 mounting the short-circuit unit in FIG. 50A;

FIG. 53 is a cross-sectional view of a commutator in accordance with another example;

FIG. 54A is a plan view of a plurality of segments and a short-circuit unit included in the commutator in FIG. 53;

FIG. 54B is an enlarged perspective view of the segment shown in FIG. 54A;

FIG. 55 is a perspective view of a mother member including a plurality of segments in FIG. 54A;

FIG. 56 is a perspective view of the mother member in FIG. 55 mounting the short-circuit unit in FIG. 54A;

FIG. 57A is a partly cross-sectional view of a separating member in accordance with another example;

FIG. 57B is a partly cross-sectional view of a separating member in accordance with another example;

FIG. 58 is a perspective view of a separating member in accordance with another example;

FIG. 59A is a perspective view of a separating member in accordance with another example;

FIG. 59B is an enlarged cross-sectional view of a plurality of separating projections provided in the separating member in FIG. 59A, that is, a cross-sectional view taken along line 55B-55B in FIG. 59A;

FIG. 59C is an enlarged cross-sectional view of a separating projection in accordance with another example;

FIG. 59D is an enlarged cross-sectional view of a separating projection in accordance with another example; and

FIG. 60 is a perspective view of a separating member in accordance with another example.

### DETAILED DESCRIPTION OF THE PREFERRED EMBODIMENTS

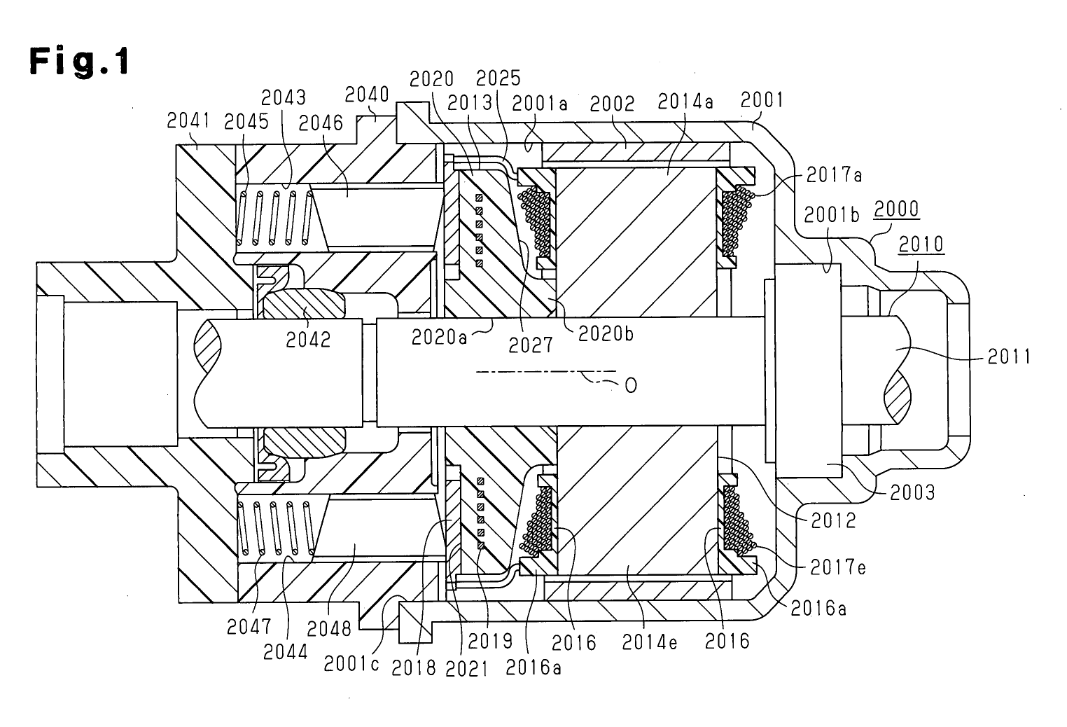

FIGS. 1 to 4 show a direct current motor 2000 according to one embodiment of the present invention.

As shown in FIG. 1, the direct current motor 2000 has a closed-end cylindrical motor housing 2001, a cylindrical brush holder 2040, and a disc-like end frame 2041, which are arranged in this order. A plurality of magnets 2002 which are aligned around the circumference are secured to the inner peripheral surface 2001a of the motor housing 2001. In these magnets 2002, six magnetic poles are formed in the circumferential direction.

The motor housing 2001 contains an armature 2010 located radially inward of the magnets 2002, so that the armature 2010 is rotatable. The armature 2010 is provided with a rotary shaft 2011, a core 2012, and a commutator 2013. The core 2012 and the commutator 2013 are respectively secured to the rotary shaft 2011 in such a manner as to be rotatable together. The core 2012 is placed close to the bottom 2001b of the motor housing 2001, and the commutator 2013 is placed close to the opening 2001c of the motor housing 2001. The brush holder 2040 is attached in the opening 2001c of the motor housing 2001. The end frame 2041 and the motor housing 2001 sandwich the brush holder 2040.

A first bearing 2003 is located at the center of the bottom 2001b of the motor housing 2001. A second bearing 2042 is located at the center of the brush holder 2040 in the radial direction. The first bearing 2003 and the second bearing 2042 support the armature 2010 in such a manner that the armature 2010 is rotatable relative to the motor housing 2001. The core 2012 faces the magnets 2002 in the radial direction.

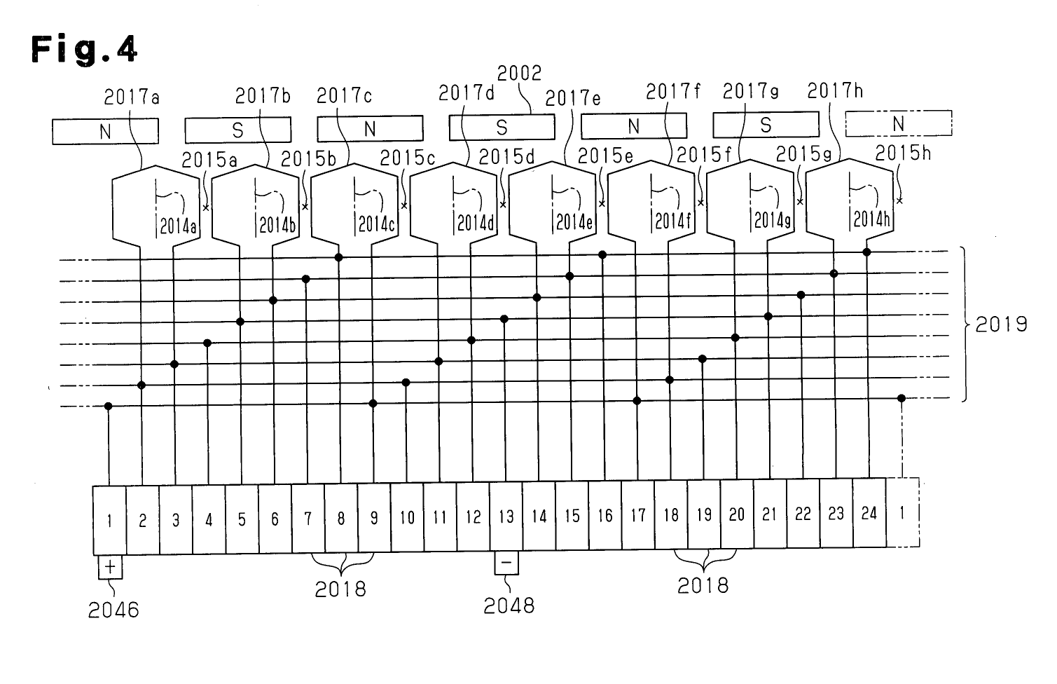

As shown in FIGS. 1 and 4, the core 2012 is provided with eight teeth 2014a to 2014h which radiate outward relative to the axis O of the rotary shaft 2011. The size of each tooth 2014a to 2014h in the circumferential direction is referred to as “width of each tooth 2014a to 2014h.” The width of each tooth 2014a to 2014h has the same value in any location in the circumferential direction. That is to say, each tooth 2014a to 2014h extends in the radial direction with a constant width.

As shown in FIG. 4, the spaces between the respective teeth 2014a to 2014h are slots 2015a to 2015h. As shown in FIG. 1, the core 2012 is coated with a pair of insulators 2016 from both sides in the axial direction. Each insulator 2016 allows the inner peripheral surface and the outer peripheral surface of the core 2012 to be exposed. Each insulator 2016 is formed of a synthetic resin material having insulating properties.

FIGS. 1 and 4 show eight coils 2017a to 2017h in total, which are wound by way of concentrated winding around the respective teeth 2014a to 2014h with the insulator 2016 in between. The coils 2017a to 2017h pass through the respective slots 2015a to 2015h.

As shown in FIG. 1, the number of times the lead 2025 is wound to form each coil 2017a to 2017h is greater toward the radially outer end of the teeth 2014a to 2014h than toward the radially inner end. That is to say, the number of layers of the lead 2025 in each coil 2017a to 2017h increases from the radially inner end to the radially outer end of the teeth. The location of the end surface of each coil 2017a to 2017h in the axial direction is referred to as “height of the end surface in the axial direction.” The height of the end surface in the axial direction of each coil 2017a to 2017h increases from the radially inner end to the radially outer end. Each insulator 2016 has a barrier 2016a which prevents the coils 2017a to 2017h from protruding radially outward. Each barrier 2016a extends from the radially outer end of the insulator 2016 in the axial direction.

As shown in FIGS. 1 to 3, the commutator 2013 is provided with twenty-four segments 2018, one short-circuit member 2019, and one support 2020. The short-circuit member 2019 connects segments 2018 which are shifted by a predetermined angle, for example, 120°, and thus, makes the segments 2018 of the same potential. The support 2020 in substantially disc-like form is made of an insulating resin material and supports the segments 2018 and the short-circuit member 2019.

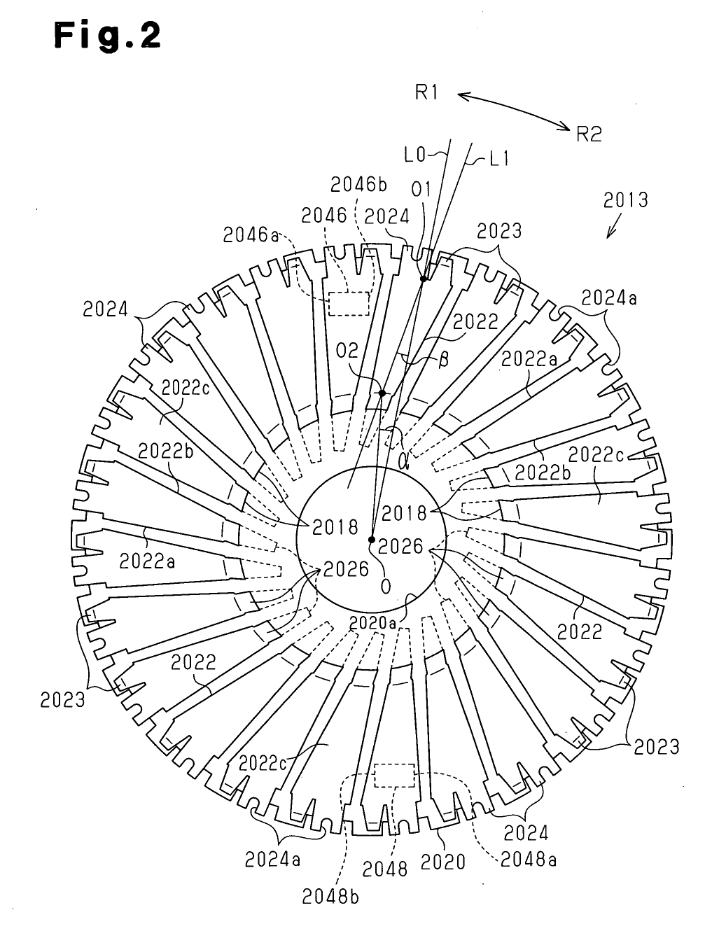

As shown in FIG. 1, the support 2020 has a coil facing surface 2027 which faces the coils 2017a to 2017h, and an opposite end surface 2021 which faces the direction opposite to the direction in which there are coils 2017a to 2017h. Each segment 2018 is placed on the opposite end surface 2021. As shown in FIG. 2, the respective segments 2018 are aligned in such a manner as to radiate outward and arranged at equal angular intervals in the circumferential direction, and thus, each extends radially outward.

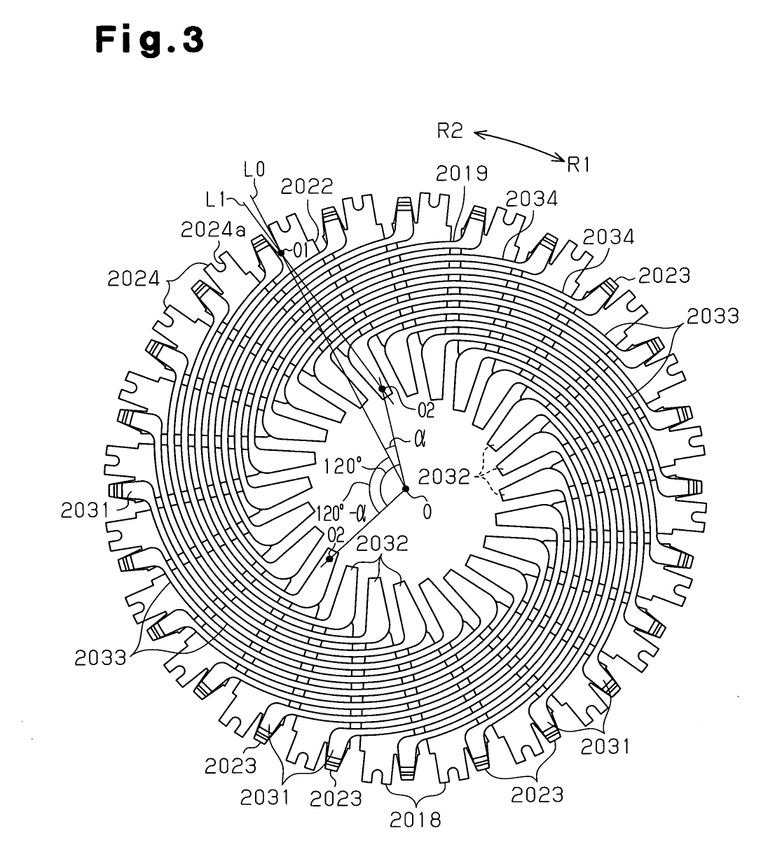

In FIG. 2, the counterclockwise direction of rotation is referred to as first circumferential direction R1, and the clockwise direction of rotation is referred to as second circumferential direction R2. FIG. 3 shows the segment 2018 as viewed from the direction opposite to the axial direction in FIG. 2, and therefore, the first circumferential direction R1 is the clockwise direction of rotation in FIG. 3, and the second circumferential direction R2 is the counterclockwise direction of rotation in FIG. 3. That is to say, FIG. 3 shows the short-circuit member 2019 and the segments 2018 as viewed from the teeth 2014a to 2014h.

As shown in FIG. 2, each segment 2018 has a main body 2022 in a substantially sectoral form as viewed in the axial direction. An outer connection portion 2023, a coil connection portion 2024, and an inner connection portion 2026 are formed in each segment main body 2022. That is to say, the segment main bodies 2022 are the portions where the outer connection portions 2023, the coil connection portions 2024 and the inner connection portions 2026 are removed from the segments 2018. Each segment main body 2022 has a flat sliding surface 2022c which faces the brush holder 2040. FIG. 2 shows the segments 2018 as viewed from the brush holder 2040, and thus, shows the sliding surfaces 2022c.

The inner connection portions 2026 are formed at the ends of the segment main bodies 2022 in the radial direction. The outer connection portions 2023 and the coil connection portions 2024 are formed at the radially outer ends of the segment main bodies 2022. The outer connection portions 2023 are located in the respective segments 2018 and in the second circumferential direction R2 of the coil connection portions 2024.

As shown in FIGS. 2 and 3, the center in the circumferential direction of the radially outer end of each segment main body 2022 is referred to as “outer center O1,” and the center in the circumferential direction of the radially inner end is referred to as “inner center O2.” The inner centers O2 of the segments 2018, which are to have the same potential, are at intervals of 120°, and the outer centers O1, which are to have the same potential, are also at intervals of 120°. The outer centers O1 are located between the outer connection portions 2023 and the coil connection portions 2024.

As shown in FIGS. 2 and 3, the respective segments 2018 are inclined in the circumferential direction. That is to say, the inner center O2 is shifted in the first circumferential direction R1 relative to outer center O1 in each segment 2018. In other words, there is an angular width α(°) relative to the axis O between the inner center O2 and the outer center O1 in each segment 2018. The angular width α can be referred to as skew angle. That is to say, the inner center O2 is shifted by an angle width α in the first circumferential direction R1 from the outer center O1.

In each segment 2018, the line which extends from the outer center O1 to the inner center O2 is referred to as “segment center line L1.” The line which extends in the radial direction from the axis O and passes through each outer center O1 is referred to as “radial line L0.” The segment center line L1 and the radial line L0 are defined for each segment 2018. The outer center O1 is shifted by an angular width α from the inner center O2; in other words, the center line L1 in each segment is inclined by an angle of inclination β(°) relative to the radial line L0. That is to say, it can be the that the portion of the segment center line L1 where the inner center O2 exists is inclined by an angle of inclination β in the first circumferential direction R1 relative to the radial line L0.

As shown in FIG. 2, each segment 2018 has an first circumferential direction end 2022a and an second circumferential direction end 2022b. The first circumferential direction end 2022a and the second circumferential direction end 2022b are the respective ends of each segment 2018 in the circumferential direction. The second circumferential direction end 2022b is located in each segment 2018 in the second circumferential direction R2 from the first circumferential direction end 2022a. The first circumferential direction end 2022a and the second circumferential direction end 2022b are respectively inclined in the circumferential direction relative to the radial line L0. The angle of inclination of the second circumferential direction end 2022b relative to the radial line L0 is wider than the angle of inclination of the first circumferential direction end 2022a relative to the radial line L0.

In more detail, the end 2022a in the first circumferential direction and the end 2022b in the second circumferential direction are respectively set so as to be inclined relative to the radial line L0 in a state where the radial line L0 passes through the center of the anode brush 2046. Likewise, the first circumferential direction end 2022a and the second circumferential direction end 2022b are respectively set so as to be inclined relative to the radial line L0 in a state where the radial line L0 passes through the center of the cathode brush 2048.

The respective outer connection portions 2023 are substantially in L shape, protrude radially outward, and after that bend and extend in the direction opposite to the sliding surface 2022c. The end of the outer connection portion 2023 is buried in the support 2020. The respective coil connection portions 2024 have connection grooves 2024a which open radially outward. The size of the connection grooves 2024a in the circumferential direction is substantially the same as the diameter of the lead 2025, and the size of the connection grooves 2024a in the radial direction is slightly greater than the diameter of the lead 2025.

Each inner connection portion 2026 extends diagonally in the direction opposite to the sliding surface 2022c, and further extends radially inward. The end of the inner connection portion 2026 is buried in the support 2020. The diameter of the imaginary circle which passes through the ends of the number of inner connection portions 2026 is greater than the diameter of the rotary shaft 2011.

As shown in FIG. 3, the short-circuit member 2019 has twenty-four connection pieces 2034. Each connection piece 2034 has an outer short-circuit end 2031, an inner short-circuit end 2032, and a coupling portion 2033. The respective outer short-circuit ends 2031 are connected to the outer connection portions 2023 of the respective segments 2018 so that the respective inner short-circuit ends 2032 are connected to the inner connection portions 2026. The respective coupling portions 2033 link the outer short-circuit ends 2031 to the inner short-circuit ends 2032, which are shifted in the second circumferential direction R2 from the outer short-circuit ends 2031. The respective coupling portions 2033 extend along involute curves. That is to say, the direction in which the respective inner short-circuit ends 2032 are shifted relative to the outer short-circuit ends 2031, that is to say, the second circumferential direction R2, is opposite to the direction in which the inner center O2 of the respective segments 2018 is inclined relative to the outer center O1, that is to say, the first circumferential direction R1, in a state where respective coupling portions 2033 link the inner short-circuit end 2032 to the outer short-circuit end 2031.

For example, in the case where the segment center lines L1 coincide with the radial lines L0, that is to say, in the case where both the angular width α and the angle of inclination β are zero, the angular width between the outer short-circuit ends 2031 and the inner short-circuit ends 2032, which are linked to the outer short-circuit ends 2031 through the coupling portions 2033, is 120°. In contrast, according to the present embodiment, the angular width between the outer short-circuit ends 2031 and the inner short-circuit ends 2032, which are linked to the outer short-circuit ends 2031 through the coupling portions 2033 is “120°−α°.” Accordingly, according to the present embodiment, the length of each coupling portion 2033 between the outer short-circuit end 2031 and the inner short-circuit end 2032 is shorter by the angular width α.

As shown in FIG. 1, portions of the segments 2018 and the short-circuit member 2019 are buried in the support 2020, which thus integrate all of the segments 2018 with the short-circuit member 2019. The support 2020 holds segments 2018, excluding predetermined segments 2018, adjacent connection pieces 2034 of the short-circuit member 2019 and the segments 2018 and coupling portions 2033 and prevents them from short-circuiting.

The outer diameter of the support 2020 is substantially the same as the diameter of an imaginary circle which passes through the respective coil connection portions 2024, greater than the inner diameter of the magnet 2002, and smaller than the inner diameter of the motor housing 2001. The outer diameter of the short-circuit member 2019 is greater than the inner diameter of the magnet 2002 and smaller than the inner diameter of the motor housing 2001. The support 2020 supports the respective segments 2018 in a state where the sliding surface 2022c of the respective segments 2018 is exposed.

As shown in FIG. 1, the center of the support 2020 in the radial direction has a hole for insertion 2020a which penetrates through the support 2020 in the axial direction, and a boss 2020b which surrounds the hole for insertion 2020a. The diameter of the hole for insertion 2020a is equal to or slightly smaller than the outer diameter of the rotary shaft 2011. The boss 2020b is in cylindrical form and extends toward the core 2012 in the axial direction.

As shown in FIG. 1, the height of the surface 2027 which faces the support 2020 in the axial direction increases inward from the outside in the radial direction.

As shown in FIG. 4, segment numbers “1” to “24” are attached to the twenty-four segments 2018 in sequence in the circumferential direction. The respective coils 2017a to 2017h are connected to these segments 2018. The two ends of the coil 2017a are respectively connected to the segments 2018 that are adjacent in the circumferential direction and of which the segment numbers are “2” and “3,” for example. Likewise, the coil 2017b is connected to the segments 2018 of which the segments numbers are “5” and “6,” the coil 2017c is connected to the segments 2018 of which the segments numbers are “8” and “9,” the coil 2017d is connected to the segments 2018 of which the segments numbers are “11” and “12,” the coil 2017e is connected to the segments 2018 of which the segments numbers are “14” and “15,” the coil 2017f is connected to the segments 2018 of which the segments numbers are “17” and “18,” the coil 2017g is connected to the segments 2018 of which the segments numbers are “20” and “21,” and the coil 2017h is connected to the segments 2018 of which the segments numbers are “23” and “24.”

In addition, every third segment 2018, that is, segment numbers “4,” “7,” “10,” “13,” “16,” “19,” “22” and “1,” is connected to the corresponding one of the coils 2017a to 2017h via the short-circuit member 2019. That is to say, the ends of the each coil 2017a to 2017h are connected to a total of eight pairs of segments 2018. Each pair is formed of two segments 2018 which are adjacent in the circumferential direction. One segment 2018 to which no end of the coils 2017a to 2017h is connected is placed between each pair of segments 2018.

An end of the respective leads 2025, which are connected to the respective segments 2018, is engaged in the corresponding connection groove 2024a. The end of each lead 2025 is welded to the coil connection portion 2024 from the outside in the radial direction, and as a result, the respective coils 2017a to 2017h are electrically connected to the respective segments 2018.

As shown in FIG. 1, the brush holder 2040 has an anode brush support 2043 and a cathode brush support 2044, which are respectively in rectangular tube form. The anode brush support 2043 and the cathode brush support 2044 are positioned in axial symmetry so as to sandwich the rotary shaft 12. The anode brush support 2043 contains a spring 2045 and an anode brush 2046 in substantially rectangular parallelepiped form. The spring 2045 presses the anode brush 2046 against the sliding surface 2022c. The cathode brush support 2044 contains a spring 2047 and a cathode brush 2048 in substantially rectangular parallelepiped form. The spring 2047 presses the cathode brush 2048 against the sliding surface 2022c.

As shown in FIGS. 1 and 2, the anode brush 2046 has an end 2046a in the first circumferential direction and an end 2046b in the second circumferential direction. The first circumferential direction end 2046a and the second circumferential direction end 2046b respectively extend parallel to the radial line L0 in a state where the radial line L0 passes through the center of the anode brush 2046. Likewise, the cathode brush 2048 has an end 2048a in the first circumferential direction and an end 2048b in the second circumferential direction. The first circumferential direction end 2048a and the second circumferential direction end 2048b respectively extend parallel to the radial line L0 in a where that the radial line L0 passes through the center of the cathode brush 2048.

The anode brush 2046 and the cathode brush 2048 supply the power of the external power supply (not shown) to the segments 2018. As a result, the coils 2017a to 2017h are energized, so as to generate a rotational magnetic field. Then, the armature 2010 rotates. When the commutator 2013 rotates, the segments 2018, which respectively slide against the anode brush 2046 or the cathode brush 2048, are switched, and therefore, the current flowing through the coils 2017a to 2017h is rectified in sequence so that the rotation of the armature 2010 continues.

The present embodiment has the following advantages:

(1) The portion of the segment center line L1 which includes the inner center O2 of each segment 2018 is inclined in the first circumferential direction R1 relative to the radial line L0. That is to say, the inner center O2 is shifted by an angular width α in the first circumferential direction from the outer center O1 in each segment 2018. The coupling portion 2033 in each connection piece 2034 links the outer short-circuit end 2031 to the inner short-circuit end 2032, which is shifted in the second circumferential direction R2 from the outer short-circuit end 2031. The second circumferential direction R2 is opposite to the first circumferential direction R1. Therefore, the angular width between the radially outer end of the segment 2018 and the radially inner end of the segment 2018, which is shifted by 120° in the second circumferential direction R2 from the segment 2018 is “120°−α°.” Accordingly, according to the present embodiment, the length of the coupling portion 2033 between the outer short-circuit end 2031 and the inner short-circuit end 2032 is short in comparison with the case where the segment center line L1 coincides with the radial line L0, for example. That is to say, the respective connection pieces 2034 is short, so that the value of the electrical resistance of the short-circuit member 2019 is small.

Therefore, the amount of drop in the voltage across the short-circuit member 2019 is prevented from increasing, and thus, the short-circuit member 2019 is prevented from overheating. The value of the electrical resistance of each connection piece 2034 is made small, and therefore, no problem arises when the width of each connection piece 2034 is reduced in order to reduce the outer diameter of the commutator. Accordingly, the commutator 2013 is miniaturized in the radial direction, so that the direct current motor 2000 is miniaturized.

The value of the electrical resistance of each connection piece 2034 lowers, and therefore, the value of the current which flows through each segment 2018 easily becomes uniform. Therefore, the armature 2010 is easy to rotate smoothly. In addition, the coupling portion 2033 is made short in the present embodiment, and therefore, the number of coupling portions 2033 which cross the respective radial lines L0 is reduced, and thus, the width of the coupling portions 2033 is easily secured.

(2) As shown in FIG. 1, the height of the surface 2027 which faces the support 2020 in the axial direction increases inward from the outside in the radial direction. The size of each coil 2017a to 2017h in the axial direction decreases inward from the outside in the radial direction. That is to say, the space between the coil facing surface 2027 and each coil 2017a to 2017h in the axial direction is reduced. That is to say, the coil facing surface 2027 is inclined along the outer form of the coils 2017a to 2017h. Accordingly, the size of the support 2020 in the axial direction is increased while preventing the direct current motor 2000 from increasing in size in the axial direction, and thus, the strength of the support 2020 is secured. That is to say, the commutator 2013 is firmly secured to the rotary shaft 2011. The size of the support 2020 in the axial direction increases radially inward, and therefore, it is easy to secure the strength of the support 2020.

Accordingly, the commutator 2013 is not easily deformed. The support 2020 having a certain strength reduces stress applied to the connection pieces 2034 having such a form unsuitable for retaining strength and a large number of electrical connection portions, and thus, it is easy to prevent disconnections of the connection pieces 2034. In addition, in the case where the support 2020 is formed so as to have the same strength as in the case where the coil facing surface 2027 is not inclined relative to the axial direction, the size of the support 2020 in the axial direction is reduced. As a result, the direct current motor 2000 is miniaturized in the axial direction. In addition, the volume required for the support 2020 in order to mount the short-circuit member 2019 is increased when the height of the coil facing surface 2027 increases inward from the outside in the radial direction.

(3) The anode brush 2046 and the cathode brush 2048 according to the present embodiment are respectively pressed against the commutator 2013 in the axial direction. That is to say, the sliding surface 2022c of each segment 2018 is perpendicular to the axial direction. According to the present embodiment, the size of the commutator 2013 in the axial direction is reduced in comparison with the case where the sliding surface 2022c is perpendicular to the radial direction. However, it is necessary to secure the strength of the commutator 2013. According to the present embodiment, the surface 2027 of the commutator 2013, which faces the coils 2017a to 2017h, is inclined, and thus, the strength of the commutator 2013 is secured.

(4) The surface 2027 of the commutator 2013, which faces the coils 2017a to 2017h, is inclined relative to the axial direction. Therefore, the commutator 2013 having a height in the axial direction which increases inward from the outside in the radial direction is easily formed.

(5) The coil facing surface 2027 is inclined so as to follow the outer shape of the coil 2017a to 2017h. Therefore, it is easy to reduce the spaces between the commutator 2013 and the coils 2017a to 2017h in the axial direction.

(6) The first circumferential direction end 2022a and the second circumferential direction end 2022b of each segment 2018 are respectively formed in a straight line. Therefore, the segments 2018 which have the segment center line L1, which is inclined in the circumferential direction relative to the radial line 10, are easily formed.

(7) The coupling portions 2033 of the respective connection pieces 2034 extend along involute curves. Therefore, the width of the respective coupling portions 2033 is increased as much as possible while preventing adjacent coupling portions 2033 from short circuiting.

(8) The first circumferential direction end 2046a and the second circumferential direction end 2046b of the anode brush 2046 respectively extend parallel to the radial line L0 in a state where the radial line L0 passes through the center of the anode brush 2046. Likewise, the first circumferential direction end 2048a and the second circumferential direction end 2048b of the cathode brush 2048 respectively extend parallel to the radial line L0 in a state where the radial line L0 passes through the center of the cathode brush 2048. Furthermore, the first circumferential direction end 2022a and the second circumferential direction end 2022b in each segment 2018 are respectively set so as to be inclined relative to the radial line L0 in a state where the radial line L0 passes through the center of the anode brush 2046. Likewise, the first circumferential direction end 2022a and the second circumferential direction end 2022b of each segment 2018 are respectively set so as to be inclined relative to the radial line L0 in a state where the radial line L0 passes through the center of the cathode brush 2048.

Therefore, the area of contact between the anode brush 2046 and the segments 2018 changes gradually when the anode brush 2046 makes contact with each segment 2018 and separates from each segment 2018. Accordingly, the voltage generated between the anode brush 2046 and each segment 2018 gradually changes. Likewise, the contact area between the cathode brush 2048 and the segments 2018 gradually changes when the cathode brush 2048 makes contact with each segment 2018 and separates from each segment 2018. Accordingly, the voltage generated between the cathode brush 2048 and each segment 2018 changes gradually. Thus, the anode brush 2046 and the cathode brush 2048 are prevented from being damaged.

The above described embodiment may be modified as follows.

The segment center line L1 is not limited to being inclined in the first circumferential direction R1 relative to the radial line L0, but may be inclined in the second circumferential direction R2. That is to say, each segment center line L1 may be inclined either in the first circumferential direction R1 or the second circumferential direction R2 relative to the radial line L0. In the case where the segment center line L1 is inclined in the second circumferential direction R2 relative to the radial line L0, the coupling portion 2033 of each connection piece 2034 links the outer short-circuit end 2031 to the inner short-circuit end 2032, which is shifted in the first circumferential direction R1 relative to the outer short-circuit end 2031.

Neither the first circumferential direction end 2022a nor the second circumferential direction end 2022b of each segment main body 2022 is limited to being in a straight line, but they may respectively be in the form of a curved line, and may be, for example, in the form of an involute curve. The outer center O1 of each segment main body 2022 may be shifted in the circumferential direction from the inner center O2.

The coil facing surface 2027 of the commutator 2013 is not limited to having a form which follows the outer shape of the entirety of the protruding portion of each coil 2017a to 2017h in the axial direction. The height of the support 2020 in the axial direction may increase inward from the outside in the radial direction.

The sliding surface of the anode brush 2046 and the cathode brush 2048 against a segment 2018 is not limited to being in rectangular form.

The intervals between segments 2018 having the same potential are not limited to 120°, but may be 180°.

The number of magnetic poles in the direct current motor 2000 is not limited to six, and the number of segments 2018 is not limited to twenty-four.

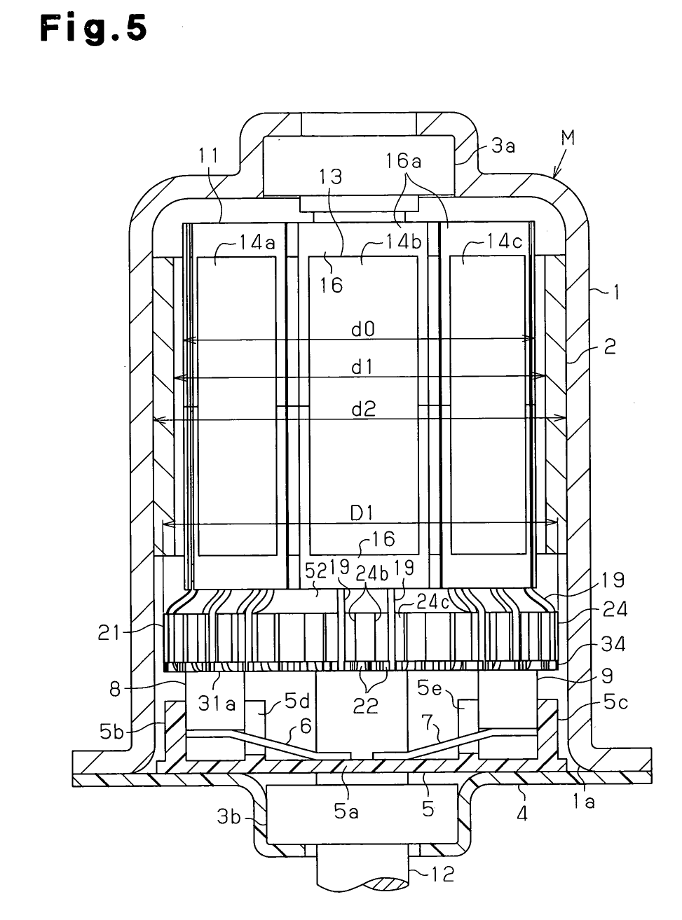

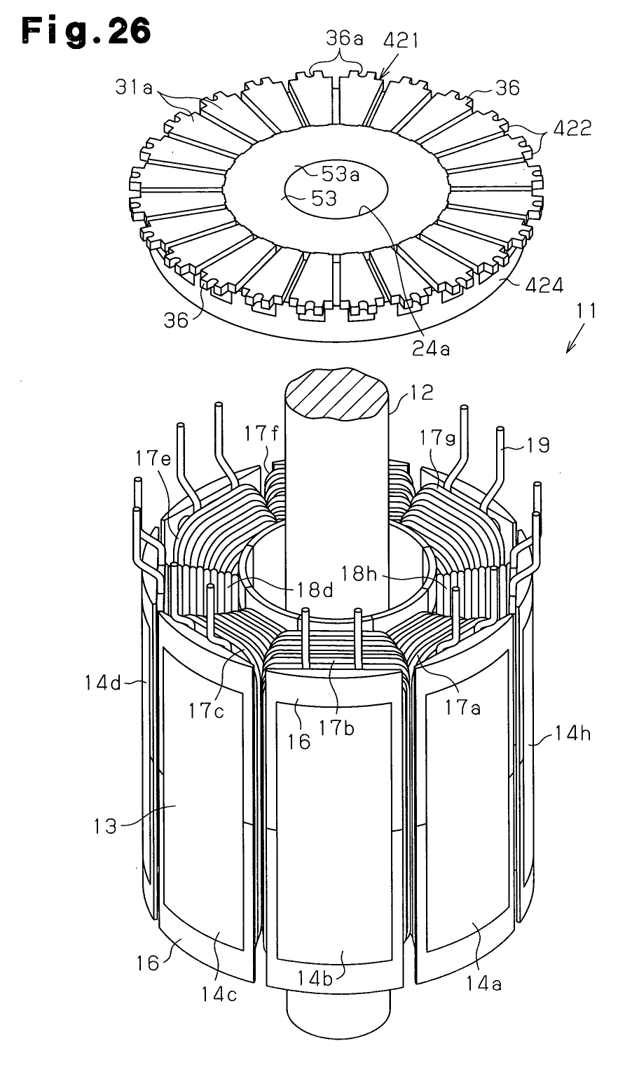

In the following, FIGS. 5 to 60 illustrate first to fourth examples related to the present invention. The present invention may be applied to these examples.

FIGS. 5 to 60 show a state where the segment center lines L1 are not inclined relative to the radial line L0. However, the segment center lines L1 shown in FIGS. 5 to 60 may be inclined in the first circumferential direction R1 relative to the radial line L0 without affecting the characteristics of the first to fourth example. In other words, the outer center O1 of each segment 22 illustrated in FIGS. 5 to 60 can be shifted by an angular width α in the second circumferential direction R2 from the inner center O2.

In the first example shown in FIGS. 5 to 12, for example, the coupling portion 44 of each connection piece 41 links the outer short-circuit end 42 to the inner short-circuit end 43, which is shifted in the second circumferential direction R2 relative to the outer short-circuit end 42. Accordingly, the angular width between the radially outer end of a first segment 22 and the radially inner end of a second segment 22, which is in such a location as to be shifted 120° in the second circumferential direction R2 from the first segment 22, may be made “120°−α°.” As a result, the length of the coupling portion 44 between the outer short-circuit end 42 and the inner short-circuit end 43 in each segment is made short. That is to say, the connection piece 41 of each segment is made short, and thus, the value of the electrical resistance of the short-circuit unit 23, which is a short-circuit member, is lowered.

FIGS. 5 to 12 show a direct current motor M according to the first example. As shown in FIG. 5, the direct-current motor M in accordance with a first example has a closed-end cylindrical motor housing 1. A first bearing 3a is fixed to a center of a bottom portion of the motor housing 1. A plurality of magnets 2 are circumferentially distributed and firmly fixed to an inner circumferential surface of the motor housing 1. A plurality of magnets 2 form six magnetic poles in a circumferential direction. The dimension in a radial direction of the magnet 2 is equal to the thickness of the motor housing 1. An opening edge 1a of the motor housing 1 is closed by a disc-shaped end frame 4. A second bearing 3b forming a pair with the first bearing 3a is fixed to a center of the end frame 4.

A brush holder 5 made of a synthetic resin is fixed to the end frame 4 so as to be directed to the motor housing 1. The brush holder 5 has a disc-shaped fixed plate 5a fixed to the end frame 4, and two brush accommodating portions 5b and 5c integrally formed with the fixed plate 5a. The rectangular tubular brush accommodating portions 5b and 5c have an opening edge directed to a bottom portion of the motor housing 1. Two brush accommodating portions 5b and 5c are arranged symmetrically with respect to a center portion of the fixed plate 5a. Side walls of two brush accommodating portions 5b and 5c have insertion grooves 5d and 5e facing each other. The insertion grooves 5d and 5e extend in the same direction as a thickness direction of the fixed plate 5a.

Proximal ends of two leaf springs 6 and 7 are fixed to a center of the fixed plate 5a. The leaf springs 6 and 7 respectively extend obliquely toward the brush accommodating portions 5b and 5c from the center portion of the fixed plate 5a. The leaf springs 6 and 7 are gradually spaced away from the fixed plate 5a in accordance that they leave for their distal ends. The leaf springs 6 and 7 are respectively inserted to the brush accommodating portions 5b and 5c from the insertion grooves 5d and 5e. The distal ends of the leaf springs 6 and 7 are arranged within the brush accommodating portions 5b and 5c.

A substantially rectangular parallelepiped anode brush 8 is inserted to the brush accommodating portion 5b in a left side in FIG. 5. A substantially rectangular parallelepiped cathode brush 9 is inserted to the brush accommodating portion 5c in a right side in FIG. 5. The anode brush 8 and the cathode brush 9 can reciprocate in the axial direction of the motor. The distal ends of the leaf springs 6 and 7 are brought into contact with the anode brush 8 and the cathode brush 9. The leaf springs 6 and 7 are brought into contact with end surfaces directed to the fixed plate 5a, in the anode brush 8 and the cathode brush 9. The anode brush 8 and the cathode brush 9 are respectively energized in such a manner as to protrude from opening edges of the brush accommodating portions 5b and 5c, by the leaf springs 6 and 7. The anode brush 8 and the cathode brush 9 are connected to an external power supply apparatus.

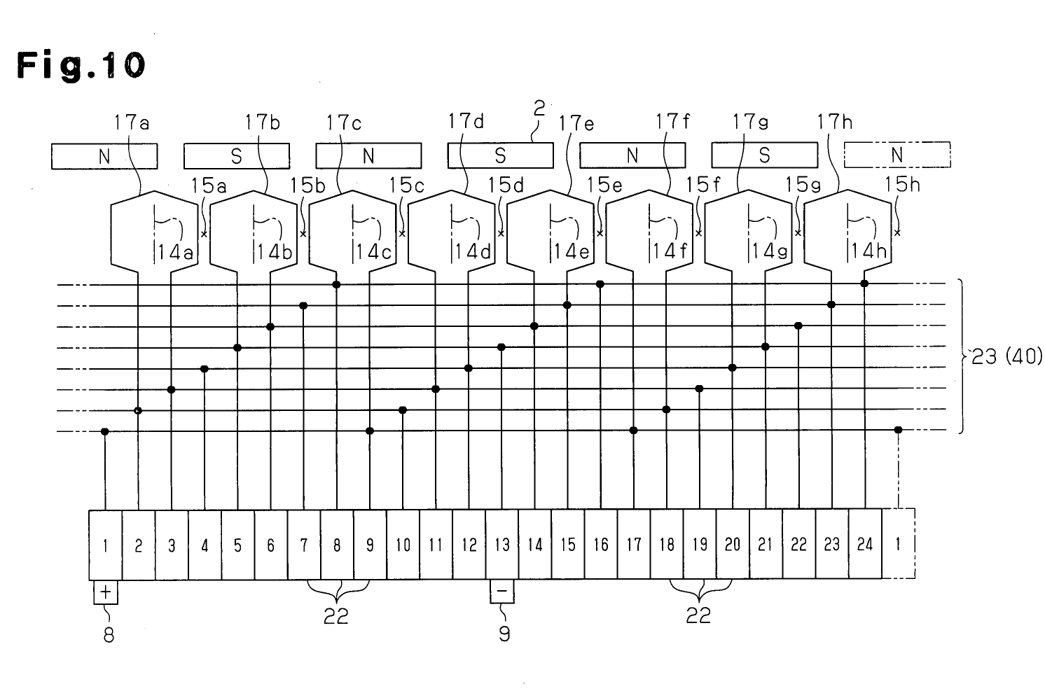

The armature 11 is rotatably accommodated in a space surrounded by the motor housing 1 and the end frame 4. The armature 11 has a rotary shaft 12 rotatably supported by the first bearing 3a and the second bearing 3b. The rotary shaft 12 has an output end passing through a center portion of the center portions of the fixed plate 5a and the end frame 4, and exposed to an outer portion of the motor housing 1. A core 13 is fixed to the rotary shaft 12. The core 13 is adjacent to a bottom portion of the motor housing 1. The core 13 has eight teeth 14a to 14h extending in a radial pattern along a radial direction of the rotary shaft 12. A space between eight teeth 14a to 14h correspond to slots 15a to 15h. FIG. 5 shows only the teeth 14a to 14c. FIG. 10 shows the teeth 14d to 14h and the slots 15a to 15h.

As shown in FIG. 5, a pair of insulators 16 are installed to the core 13. The insulator 16 covers both ends in the axial direction of the core 13. In other words, the insulator 16 does not cover an inner circumferential surface and an outer circumferential surface of the core 13. The insulator 16 is formed by a synthetic resin having an insulating characteristic.

An outer circumferential surface of the core 13 corresponds to distal end surfaces of the teeth 14a to 14h. A first coil 17a to an eighth coil 17h are respectively wound around the teeth 14a to 14h by concentrated winding from the above of the insulator 16. The core 13 and each of the coils 17a to 17h are insulated by the insulator 16. Conducting wires of the coils 17a to 17h pass through the slots 15a to 15h existing in both sides in a circumferential direction of the respective teeth 14a to 14h.

As shown in FIG. 5, the insulator 16 has a prevention wall 16a preventing each of the coils 17a to 17h from protruding radially outward. The prevention wall 16a extends in the axial direction from a radially outer end of the insulator 16.

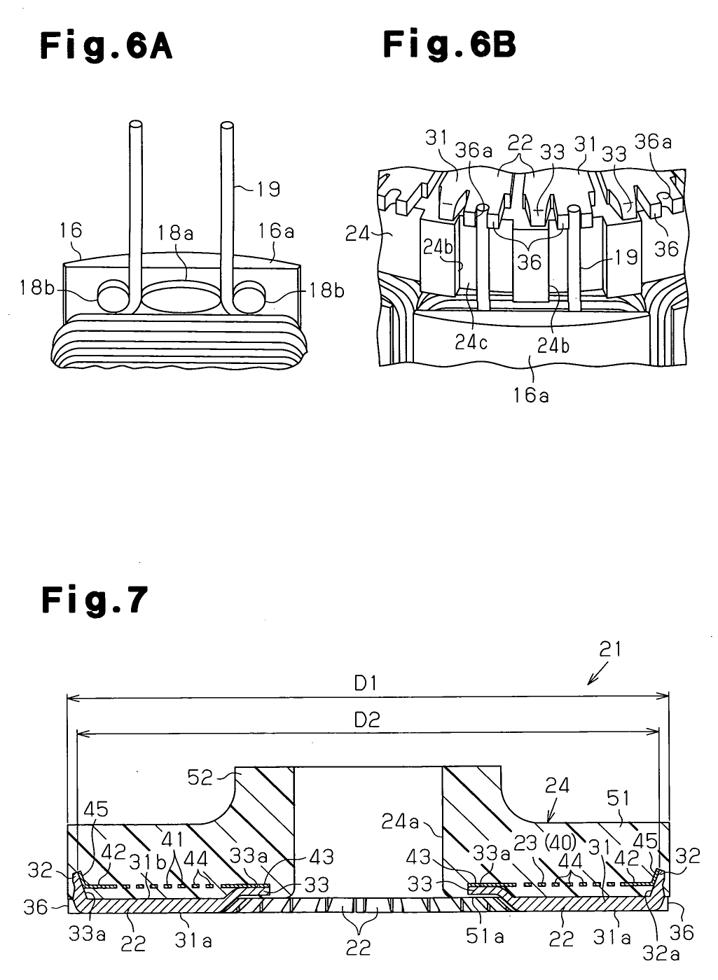

As shown in FIG. 6A, the prevention wall 16a has a first holding projection 18a extending radially inward, and a pair of second holding projections 18b pinching the first holding projection 18a. The first holding projection 18a and the second holding projections 18b are arranged in the circumferential direction in an inward surface in the radial direction of the prevention wall 16a. The first holding projection 18a is positioned in a center with respect to the circumferential direction of the prevention wall 16a. The first holding projection 18a is formed in a columnar shape having an oval cross section, and the second holding projection 18b is formed in a columnar shape. An interval between the first holding projection 18a and the second holding projection 18b is equal to the diameter of the conducting wires 19 of the coils 17a to 17h, or slightly smaller than the diameter of the conducting wires 19.

As shown in FIGS. 6A and 6B, a first end of the conducting wire 19 in each of the coils 17a to 17h is led out in the axial direction through a portion between the first holding projection 18a and one of the second holding projections 18b. A second end of the conducting wire 19 is led out in the axial direction through a portion between the first holding projection 18a and the other of the second holding projections 18b. Each of the conducting wires 19 is pinched by the first holding projection 18a and the second holding projection 18b arranged in the circumferential direction. Accordingly, each of the conducting wires 19 is kept in a state of extending in the axial direction.

As shown in FIG. 5, a commutator 21 is fixed to the rotary shaft 12. The commutator 21 is positioned between the core 13 and the brush holder 5. As shown in FIG. 8, the commutator 21 includes a plurality of segments 22 arranged in the circumferential direction, and a plurality of short-circuit units 23. The short-circuit unit 23 short-circuits the predetermined segments 22 having the same electric potential with each other. As shown in FIG. 7, the commutator 21 further includes a holding portion 24 holding the segment 22 and the short-circuit unit 23. As shown in FIG. 8, the number of the segments 22 is twenty-four.

As shown in FIG. 8, a plurality of segments 22 are arranged at a uniform angular interval in the circumferential direction so as to be spaced with each other. The segments 22 are arranged in a radial pattern. Each of the segments 22 is formed in a sectoral shape in which a radially outer end is larger than a radially inner end. An interval between the adjacent segments 22 is constant over the radial direction.

As shown in FIG. 8, each of the segments 22 has a tabular segment main body 31 formed in a sectoral shape, an inner connection portion 33 extending from an inner end in a radial direction of the segment main body 31, and an outer connection portion 32 extending from a radially outer end of the segment main body 31. Further, each of the segments 22 has a coil connection portion 36 which is adjacent to the outer connection portion 32.

As shown in FIG. 7, the segment main body 31 has a flat slidable contact surface 31a. The slidable contact surface 31a corresponds to a lower surface of the segment main body 31 in FIG. 7. The segment main body 31 has a bonded surface 31b which is in an opposite side to the slidable contact surface 31a. The bonded surface 31b is parallel to the slidable contact surface 31a. The bonded surface 31b is bonded to the holding portion 24. The inner connection portion 33 has a diagonal portion extending diagonally away from the slidable contact surface 31a, from the radially inner end of the segment main body 31, and a parallel portion extending parallel to the slidable contact surface 31a and to the inner side in the radial direction. The parallel portion is formed in a trapezoidal shape which becomes smaller toward the inner side in the radial direction as viewed in the axial direction, as shown in FIG. 8. As shown in FIG. 7, the parallel portion has an inner connection surface 33a which is parallel to the slidable contact surface 31a. The inner connection surface 33a corresponds to an upper surface of the inner connection portion 33. The thickness of the inner connection portion 33 is smaller than the thickness in the axial direction of the segment main body 31.

Each of the slidable contact surfaces 31a is arranged within the same plane. Each of the inner connection surfaces 33a is arranged in another common plane. The diameter of an imaginary circle defined by the radially inner end of the inner connection portion 33 is larger than the diameter of the rotary shaft 12.

As shown in FIG. 8, the outer connection portion 32 is deviated from the center in the circumferential direction, in the radially outer end of the segment main body 31. The outer connection portion 32 and the coil connection portion 36 are arranged in the circumferential direction. As shown in FIG. 7, the outer connection portion 32 is sloped, and a distal end thereof extends away from the slidable contact surface 31a. The thickness of the outer connection portion 32 is smaller than the segment main body 31. An angle of inclination of the outer connection portion 32 is larger than an angle of inclination of the inner connection portion 33. The outer connection portion 32 has an outer connection surface 32a directed to an inner side in the radial direction. An angle between the outer connection surface 32a and the slidable contact surface 31a is an obtuse angle. A recess between the outer connection portion 32 and the inner connection portion 33 can serve as a separating recess facing a coupling portion 44.

As shown in FIG. 7, the coil connection portion 36 has the same thickness as the segment main body 31, and protrudes toward an outer side in a radial direction. As shown in FIG. 8, a radially outer end of the coil connection portion 36 has a connection groove 36a. The connection groove 36a extends along the thickness direction of the segment main body 31. As shown in FIG. 6B, the dimension in a circumferential direction of the connection groove 36a is substantially equal to the diameter of the conducting wire 19. The dimension in the radial direction of the connection groove 36a is slightly larger than the diameter of the conducting wire 19.

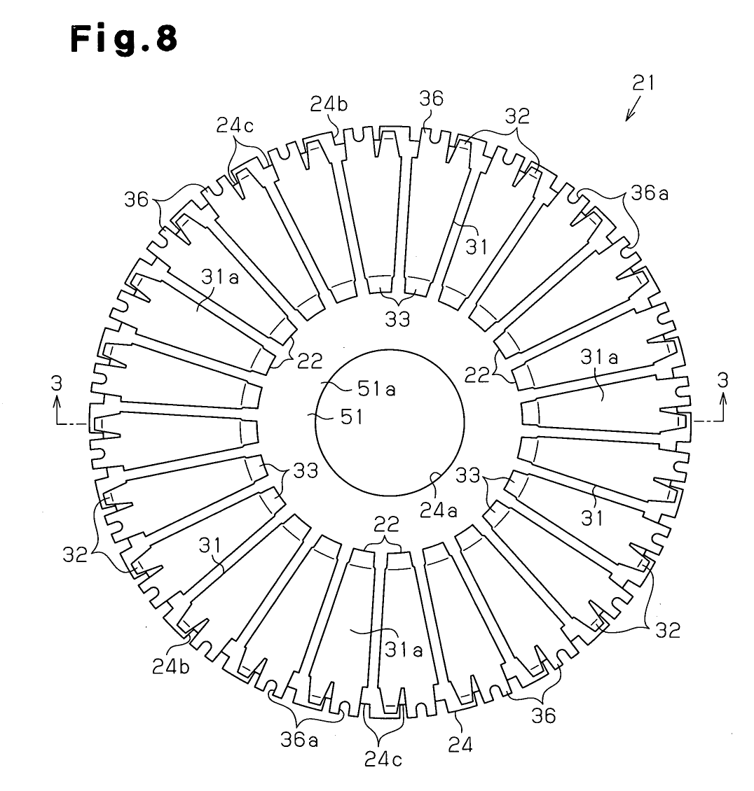

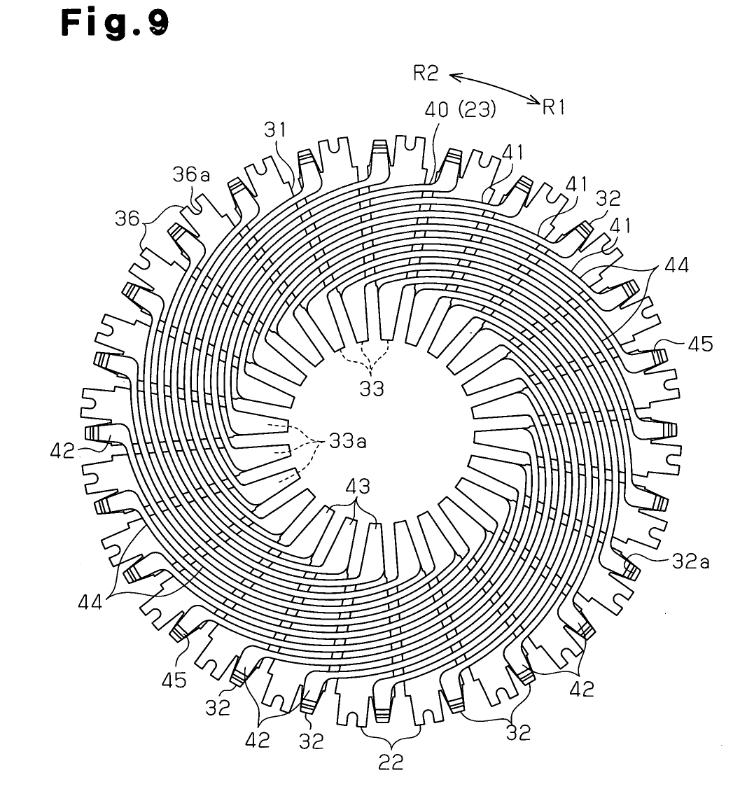

As shown in FIG. 9, the short-circuit unit 23 in accordance with the present example is structured by one short-circuit group 40. FIG. 9 shows the segment 22 of the commutator 21 and the short-circuit unit 23, and omits an illustration of the holding portion 24. The short-circuit group 40 includes twenty-four outer short-circuit ends 42 connected to the outer connection portion 32, twenty-four inner short-circuit ends 43 arranged in an inner side in a radial direction than the outer short-circuit ends 42, and twenty-four coupling portions 44 connecting the outer short-circuit ends 42 to the inner short-circuit ends 43. In other words, one short-circuit group 40 includes twenty-four short-circuit pieces 41. One short-circuit piece 41 has one outer short-circuit end 42, one inner short-circuit end 43 and one coupling portion 44. The inner short-circuit end 43 is mounted on the inner connection portion 33. Each of the coupling portions 44 connects the outer short-circuit end 42 to the inner short-circuit end 43 which is displaced by a predetermined angle in the circumferential direction.

As shown in FIG. 7, the outer short-circuit end 42 is formed in a tabular shape which is parallel to the slidable contact surface 31a of the segment 22. A connection piece 45 is integrally formed in a radially outer end of the outer short-circuit end 42. The connection piece 45 is formed in a tabular shape which is parallel to the outer connection surface 32a.

The inner short-circuit end 43 is formed in the same trapezoidal tabular shape as the inner connection surface 33a. The inner short-circuit end 43 is parallel to the slidable contact surface 31a. In other words, the inner short-circuit end 43 is parallel to the inner connection surface 33a.

As shown in FIG. 9, the coupling portion 44 connects the outer short-circuit end 42 to the inner short-circuit end 43 which is displaced by 120°. The coupling portion 44 is formed in a curved shape along an involute curve. As shown in FIG. 9, as viewed in the above in FIG. 7, the coupling portion 44 extends to the inner short-circuit end 43 which is displaced by 120° in a counterclockwise direction from each of the outer short-circuit ends 42. The coupling portions 44 which are adjacent in the circumferential direction are arranged so as to be spaced. In other words, the coupling portions 44 are in non-contact with each other. As shown in FIG. 7, the outer short-circuit end 42, the inner short-circuit end 43 and the coupling portion 44 are integrally formed, and are formed in one flat plate shape. The thickness of the short-circuit group 40, that is, the dimension in the axial direction thereof is smaller than the thickness of the segment main body 31.

As shown in FIGS. 7 and 8, each of the connection pieces 45 is brought into contact with the corresponding outer connection surface 32a. Each of the inner short-circuit ends 43 is brought into contact with corresponding inner connection surface 33a. In a state in which the short-circuit unit 23 is assembled in the segment 22, the short-circuit unit 23 has a surface on the same plane as the inner connection surface 33a. In FIG. 7, a surface facing the segment 22 in the short-circuit unit 23 exists on the same plane as the inner connection surface 33a. Accordingly, the short-circuit unit 23 is parallel to the slidable contact surface 31a. The coupling portion 44 faces the bonded surface 31b of the segment main body 31 so as to be spaced. In other words, the coupling portion 44 is in a non-contact state with the segment main body 31.

The connection piece 45 is welded to the outer connection portion 32, and the inner short-circuit end 43 is welded to the inner connection portion 33. The welding employs, for example, a tungsten inert gas (TIG) welding. Accordingly, the outer short-circuit end 42 is electrically connected to the outer connection portion 32 via the connection piece 45. The inner short-circuit end 43 is electrically connected to the inner connection portion 33. In other words, if the short-circuit unit 23 is electrically connected to the segment 22, the segments 22 spaced at 120° are short-circuited with each other.

As shown in FIG. 7, the holding portion 24 is formed in a flat cylindrical shape. The holding portion 24 is made of an insulative resin. The holding portion 24 has a fitting hole 24a extending in the axial direction in the center. The rotary shaft 12 is fitted and inserted to the fitting hole 24a. The diameter of the fitting hole 24a is equal to or slightly smaller than the outer diameter of the rotary shaft 12.

A part of the segment 22 and the short-circuit unit 23 are embedded in the holding portion 24. In other words, the holding portion 24 is integrated with the segment 22 and the short-circuit unit 23.

As shown in FIG. 7, the holding portion 24 has a ring plate 51 serving as a holding portion main body, and a boss portion 52 evaginating from the ring plate 51. The cylindrical boss portion 52 surrounds the fitting hole 24a. The dimension in the axial direction of the boss portion 52 is substantially equal to the thickness of the holding portion 24.

The ring plate 51 has an end surface 51a which is positioned in an opposite side to the boss portion 52, and a contact surface 51b which is adjacent to the boss portion 52. The end surface 51a is perpendicular to the axial direction. The end surface 51a is adjacent to the segment 22. In FIG. 7, the end surface 51a corresponds to a lower end surface of the holding portion 24. The slidable contact surface 31a is farther from the short-circuit unit 23 than the end surface 51a. In other words, the slidable contact surface 31a protrudes in the axial direction than the end surface 51a. The slidable contact surface 31a is parallel to the end surface 51a.

As shown in FIG. 7, the outer diameter of the ring plate 51, that is, the outer diameter D1 of the holding portion 24 is equal to the diameter of an imaginary circle defined by distal ends of a plurality of coil connection portions 36. The outer diameter D1 of the holding portion 24 is equal to the outer diameter of the commutator 21. As shown in FIG. 5, the outer diameter D1 of the holding portion 24 is larger than the inner diameter d1 of an imaginary cylinder defined by a plurality of arcuate shaped magnets 2, and smaller than the inner diameter d2 of the motor housing 1 (d1<D1<d2). The outer diameter D2 of the short-circuit unit 23 is smaller than the outer diameter D1 of the holding portion 24 (D2<D1). The outer diameter D2 of the short-circuit unit 23 is also larger than the inner diameter d1 of the imaginary cylinder formed by a plurality of magnets 2, and smaller than the inner diameter d2 of the motor housing 1 (d1<D2<D1<d2).

As shown in FIG. 8, the resin holding portion 24 gets into a portion between the segments 22 which are adjacent to each other in the circumferential direction. Accordingly, it is possible to prevent the segments 22 which are adjacent to each other in the circumferential direction from being short-circuited. A whole of the short-circuit unit 23 is embedded in the holding portion 24.

As shown in FIG. 7, the holding portion 24 gets into the portion between the bonded surface 31b between the segments 22 facing each other in the axial direction, and the coupling portion 44. Accordingly, it is possible to prevent the coupling portion 44 from being short-circuited with the segment 22.

As shown in FIG. 8, twenty-four guide grooves 24b are formed on an outer circumferential surface of the ring plate 51 so as to correspond to the coil connection portion 36. The guide groove 24b extends in the axial direction. The dimension in the circumferential direction of the guide groove 24b is slightly larger than the dimension in the circumferential direction of the coil connection portion 36. The coil connection portion 36 protrudes to an outer side in the radial direction than the bottom surface 24c of the guide groove 24b. In other words, the connection groove 36a does not lap over the holding portion 24 in the axial direction.

As shown in FIG. 5, the rotary shaft 12 is pressed into the fitting hole 24a of the holding portion 24. The segment 22 is positioned in an opposite side to the core 13 in the commutator 21. The thickness direction of the holding portion 24 agrees with the axial direction of the rotary shaft 12. The anode brush 8 and the cathode brush 9 are brought into slidable contact with the slidable contact surface 31a of each of the segments 22 from the axial direction. A distance between the commutator 21 and the opening of the motor housing 1 is smaller than a distance between the magnet 2 and the opening of the motor housing 1. The commutator 21 faces the lower end surface of the magnet 2 in the axial direction.

FIG. 10 shows a wiring diagram of the direct-current motor. The conducting wire 19 corresponding to the end portion of the corresponding coil 17a to 17h is connected to the segment 22. Number “1” is attached to the segment 22 arranged between the teeth 14a and the teeth 14h. Numbers “2” to “24” are attached alphabetically in the counterclockwise direction from the segment 22 of the number “1”. The conducting wires 19 of the corresponding coils 17a to 17h are connected to eight pairs of segments 22 forming a pair adjacently in the circumferential direction. The segments 22 which are not connected to the coils 17a to 17h are arranged one by one between eight pairs of segments 22.

Describing in detail, a first end of the first coil 17a is connected to the segment 22 of the number “2”, and a second end of the first coil 17a is connected to the segment 22 of the number “3”. The conducting wire 19 of any of the coils 17a to 17h is not connected to the segment 22 of the number “4”. A first end of the second coil 17b is connected to the segment 22 of the number “5”, and a second end of the second coil 17b is connected to the segment 22 of the number “6”.

The conducting wire 19 of any of the coils 17a to 17h is not connected to every third segments 22 from the segment 22 of the number 1, or the segments 22 of the numbers “1”, “4”, “7”, “10”, “13”, “16”, “19” and “22”. A first end of the third coil 17c is connected to the segment 22 of the number “8”, and a second end of the third coil 17c is connected to the segment 22 of the number “9”. A first end of the fourth coil 17d is connected to the segment 22 of the number “11”, and a second end of the fourth coil 17d is connected to the segment 22 of the number “12”. A first end of the fifth coil 17e is connected to the segment 22 of the number “14”, and a second end of the fifth coil 17e is connected to the segment 22 of the number “15”. A first end of the sixth coil 17f is connected to the segment 22 of the number “17”, and a second end of the sixth coil 17f is connected to the segment 22 of the number “18”. A first end of the seventh coil 17g is connected to the segment 22 of the number “20”, and a second end of the seventh coil 17g is connected to the segment 22 of the number “21”. A first end of the eighth coil 17h is connected to the segment 22 of the number “23”, and a second end of the eighth coil 17h is connected to the segment 22 of the number “24”.

As shown in FIG. 6B, the conducting wire 19 corresponding to the end portion of each of the coils 17a to 17h is guided to the connection groove 36a of the segment 22 through the guide groove 24b in the outer circumferential surface of the holding portion 24. In this state, the conducting wire 19 of each of the coils 17a to 17h is electrically connected to the coil connection portion 36 by applying a welding from the outer side in the radial direction.

If an electric current is supplied to the direct-current motor from an external power supply apparatus, the electric current is selectively supplied to the coils 17a to 17h via the anode brush 8 and the cathode brush 9. As a result, a rotating magnetic field is generated from the coils 17a to 17h, and the armature 11 is rotated. If the armature 11 is rotated, the commutator 21 is rotated. Accordingly, the segments 22 brought into slidable contact with the anode brush 8 and the cathode brush 9 are switched, and rectifications of the coils 17a to 17h are executed sequentially.

Next, a description will be given of a manufacturing method of the commutator 21.

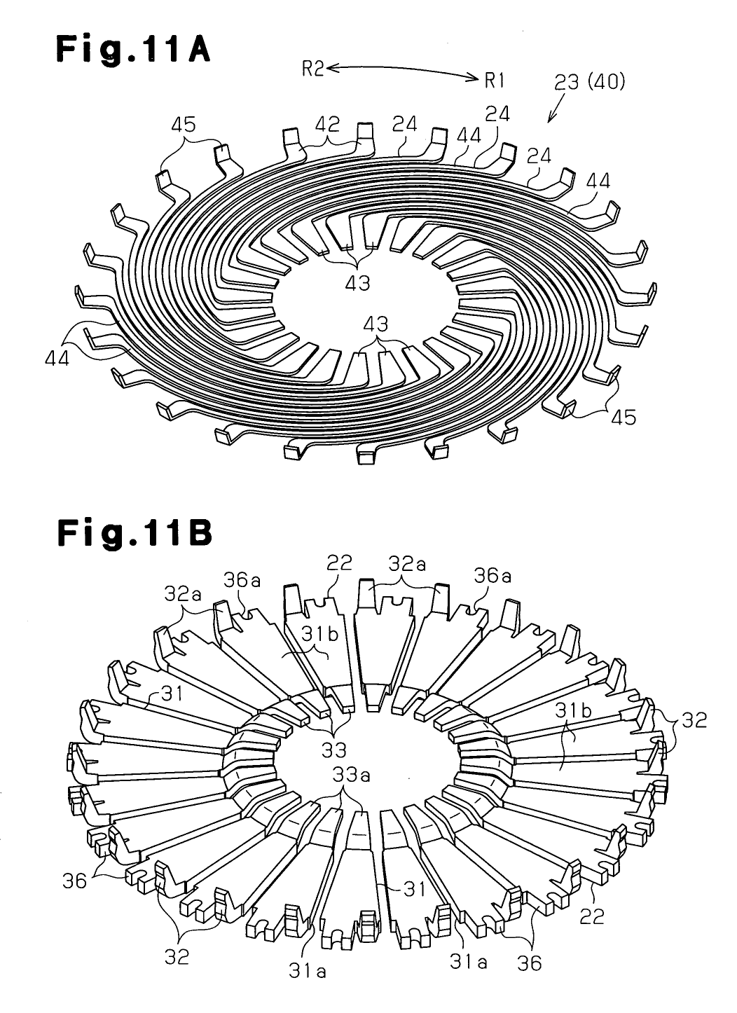

First, there is executed a short-circuit unit forming step of forming the short-circuit unit 23. FIG. 11A shows a perspective view of the short-circuit unit 23 formed by the short-circuit unit forming step. At a time of forming the short-circuit unit 23, that is, the short-circuit group 40, the connection piece 45 is formed by stamping a conductive plate member, for example, a copper plate by a punch and thereafter bending the outer short-circuit end. In the short-circuit unit 23, the outer short-circuit end 42, the inner short-circuit end 43 and the coupling portion 44 are integrally formed, and are formed in the flat shape.

Next, there is executed a segment forming step of forming the segment 22 shown in FIG. 11B. At a time of forming the segment 22, the outer connection portion 32 and the inner connection portion 33 are formed by stamping the conductive plate member by a punch and thereafter bending both ends of the stamped piece. Twenty-four segments 22 are formed by being stamped individually from the conductive plate member.

Next, there is executed an arranging step of arranging the short-circuit unit 23 in the segment 22. As shown in FIG. 11B, the slidable contact surfaces 31a of the respective segments 22 are arranged in a radial pattern within the same plane. The tabular short-circuit units 23 are arranged parallel twenty-four slidable contact surfaces 31a arranged in the radial pattern. As shown in FIG. 7, the inner short-circuit end 43 of the short-circuit unit 23 is brought into contact with the inner connection surface 33a of the segment 22. The connection piece 45 of the short-circuit unit 23 is brought into contact with the outer connection surface 32a of the segment 22. FIG. 9 shows a plan view of the short-circuit unit 23 in which the segment 22 is arranged. In a state in which the short-circuit unit 23 is arranged on the segments 22, the short-circuit unit 23 is brought into contact with the inner connection surface 33a of the segment 22. The bonded surface 31b of the segment main body 31 and the coupling portion 44 of the short-circuit unit 23 are arranged so as to be spaced in such a manner as to be in non-contact with each other.

Next, there is executed a bonding step of connecting the short-circuit unit 23 to the segment 22. The inner short-circuit end 43 of the segment 22 is bonded to the inner connection portion 33 of the short-circuit unit 23 by welding. In other words, the inner short-circuit end 43 of the segment 22 is electrically connected to the inner connection portion 33. The outer connection portion 32 of the segment 22 is bonded to the connection piece 45 of the short-circuit unit 23 by welding. In other words, the outer short-circuit end 42 of the segment 22 is electrically connected to the outer connection portion 32 via the connection piece 45.

Next, there is executed a holding portion forming step of forming the holding portion 24. Twenty-four segments 22 are arranged in a forming die such as a lower die 491 and an upper die 492 shown in FIG. 37, while keeping a state of being connected to twenty-four short-circuit units 23. Thereafter, the forming die is filled with a molten insulative resin. The insulative resin fills a gap between the segments 22 which are adjacent in the circumferential direction, a gap between the coupling portions 44 which are adjacent in the circumferential direction, and a gap between the segment main body 31 and the coupling portion 44 which face each other in the axial direction. The insulative resin is cooled so as to be hardened, whereby the holding portion 24 having the boss portion 52 is formed. The holding portion 24 integrally holds the segment 22 and the short-circuit unit 23. As a result, the commutator 21 is finished. The commutator 21 is removed from the forming die after the holding portion 24 is formed.

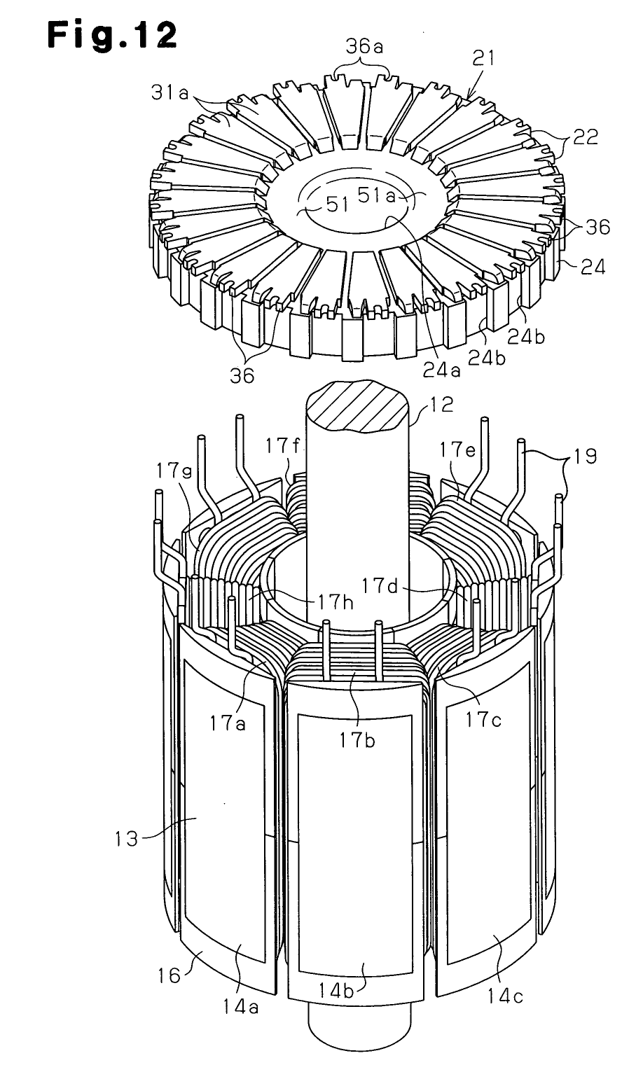

As shown in FIG. 12, the core 13 around which the coils 17a to 17h are wound is fixed to the rotary shaft 12. The rotary shaft 12 is pressed into the fitting hole 24a, whereby the commutator 21 is fixed to the rotary shaft 12. Thereafter, the conducting wire 19 of each of the coils 17a to 17h is connected to the coil connection portion 36 of the segment 22.

As shown in FIG. 7, the outer diameter D1 of the commutator 21 is substantially equal to the imaginary circle passing through the distal ends of twenty-four coil connection portions 36 arranged in the radial pattern. Accordingly, the conducting wires 19 of the respective coils 17a to 17h are arranged adjacently in the circumferential direction with respect to the coil connection portion 36.

As shown in FIG. 6A, the conducting wire 19 of each of the coils 17a to 17h is taken out along the axial direction while passing through the portion between the first holding projection 18a and the second holding projection 18b. Accordingly, each of the conducting wires 19 is held by the first and second holding projections 18a and 18b, and tends to keep a state of extending in the axial direction. Therefore, it is easy to arrange each of the conducting wires 19 with respect to the connection groove 36a of the segment 22.

In a state in which the conducting wire 19 of each of the coils 17a to 17h is arranged in the connection groove 36a of the segment 22, the coil connection portion 36 of the segment 22 is welded to the conducting wire 19 from the outer side in the radial direction of the commutator 21, thereby being electrically connected. Accordingly, the armature 11 is finished.

The first example mentioned above has the following advantages.

(1) The holding portion 24 holding the segment 22 is formed in a disc shape. Twenty-four segments 22 are arranged in one end in the thickness direction of the holding portion 24 in the radial pattern. The slidable contact surface 31a in the holding portion 24 is orthogonal to the thickness direction of the holding portion 24. The commutator 21 is fixed to the rotary shaft 12 in such a manner that the thickness direction of the holding portion 24 agrees with the axial direction of the rotary shaft 12. The anode brush 8 and the cathode brush 9 are brought into slidable contact with the slidable contact surface 31a in the axial direction.

In contrast, the feeding brush is brought into slidable contact with the commutator in accordance with the prior art from the radial direction. Accordingly, the present example can enlarge the outer diameter of the commutator 21 without enlarging the outer diameter of the direct-current motor in comparison with the prior art. Accordingly, in comparison with the short-circuit unit provided in the conventional commutator, it is possible to enlarge the dimension in the radial direction of the short-circuit unit 23 in accordance with the present example in correspondence to the outer diameter of the commutator 21. Therefore, it is possible to enlarge the dimension in the circumferential direction of the coupling portion 44. As a result, it is possible to enlarge the cross section area perpendicular to the current passing direction of the coupling portion 44.

Further, the short-circuit unit 23 in accordance with the present example can enlarge the cross-sectional area of the coupling portion 44 without increasing the number of the short-circuit group 40. Accordingly, it is possible to prevent the parts number of the commutator 21 from being increased. Further, it is possible to suppress the commutator 21 from being enlarged in size in the axial direction.

Further, the tabular short-circuit unit 23 is arranged parallel to the slidable contact surface 31a in the commutator 21. In other words, the short-circuit unit 23 is arranged parallel to the holding portion 24 holding the segment 22. As mentioned above, it is possible to further downsize the commutator 21 in the axial direction by arranging the tabular short-circuit unit 23 parallel to the disc-shaped holding portion 24.

The feeding brush is brought into slidable contact with the conventional commutator from the radial direction. Accordingly, in order to secure the position where the circumferential surface of the commutator is brought into slidable contact with the feeding brush, a certain degree of dimension in the axial direction is required in the commutator. In other words, it is hard to downsize the commutator in accordance with the prior art in the axial direction. However, the anode brush 8 and the cathode brush 9 are brought into slidable contact with the commutator 21 in accordance with the present example from the axial direction. Accordingly, the thickness of the holding portion 24 can be set regardless of the thickness of the distal ends of the anode brush 8 and the cathode brush 9. Therefore, it is possible to reduce the thickness of the holding portion 24. In other words, it is possible to further downsize the commutator 21 provided with the short-circuit unit 23 in the axial direction.

(2) The short-circuit unit 23 is fixed to the segment 22 in both of the outer short-circuit end 42 and the inner short-circuit end 43. Accordingly, the short-circuit unit 23 is stably arranged on the segments 22.

The outer short-circuit end 42 of the short-circuit unit 23 is connected to the outer connection portion 32 of the segment 22. The inner short-circuit end 43 of the short-circuit unit 23 is connected to the inner connection portion 33 of the segment 22. Accordingly, the dimension in the radial direction of the segment 22 is substantially equal to the dimension in the radial direction of the short-circuit unit 23. Therefore, it is possible to do away with the wasteful space of the motor housing 1, for example, in comparison with the case that the dimension in the radial direction of the segment 22 is different from the dimension in the radial direction of the short-circuit unit 23.

(3) Each of the coupling portions 44 of the short-circuit group 40 connects the outer short-circuit end 42 to the inner short-circuit end 43 which is displaced by 120° in the circumferential direction from the outer short-circuit end 42. In other words, one short-circuit group 40 short-circuits a plurality of segments 22 which are arranged so as to be spaced at 120° in the circumferential direction with each other. Since the short-circuit unit 23 is constituted by one short-circuit group 40, the parts number of the commutator 21 is reduced. Further, it is easy to assemble the parts of the commutator 21 with each other, that is, assemble the segment 22 in the short-circuit unit 23. Further, it is easy to downsize the commutator 21 in the axial direction in comparison with the case that the short-circuit unit 23 is constituted by a plurality of short-circuit groups.

(4) The outer diameter of the holding portion 24 is substantially equal to the circle passing through the radially outer ends of twenty-four segments 22 which are arranged in the circumferential direction. The outer diameter D1 of the holding portion 24 is larger than the inner diameter d1 of the imaginary cylinder defined by a plurality of magnets 2, and smaller than the inner diameter d2 of the motor housing 1. In other words, the outer diameter D1 of the commutator 21 is larger than the inner diameter d1 of the imaginary cylinder defined by a plurality of magnets 2 within the motor housing 1.

Further, the radially outer ends of the segments 22 to which the conducting wires 19 of the coils 17a to 17h are connected, are arranged in such a manner as to lap over the outer circumferential surface of the holding portion 24. In other words, the distal end of the coil connection portion 36 is arranged at an equal position to the outer circumferential surface of the holding portion 24 in the radial direction. Accordingly, the dimension in the radial direction between the outer circumferential surface of the segment 22 in the present example and the outer circumferential surface of the core 13 is smaller in comparison with the prior art in which the feeding brush is brought into slidable contact with the commutator from the radial direction.

The conducting wire 19 of each of the coils 17a to 17h is led out along the axial direction from the outer periphery of the core 13. The dimension in the radial direction between the lead-out position of the conducting wire 19 of each of the coil 17a to 17h and the coil connection portion 36 of the segment 22 in the present example is smaller in comparison with the prior art in which the feeding brush is brought into slidable contact with the commutator from the radial direction. Accordingly, it is possible to make the length of the conducting wire 19 connecting each of the coils 17a to 17h to the segment 22 smaller.

(5) As shown in FIG. 5, the outer diameter D1 of the commutator 21 is larger than the inner diameter d1 of the imaginary cylinder sectioned by a plurality of magnets 2, and smaller than the inner diameter d2 of the motor housing 1 (d1<D1<d2). In the present example, the outer diameter D1 of the commutator 21 is equal to the outer diameter of the holding portion 24.

Accordingly, it is possible to make the outer diameter of the commutator 21 further larger within the motor housing 1. Therefore, it is possible to enlarge the area of the slidable contact surface 31a of the commutator 21 to the maximum without enlarging the outer diameter of the motor housing 1. Accordingly, it is possible to enlarge the feeding amount to the armature 11.

The outer diameter D1 of the commutator 21 is larger than the outer diameter d0 of the core 13 (d0<d1<D1). Accordingly, for example, in comparison with the case that the outer diameter of the commutator is smaller than the outer diameter d0, the present example can enlarge the area of the slidable contact surface 31a. Therefore, it is possible to enlarge the anode brush 8 and the cathode brush 9 in the radial direction. Accordingly, it is possible to enlarge the feeding amount to the armature 11 without enlarging the outer diameter of the motor housing 1.

(6) The commutator 21 is closer to the opening edge 1a of the motor housing 1 than the magnet 2. The commutator 21 faces the magnet 2 in the axial direction. In other words, the commutator 21 does not lap over the magnet 2 in the radial direction. Accordingly, even if the outer diameter of the commutator 21 is larger than the inner diameter of the magnet 2, it is possible to prevent the commutator 21 from being brought into contact with the magnet 2.

(7) The coil connection portion 36 connected to the conducting wire 19 of each of the coils 17a to 17h is arranged in the outer peripheral portion of the commutator 21. Accordingly, welding for connecting the conducting wire 19 of each of the coils 17a to 17h to the corresponding segment 22 is executed from the outer side in the radial direction. For example, in the case that welding is executed from the axial direction, there is a case that the core 13 and the rotary shaft 12 interferes with the weld. However, if welding is executed from the radial direction as in the present example, it is possible to secure the space for the welding work without being affected by the core 13 and the rotary shaft 12. Accordingly, it is possible to further easily execute the welding mentioned above.

Further, for example, in comparison with the case that the coil connection portion is provided in the inner side in the radial direction of the segment 22, the distance between the coil connection portions 36 in accordance with the present example is larger. Accordingly, it is possible to suppress the short-circuit between the conducting wires 19 of the coils 17a to 17h. Further, it is possible to further suppress the contact between the coil connection portions 36 which are adjacent to each other in the circumferential direction. The welding work can be easily executed because the wider space can be secured in the present example.

(8) The connection groove 36a is formed in the radially outer end of the segment 22. The conducting wire 19 of each of the coils 17a to 17h is welded to the segment 22 in a state of being arranged in the connection groove 36a. The conducting wire 19 is positioned in the circumferential, direction by being arranged in the connection groove 36a. Accordingly, it is possible to easily weld each of the conducting wires 19 to the segment 22.

(9) The conducting wire 19 of each of the coils 17a to 17h is pinched from both sides in the circumferential direction by the first holding projection 18a and the second holding projection 18b. Accordingly, the conducting wire 19 of each of the coils 17a to 17h tends to be maintained in the state of being led out in the axial direction. As a result, it is possible to further easily connect the conducting wire 19 of each of the coils 17a to 17h to the radially outer end of the segment 22.

(10) The outer short-circuit end 42 of the short-circuit unit 23 is welded to the outer connection portion 32 of the segment 22, and the inner short-circuit end 43 of the short-circuit unit 23 is welded to the inner connection portion 33 of the segment 22. As a result, the short-circuit unit 23 is electrically connected to the segment 22. Therefore, the electric connection of the short-circuit unit 23 to the segment 22 is more securely executed than the case of the contact with each other, the case of the soldering and the case of the swaging.

(11) The holding portion 24 holds both of the segments 22 and the short-circuit unit 23. Accordingly, for example, in comparison with the case that the holding portion is formed in each of the segment 22 and the short-circuit unit 23, it is possible to more easily manufacture the commutator 21.

The holding portion 24 constituted by the insulative resin is integrally formed with the segment 22 and the short-circuit unit 23. Accordingly, it is possible to prevent the short-circuit unit 23 from being displaced from the segment 22 during the rotation of the commutator 21. For example, in comparison with the case that the segment 22 is only welded to the short-circuit unit 23, the short-circuit unit 23 in accordance with the present example is hard to be detached from the segment 22.

(12) The holding portion 24 covers the connection portion of the outer short-circuit end 42 to the outer connection portion 32. Accordingly, it is possible to prevent the outer short-circuit end 42 from being separated from the outer connection portion 32.

In the same manner, the holding portion 24 covers the connection portion of the inner short-circuit end 43 to the inner connection portion 33. Accordingly, it is possible to prevent the inner short-circuit end 43 from being separated from the inner connection portion 33. As a result, it is possible to improve a connection reliability of the commutator 21.

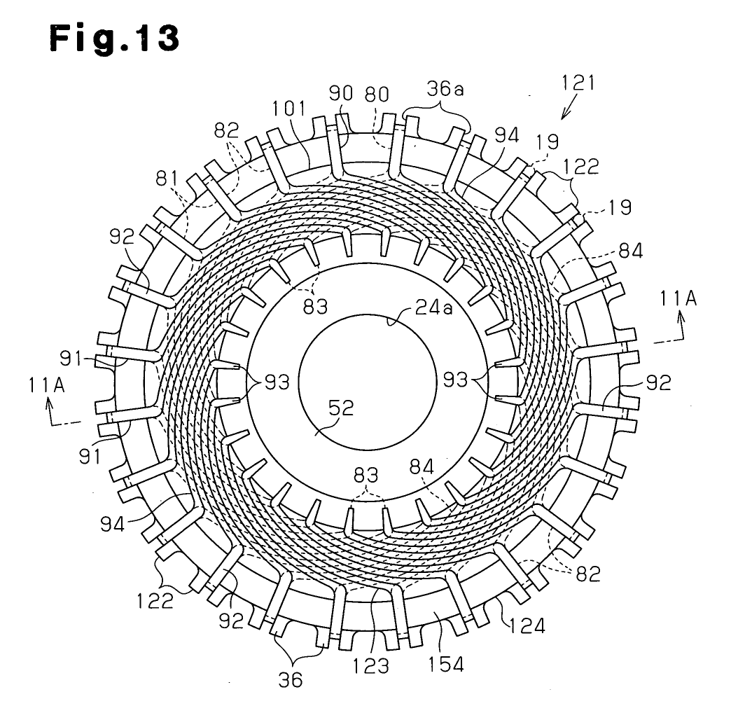

A description will be given below of a second example of the present invention with reference to FIGS. 13 to 17B. The same reference numerals are attached to the same structures as those of the first example, and a description thereof will be omitted.

As shown in FIG. 13, a commutator 121 in accordance with the present example includes twenty-four segments 122 which are arranged in a circumferential direction, a short-circuit unit 123 which short-circuits the segments 122 having the same electric potential with each other, and a holding portion 124 holding the segments 122.

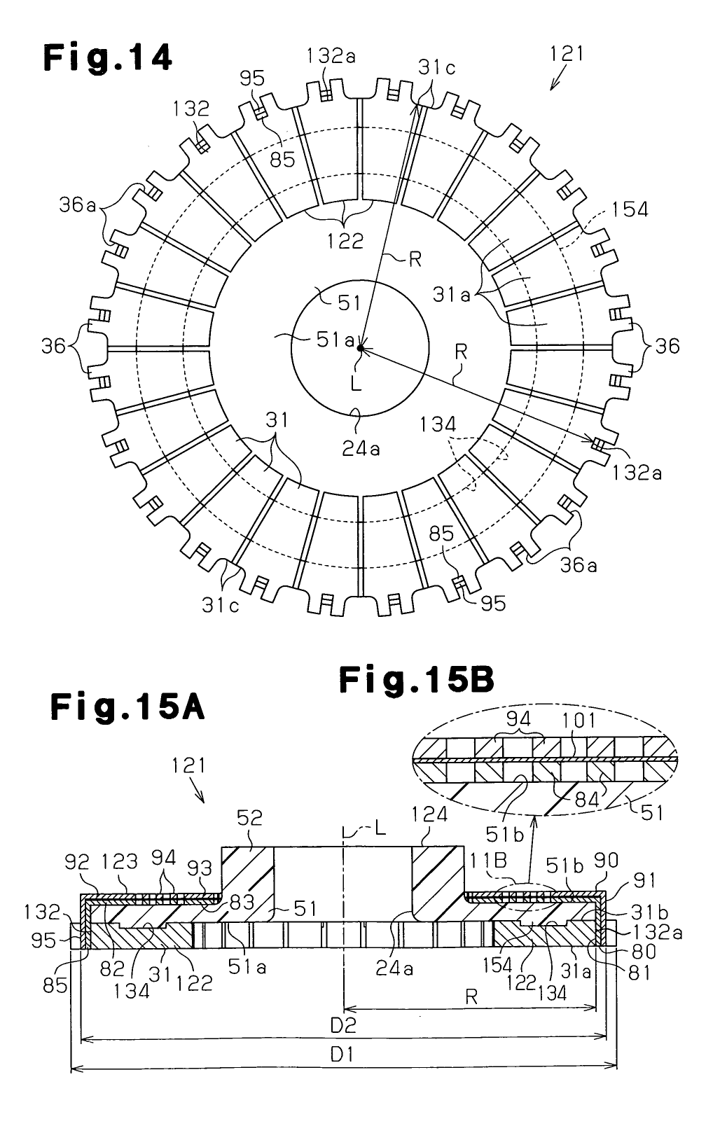

As shown in FIG. 14, the segment 122 has the segment main body 31, and the coil connection portion 36 protruding radially outward from the radially outer end surface 31c of the segment main body 31. The coil connection portion 36 is positioned in a center portion in a circumferential direction of the radially outer end surface 31c. The segment 122 does not have the inner connection portion 33. An outer portion in the radial direction of the segment 122 serves as an outer connection portion 132. A bottom surface of a connection groove 36a serves as an outer connection surface 132a connected to the short-circuit unit 123 in an outer portion in the radial direction of the segment 122. A side wall of the coil connection portion 36 can serve as an outer connection surface. The conducting wire 19 is connected to the short-circuit unit 123 within the connection groove 36a.

As shown in FIG. 15A, the bonded surface 31b has a filling recess 135 in an intermediate portion in the radial direction. As shown in FIG. 15A, the filling recess 135 is formed in a rectangular shape in the case of being viewed from the circumferential direction. The filling recess 135 can serve as a separating recess facing the first coupling portion 84 and the second coupling portion 94.

As shown in FIG. 15A, the thickness of the ring plate 51 is smaller than the thickness of the segment main body 31. An annular holding projection 154 protruding in the axial direction is formed in the end surface 51a. The holding projection 154 is arranged in the filling recess 135. A distance R from a center L of the holding portion 124 to an outer circumferential surface of the holding portion 124 is equal to a distance from the center L to the radially outer end surface 31c. A distance from the center L to the outer connection surface 132a of the connection groove 36a is equal to the distance R. As shown in FIG. 15A, the contact surface 51b is parallel to the slidable contact surface 31a of the segment main body 31.

As shown in FIG. 13, the short-circuit unit 123 includes the first short-circuit group 80 and the second short-circuit group 90. In other words, the first short-circuit group 80 has twenty-four first short-circuit pieces 81. The second short-circuit group 90 has twenty-four second short-circuit pieces 91.

Each of the first short-circuit pieces 81 has a first outer short-circuit end 82, a first inner short-circuit end 83 and a first coupling portion 84. In other words, the first short-circuit group 80 is provided with twenty-four first outer short-circuit ends 82 which are arranged in the circumferential direction, twenty-four first inner short-circuit ends 83 which are arranged in an inner side of the first outer short-circuit end 82, and twenty-four first coupling portions 84. Each of the first coupling portions 84 connects the corresponding first outer short-circuit end 82 to the first inner short-circuit end 83 which is displaced by a predetermined angle in the circumferential direction from the first outer short-circuit end 82. Each of the first outer short-circuit ends 82 is formed in a substantially rectangular plate shape. Each of the first inner short-circuit ends 83 is formed in a substantially trapezoidal plate shape. The thickness of the first short-circuit group 80 is smaller than the thickness of the segment main body 31.

As shown in FIG. 13, the first outer short-circuit end 82 is arranged in such a manner as to correspond to the segment 122 on the contact surface 51b.

As shown in FIG. 15A, a first connection piece 85 extending toward the segment 122 is integrally formed in a radially outer end of the first outer short-circuit end 82. The first connection piece 85 extends in a direction orthogonal to the first outer short-circuit end 82, that is, in the axial direction. The first connection piece 85 is brought into contact with the outer connection surface 132a in a state of being inserted to the connection groove 36a. The first connection piece 85 is brought into contact with the outer circumferential surface of the holding portion 124. The dimension in the circumferential direction of the first connection piece 85 is substantially equal to the dimension in the circumferential direction of the connection groove 36a. A distal end of the first connection piece 85 is positioned within the same plane as the slidable contact surface 31a.

The first inner short-circuit ends 83 are arranged around the boss portion 52 so as to be spaced at a uniform angular interval. The first inner short-circuit end 83 is brought into contact with the contact surface 51b. As shown in FIG. 13, the first inner short-circuit end 83 laps over the first outer short-circuit end 82. The dimension in the circumferential direction of the first inner short-circuit end 83 is slightly smaller than the dimension in the circumferential direction of the first outer short-circuit end 82.

As shown in FIG. 13, the first coupling portion 84 connects the first outer short-circuit end 82 to the first inner short-circuit end 83 which is displaced by 60° from the first outer short-circuit end 82. The first coupling portion 84 is formed in a curved shape which is along an involute curve. As shown in FIG. 13, the first coupling portion 84 extends to the first inner short-circuit end 83 which is displaced by 60° in a counterclockwise direction from the first outer short-circuit end 82, in a state in which the contact surface 51b is visible. The width of the first coupling portion 84 is set such that the adjacent first coupling portions 84 become in non-contact.

As shown in FIG. 13, each of the second short-circuit pieces 91 has a second outer short-circuit end 92, a second inner short-circuit end 93 and a second coupling portion 94. In other words, the second short-circuit group 90 is provided with twenty-four second outer short-circuit ends 92 which are arranged in the circumferential direction, twenty-four second inner short-circuit ends 93 which are arranged in an inner side of the second outer short-circuit end 92, and twenty-four second coupling portions 94. The second outer short-circuit end 92 is formed in a substantially rectangular plate shape. The second inner short-circuit end 93 is formed in a substantially trapezoidal plate shape. The thickness of the second short-circuit group 90 is smaller than the thickness of the segment main body 31.

The second outer short-circuit end 92 is laminated on the first outer short-circuit end 82. The dimension in the circumferential direction of the second outer short-circuit end 92 is equal to the first outer short-circuit end 82. As shown in FIG. 15A, the dimension in the radial direction of the second outer short-circuit end 92 is larger at the thickness of the first connection piece 85 than the first outer short-circuit end 82. A second connection piece 95 extending toward the segment 122 is integrally formed in a radially outer end of the second outer short-circuit end 92. The second connection piece 95 is inserted to the connection groove 36a, and is brought into contact with an outer surface in the radial direction of the first connection piece 85. A distal end of the second connection piece 95 is positioned within the same plane as the slidable contact surface 31a. The first connection piece 85 is positioned between the second connection piece 95 and the outer connection surface 132a.

As shown in FIG. 13, the second inner short-circuit end 93 is laminated on the first inner short-circuit end 83. The second inner short-circuit end 93 has the same shape as the first inner short-circuit end 83. In a state in which the contact surface 51b is visible, each of the second coupling portions 94 connects the corresponding second outer short-circuit end 92 to the second inner short-circuit end 93 which is displaced by 60° in the clockwise direction. The width of the second coupling portion 94 is set such that the second coupling portions 94 which are adjacent to each other in the circumferential direction become in non-contact.

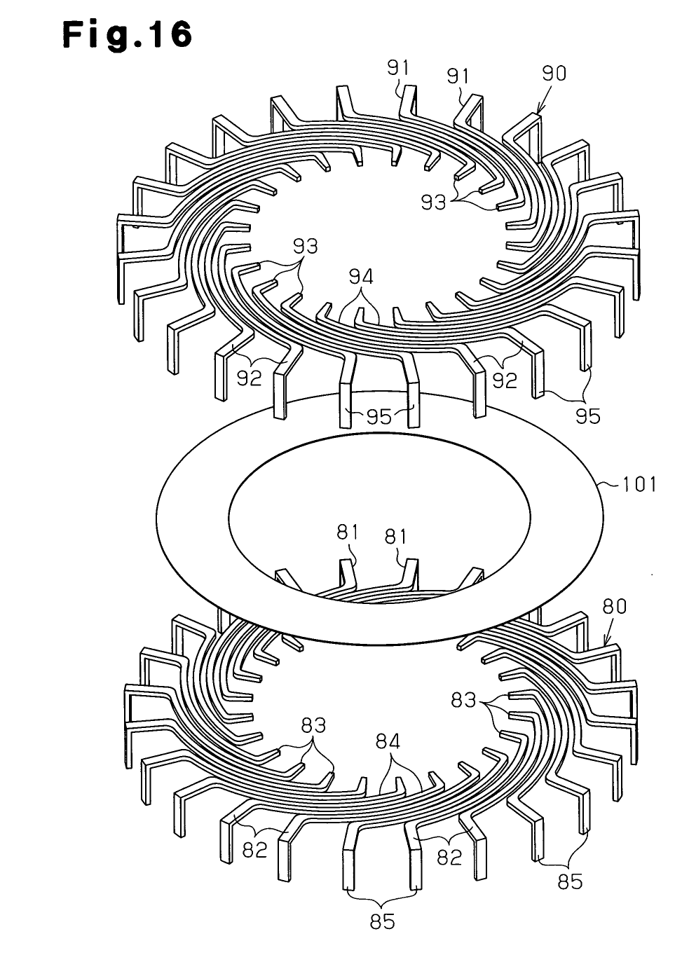

As shown in FIGS. 15B and 16, a ring-shaped insulating paper sheet 101 is arranged between the first coupling portion 84 and the second coupling portion 94. The insulating paper sheet 101 makes the first coupling portion 84 non-contact from the second coupling portion 94.

The first short-circuit group 80 and the second short-circuit group 90 are laminated such that the first coupling portion 84 and the second coupling portion 94 are in the opposite direction. Accordingly, the short-circuit unit 123 short-circuits the segments 122 spaced at 120° with each other. The first outer short-circuit end 82 is electrically connected to the corresponding second outer short-circuit end 92 by welding. The first inner short-circuit end 83 is electrically connected to the corresponding second inner short-circuit end 93 by welding. Since the tabular first short-circuit group 80 is laminated on the tabular second short-circuit group 90, the short-circuit unit 123 is formed in a tabular shape.

The short-circuit unit 123 is arranged in the periphery of the boss portion 52 in a state of being bonded to the contact surface 51b. The end 823 is parallel to the slidable contact surface 31a. In a state in which the first connection piece 85 and the second connection piece 95 are inserted to the connection groove 36a, the short-circuit unit 123 is welded to the coil connection portion 36 from the radial direction.

The outer diameter D1 of the commutator 121, that is, the diameter of an imaginary circle passing through the distal ends of the coil connection portions 36 of the segments 122 is larger than the inner diameter d1 of an imaginary cylinder defined by a plurality of magnets 2, and smaller than the inner diameter d2 of the motor housing 1 (d1<D1<d2). The outer diameter D2 of the short-circuit unit 123 is smaller than the outer diameter D1 of the commutator 121. The outer diameter D2 of the short-circuit unit 123 is larger than the inner diameter d1 with regard to the magnet 2, and smaller than the inner diameter d2 of the motor housing 1 (d1<D2<D1<d2).

A distance between the opening edge 1a of the motor housing 1 and the commutator 121 is smaller than the distance between the opening edge 1a and the magnet 2. The commutator 121 does not lap over the magnet 2 in the axial direction.

Next, a description will be given of a manufacturing method of the commutator 121.

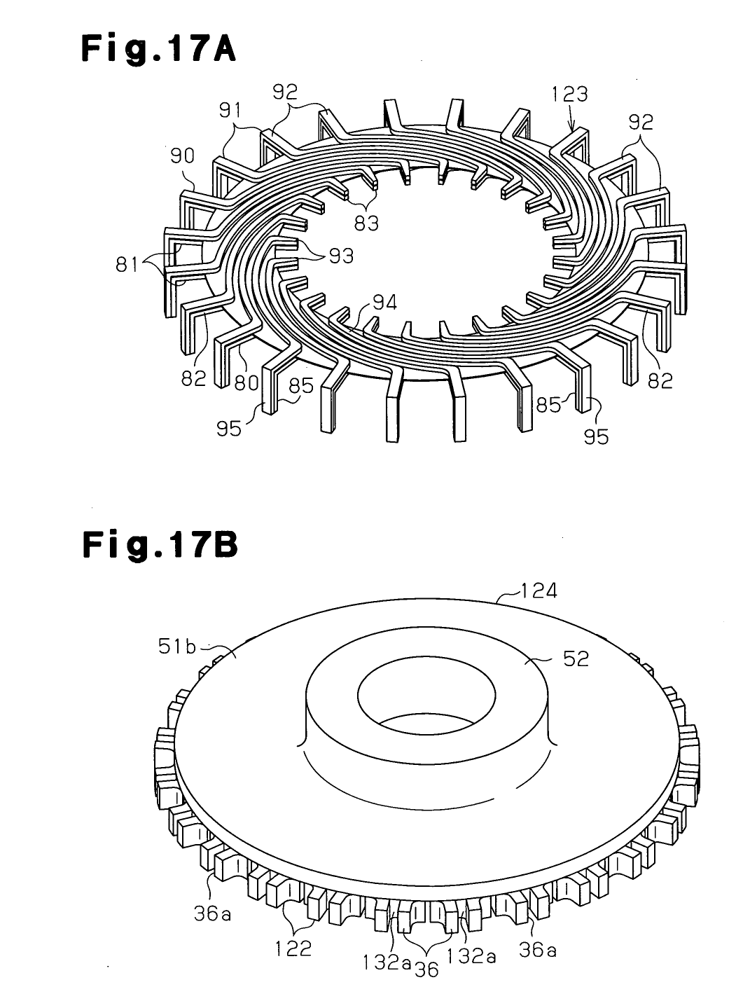

As shown in FIG. 16, the first short-circuit group 80 and the second short-circuit group 90 of the short-circuit unit 123 are first formed. Each of the first connection piece 85 and the second connection piece 95 is formed by stamping the conductive plate member, for example, the copper plate by a punch, and bending the stamped piece. The insulating paper sheet 101 is arranged between the first coupling portion 84 and the second coupling portion 94. The inner surface in the radial direction of the second connection piece 95 is brought into contact with the outer surface in the radial direction of each of the first connection pieces 85. The second outer short-circuit end 92 is laminated on the first outer short-circuit end 82. The second inner short-circuit end 93 is laminated on each of the first inner short-circuit ends 83. As shown in FIG. 17A, the second outer short-circuit end 92 is welded to the first outer short-circuit end 82, and the second inner short-circuit end 93 is welded to the first inner short-circuit end 83, whereby the short-circuit unit 123 is finished.

The segment 122 is formed by stamping the conductive plate member by a punch. The filling recess 135 is formed by setting a part of the segment main body 31 thin at a time of stamping the segment 122. Twenty-four segments 122 are individually stamped and formed.

Next, the holding portion 124 shown in FIG. 17B is formed. Twenty-four segments 122 are arranged in the radial pattern in a forming die for the holding portion 124. The forming die is filled with a molten insulative resin. The filling recess 135 is filled with the insulative resin, and the holding projection 154 is formed. The insulative resin is cooled so as to be hardened, whereby the holding portion 124 is finished and is removed from the forming die.

Next, the short-circuit unit 123 is arranged on the segments 122 which the holding portion 124 holds. As shown in FIGS. 17A and 17B, the first connection piece 85 and the second connection piece 95 of the short-circuit unit 123 are arranged so as to be directed to the holding portion 124. The first connection piece 85 and the second connection piece 95 are inserted to the connection groove 36a. The first short-circuit group 80 is brought into contact with the contact surface 51b of the holding portion 124.

Next, the short-circuit unit 123 is connected to the segment 122 which the holding portion 124 holds. The first connection piece 85 and the second connection piece 95 which are inserted to the connection groove 36a are welded to the outer connection surface 132a. Accordingly, the commutator 121 is finished.

After the rotary shaft 12 is pressed into the fitting hole 24a of the commutator 121, the conducting wire 19 of each of the coils 17a to 17h is arranged in the corresponding connection groove 36a. The conducting wire 19 is welded to the segment 122, the first connection piece 85 and the second connection piece 95 from the outer side in the radial direction. Accordingly, the armature provided with the commutator 121 is finished.

The second example has the advantages (1) and (4) to (9) of the first example mentioned above, and the following advantages.

(22) The short-circuit unit 123 is constituted by the first short-circuit group 80 and the second short-circuit group 90. The first coupling portion 84 is laminated in the opposite direction to the second coupling portion 94. Accordingly, the segments 122 spaced at 120° in the circumferential direction are connected so as to become at the same electric potential. The short-circuit unit 23 in accordance with the first example is connected to the segment 22 in both of the outer short-circuit end 42 and the inner short-circuit end 43. The short-circuit unit 123 in accordance with the second example is not connected to the segment 122 in the inner short-circuit end, but is connected to the segment 122 only in the first outer short-circuit end 82 and the second outer short-circuit end 92. Accordingly, it is possible to easily execute a connecting work between the segment 122 and the short-circuit unit 123.

(23) The short-circuit unit 123 is constituted by the first short-circuit group 80 and the second short-circuit group 90 which are respectively rotated at 60°. Accordingly, for example, in comparison with the case of the short-circuit unit provided with three or more short-circuit groups rotating at 60°, it is possible to minimize the number of the short-circuit groups. Accordingly, it is easy to execute an assembling work of the commutator 121, and it is possible to downsize the dimension in the axial direction of the commutator 21.

(24) The first connection piece 85 and the second connection piece 95 are inserted to the connection groove 36a which the coil connection portion 36 of the holding portion 124 has. Accordingly, it is possible to regulate a relative movement of the short-circuit unit 123 with respect to the segment 122. Therefore, it is easy to position the short-circuit unit 123 to the segment 122, and it is easy to stabilize the connection state of the short-circuit unit 123 to the segment 122.

(25) The thickness of each of the first short-circuit group 80 and the second short-circuit group 90 is smaller than the thickness of the segment 122. For example, in comparison with the segment 122, the first short-circuit group 80 and the second short-circuit group 90 are easily bent. Accordingly, it is easy to manufacture the short-circuit unit 123 and the segment 122.

(26) The boss portion 52 is inserted to the inner side of the short-circuit unit 123, whereby the short-circuit unit 123 is assembled in the holding portion 124. Accordingly, the movement in the radial direction of the short-circuit unit 123 is regulated by the boss portion 52. Therefore, the short-circuit unit 123 is hard to be displaced with respect to the holding portion 124.

(28) The short-circuit unit 123 is arranged on the segments 122 held by the holding portion 124. In other words, in a state in which the holding portion 124 defines the positions of a plurality of segments 122, the short-circuit unit 123 is arranged on the segments 122. Accordingly, it is easy to arrange the short-circuit unit 23 in the segment 122.

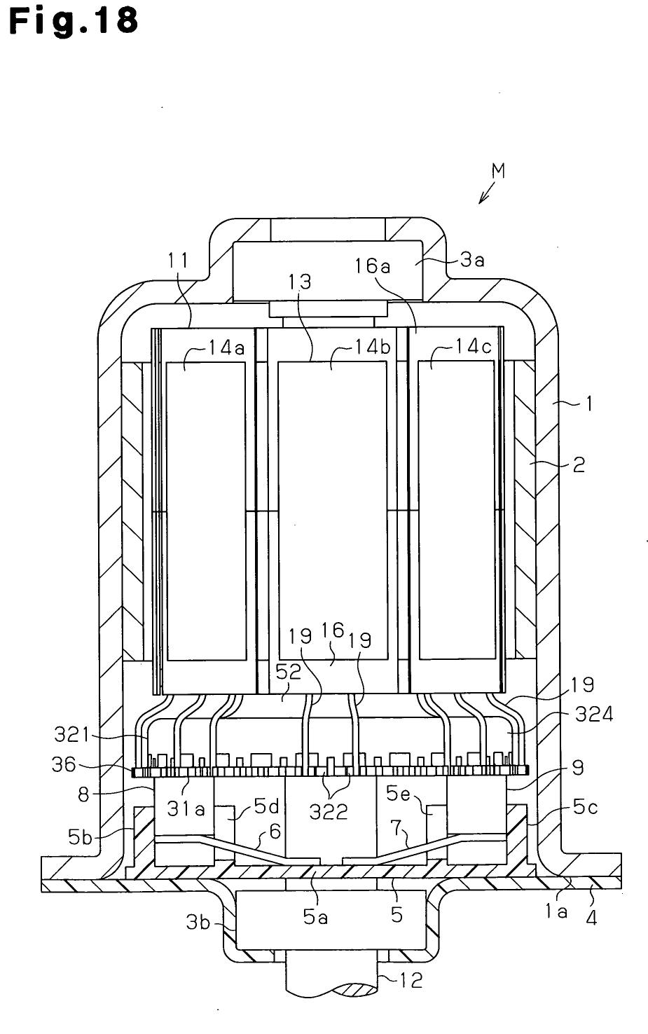

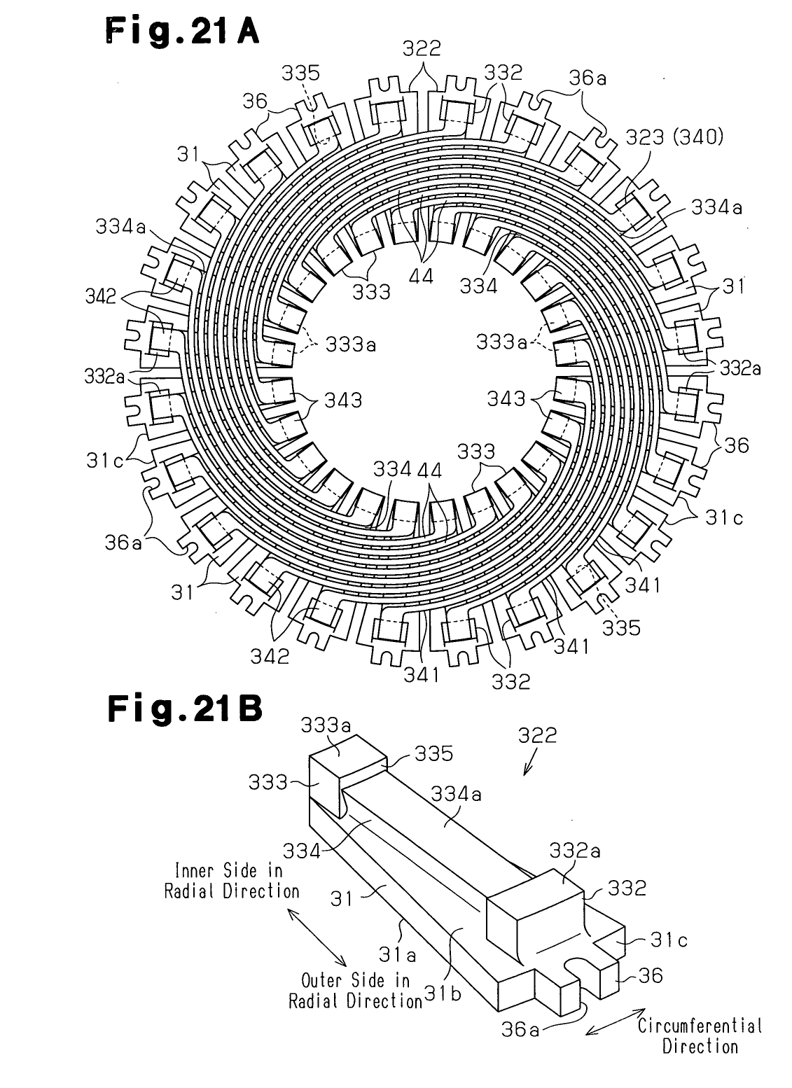

A description will be given below of a third example in accordance with the present invention with reference to FIGS. 18 to 24. As shown in FIGS. 21A and 21B, an outer connection portion 332 is formed in a rectangular parallelepiped shape in a segment 322 of a commutator 321. The outer connection portion 332 protrudes to an opposite side to the slidable contact surface 31a from a portion near a radially outer end of the segment main body 31. The dimension in the circumferential direction of the outer connection portion 332 is smaller than the dimension in the circumferential direction of the radially outer end of the segment main body 31. A protruding amount of the outer connection portion 332, that is, the dimension in the vertical direction in FIG. 21B is slightly larger than the thickness of the segment main body 31. In FIG. 21B, an upper end of the outer connection portion 332 is an outer connection surface 332a which is parallel to the slidable contact surface 31a.

As shown in FIG. 21B, an inner connection portion 333 is formed in a rectangular parallelepiped shape. The inner connection portion 333 protrudes to an opposite side to the slidable contact surface 31a from a radially inner end of the segment main body 31. The dimension in the circumferential direction of the inner connection portion 333 is equal to or slightly smaller than the dimension in a circumferential direction of the radially inner end of the segment main body 31. A protruding amount of the inner connection portion 333 is slightly larger than the thickness of the segment main body 31. In FIG. 21B, an upper end of the inner connection portion 333 is an inner connection surface 333a which is parallel to the slidable contact surface 31a. The inner connection surface 333a exists within the same imaginary plane as the outer connection surface 332a.

As shown in FIG. 21B, the segment main body 31 has an intermediate protruding portion 334 extending to the inner connection portion 333 from the outer connection portion 332. The intermediate protruding portion 334 protrudes from the bonded surface 31b of the segment main body 31. In other words, the intermediate protruding portion 334 protrudes to an opposite side to the slidable contact surface 31a, and extends along a radial direction of the commutator 321. The thickness of the intermediate protruding portion 334 is smaller than the thickness of the outer connection portion 332. Accordingly, a separating recess 335 is positioned between the outer connection portion 332 and the inner connection portion 333. In other words, a separating recess 335 is defined by a second bonded surface 334a corresponding to an upper surface of the intermediate protruding portion 334, an inner surface in a radial direction of the outer connection portion 332, and an outer surface in a radial direction of the inner connection portion 333. The second bonded surface 334a, the slidable contact surface 31a, the outer connection surface 332a and the inner connection surface 333a are parallel to each other.

The coil connection portion 36 protrudes to the outer side in the radial direction from the radially outer end surface 31c of the segment main body 31.

As shown in FIG. 21A, the short-circuit unit 323 is constituted by one short-circuit group 340. The short-circuit group 340 has twenty-four short-circuit pieces 341. Each of the short-circuit pieces 341 has an outer short-circuit end 342, an inner short-circuit end 343 and a coupling portion 44.

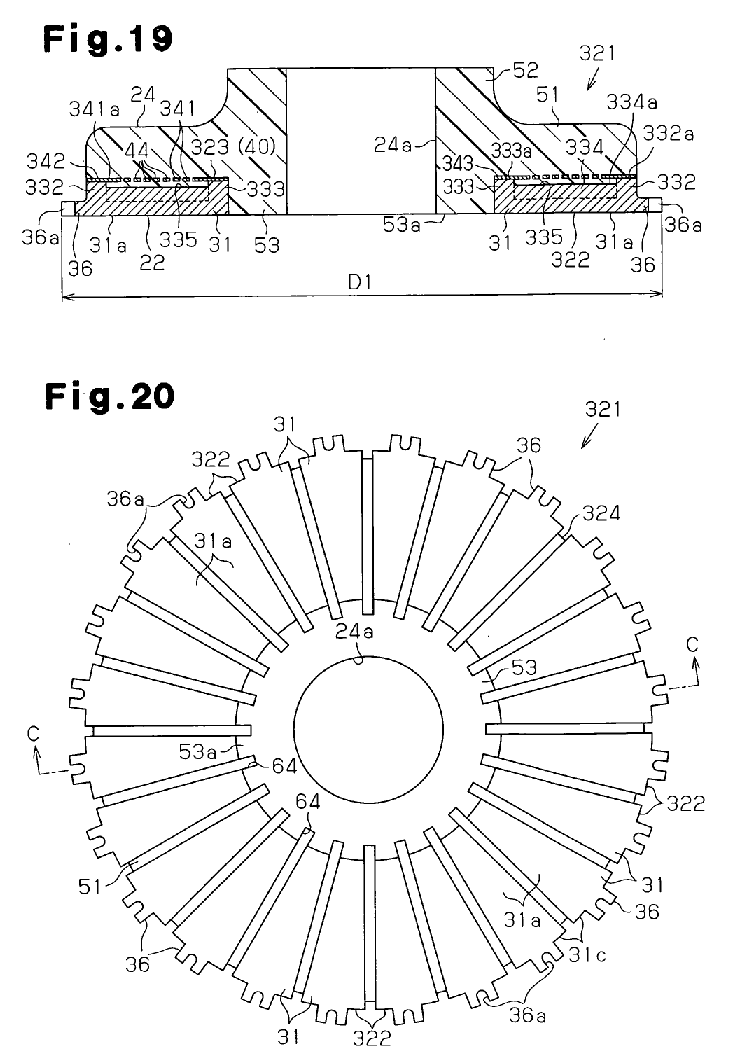

As shown in FIGS. 19 and 21A, the outer short-circuit end 342 has a rectangular tabular shape which is parallel to the slidable contact surface 31a of the segment 322. In other words, the outer short-circuit end 342 is parallel to the outer connection surface 332a. The dimension in the circumferential direction of the outer short-circuit end 342 is slightly smaller than the dimension in the circumferential direction of the outer connection surface 332a. The dimension in the radial direction of the outer short-circuit end 342 is slightly larger than the dimension in the radial direction of the outer connection surface 332a. A radially outer end of each of the outer short-circuit ends 342 agrees with the radially outer end of the outer connection surface 332a in the segment 322, as viewed in the axial direction.

Each of the inner short-circuit ends 43 has a rectangular tabular shape which is parallel to the slidable contact surface 31a of the segment 322, and the inner connection surface 333a. The dimension in the circumferential direction of each of the inner short-circuit ends 43 is substantially equal to the dimension in the circumferential direction of the inner connection surface 333a in the segment 322. The dimension in the radial direction of each of the inner short-circuit ends 43 is slightly larger than the dimension in the radial direction of the inner connection surface 333a. A radially inner end of each of the inner short-circuit ends 43 agrees with a radially inner end of the inner connection surface 333a.

As shown in FIG. 21A, each of the coupling portions 44 connects the corresponding outer short-circuit end 342 to the inner short-circuit end 43 which is displaced by 120° from the outer short-circuit end 342. As shown in FIG. 19, the thickness of the short-circuit group 340 is smaller than the thickness of the segment main body 31.

As shown in FIGS. 19 and 21A, the outer short-circuit end 342 is welded to the outer connection surface 332a of the segment 322. The inner short-circuit end 43 is welded to the inner connection surface 333a. The tabular short-circuit unit 323 is arranged parallel to the slidable contact surface 31a. Each of the coupling portions 44 of the short-circuit unit 323 faces the separating recess 335 with respect to the axial direction. Accordingly, the coupling portion 44 is in a non-contact state with respect to the second bonded surface 334a of the intermediate protruding portion 334.

The short-circuit unit 323 short-circuits the segments 322 arranged so as to be spaced at 120° in the circumferential direction with each other.

As shown in FIG. 19, the holding portion 324 has the ring plate 51, the boss portion 52, and the cylindrical support portion 53. The support portion 53 extends in an opposite direction to the boss portion 52 from the ring plate 51. Twenty-four segments 322 are arranged in a radial pattern around the support portion 53.

A radially inner end of each of the segments 322 is brought into contact with the support portion 53. The distal end surface 53a of the support portion 53 is positioned within the same plane as the slidable contact surface 31a.

The separating recess 335 of each of the segments 322 is filled with the insulative resin material constituting the ring plate 51. Accordingly, it is possible to secure the insulating state between the coupling portion 44 and the second bonded surface 334a of the intermediate protruding portion 334.

The conducting wire 19 of each of the coils 17a to 17h is welded to the coil connection portion 36 from the outer side in the radial direction, in the connection groove 36a.

Next, a description will be given of a manufacturing method of the commutator 321.

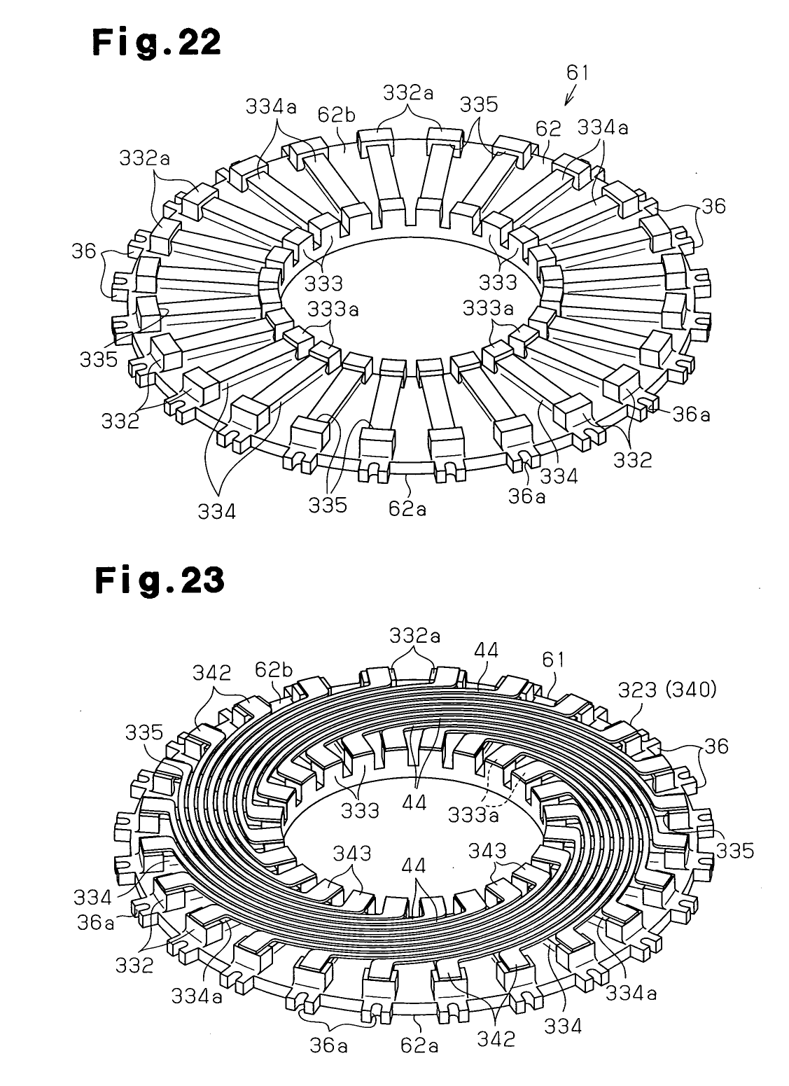

As shown in FIG. 22, in order to manufacture a plurality of segments 322, a mother member 61 is prepared. The mother member 61 is provided with an annular mother main body 62 to manufacture a plurality of the segment main bodies 31. The width in a radial direction of the mother main body 62 is equal to the dimension in the radial direction of the segment main body 31. The thickness of the mother main body 62 is equal to the thickness of the segment main body 31. The mother main body 62 has a flat surface 62a for forming the slidable contact surface 31a, and a bonded surface 62b in an opposite side to the flat surface 62a. In FIG. 22, the flat surface 62a faces downward is directed to a lower side, and the bonded surface 62b faces upward. Twenty-four outer connection portions 332, twenty-four inner connection portions 333 and twenty-four intermediate protruding portions 334 protrude from the bonded surface 62b. Twenty-four separating recesses 335 also exists in the bonded surface 62b. Twenty-four coil connection portions 36 protrude radially outward from an outer circumferential surface of the mother main body 62.

The mother member 61 is formed by sintering a conductive metal pulverulent body, for example, a copper pulverulent body. The metal pulverulent body is pressurized in the axial direction of the mother member 61 at a time of sintering. In other words, the metal pulverulent body is pressurized from a direction perpendicular to the flat surface 62a.

Further, the short-circuit unit 323 shown in FIG. 23 is formed by stamping the conductive plate member, for example, the copper plate by a punch.

As shown in FIG. 23, the short-circuit unit 323 is arranged in the mother member 61. The outer short-circuit end 342 is arranged on the outer connection portion 332, and the inner short-circuit end 43 is arranged on the inner connection portion 333. The tabular short-circuit unit 323 is parallel to the flat surface 62a in a state of being arranged in the mother member 61. The coupling portion 44 faces the separating recess 335 in the axial direction. A gap exists between the second bonded surface 334a of the intermediate protruding portion 334 and the coupling portion 44. In other words, the segment 322 is in non-contact with the coupling portion 44.

After arranging the short-circuit unit 323 in the mother member 61, the outer short-circuit end 342 is welded to the outer connection portion 332. The inner short-circuit end 43 is welded to the inner connection portion 333.

Next, the holding portion 324 is formed. The mother member 61 and the short-circuit unit 323 which are connected to each other are accommodated in the forming die. The forming die is filled with molten insulative resin. The insulative resin fills between the coupling portions 44 which are adjacent in the circumferential direction, and in the separating recess 335. The insulative resin also fills the inner side in the radial direction of the mother member 61 so as to form the support portion 53. If the insulative resin is cooled, the holding portion 324 is finished, and is removed from the forming die.

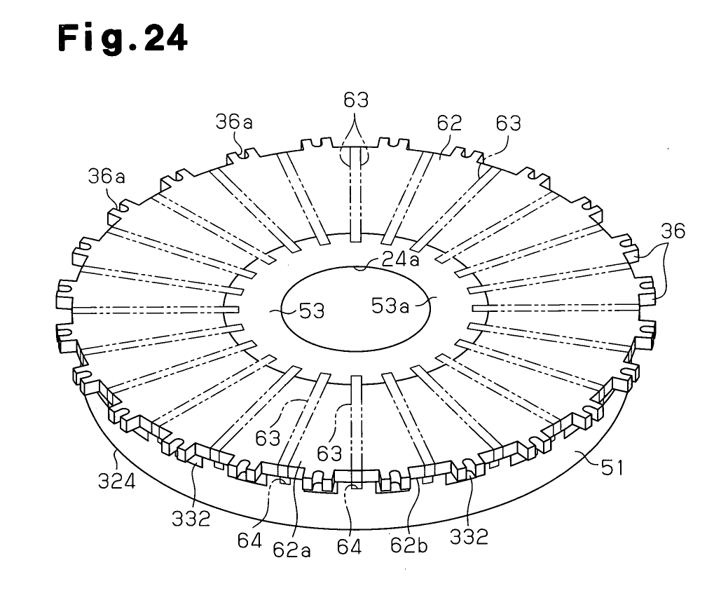

As shown in FIG. 24, twenty-four segments 322 are formed by cutting the mother member 61 and the holding portion 324 along a two-dot chain line 63. A groove 64 having a depth which does not reach the short-circuit unit 323 is formed in the holding portion 324. The two-dot chain line 63 extends in a radial direction of the mother main body 62 between the outer connection portions 332 which are adjacent in the circumferential direction. In a state in which each of the bonded surfaces 31b is held by the holding portion 324, the mother member 61 is cut. Accordingly, each of the segments 322 is already held by the holding portion 324 in a state of being disconnected from the mother member 61. As a result, the commutator 321 is finished.

The third example has the following advantages.

(31) Each of the segments 322 has the separating recess 335 between the outer connection portion 332 and the inner connection portion 333. The coupling portion 44 of the short-circuit unit 323 faces the separating recess 335. Accordingly, it is possible to maintain the coupling portion 44 in non-contact with the segment 322, and it is possible to secure an insulating characteristic of the coupling portion 44 with respect to the segment 322. Each of the segments 322 is constituted by a comparatively simple structure having the outer connection portion 332 and the inner connection portion 333. Accordingly, it is possible to prevent the manufacturing step of the commutator 321, in which the insulating characteristic is secured, from being complicated.

(32) The separating recess 335 is filled with the insulating material of the holding portion 324. Accordingly, it is possible to prevent each of the segments 322 from being short-circuited with each of the coupling portions 44.

(34) The holding portion 324 has the support portion 53 which is brought into contact with the radially inner end of each of the segments 322. The support portion 53 regulates the movement in the radial direction of the segment 322. The distal end surface 53a of the support portion 53 exists within the same plane as the slidable contact surface 31a. Accordingly, the entire circumferential surface of the support portion 53 is brought into contact with the segment 322. In other words, it is possible to secure a contact area between the support portion 53 and the segment 322. Therefore, the holding portion 324 further stably holds each of the segments 322.

(35) In a state in which the holding portion 324 holds the mother member 61, the mother member 61 is cut, and a plurality of segments 322 are formed. Accordingly, a plurality of segments 322 are prevented from being scattered in all directions during the manufacturing step. Therefore, for example, in comparison with the case that the holding portion 324 is manufactured after individually manufacturing a plurality of segments 322, a handling of the parts of the commutator 321 is more easily executed during the manufacturing step.

(36) The mother member 61 is formed in accordance with the sintering process. Accordingly, even if the shape of the segment 322 is complicated, it is possible to easily form the segment 22. The present example is easier, for example, than the case that the segment 322 is formed from a flat plate.

In the sintering process, the material of the mother member 61 is pressurized. Accordingly, a flatness of the slidable contact surface 31a is improved. As a result, the anode brush 8 and the cathode brush 9 can be further smoothly brought into slidable contact with the slidable contact surface 31a. Therefore, it is possible to improve a reliability of a current supply to the commutator 321 from the anode brush 8 and the cathode brush 9.

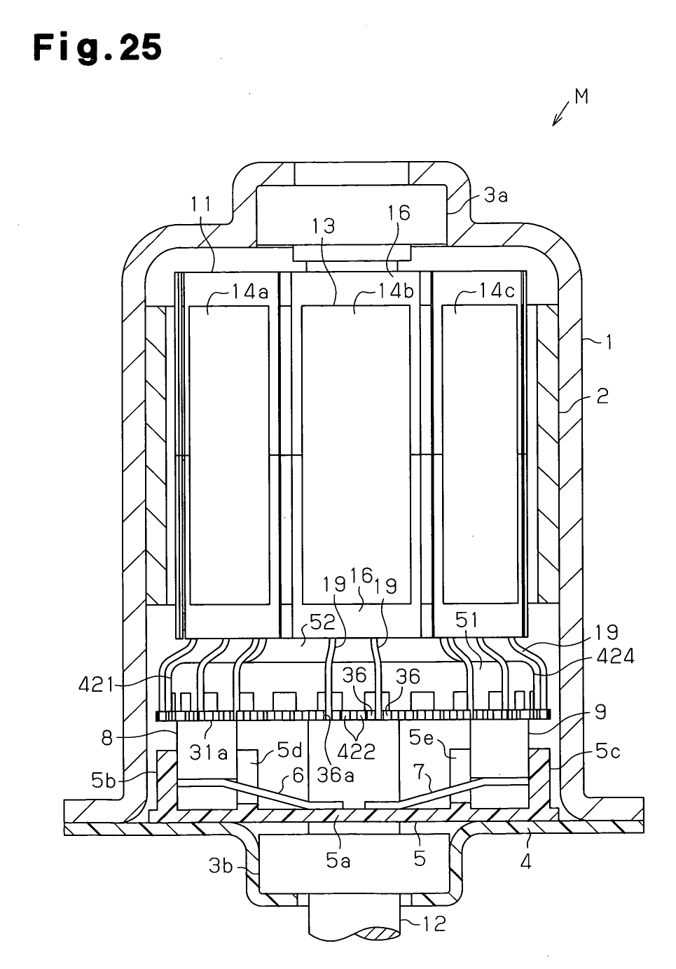

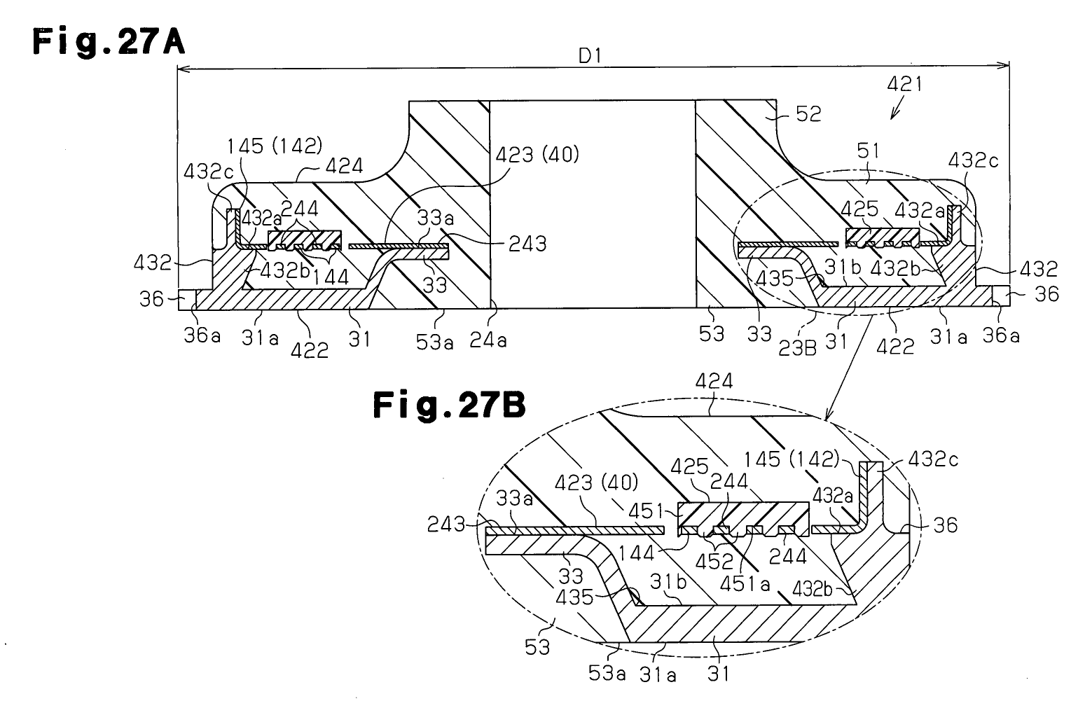

A description will be given of a fourth example in accordance with the present invention with reference to FIGS. 25 to 39. As shown in FIG. 27A, a commutator 421 has twenty-four segments 422, a short-circuit unit 423 and a holding portion 424. Further, the commutator 421 has a separating member 425 arranged in the short-circuit unit 423. The holding portion 424 holds the segments 422, the short-circuit unit 423 and the separating member 425.

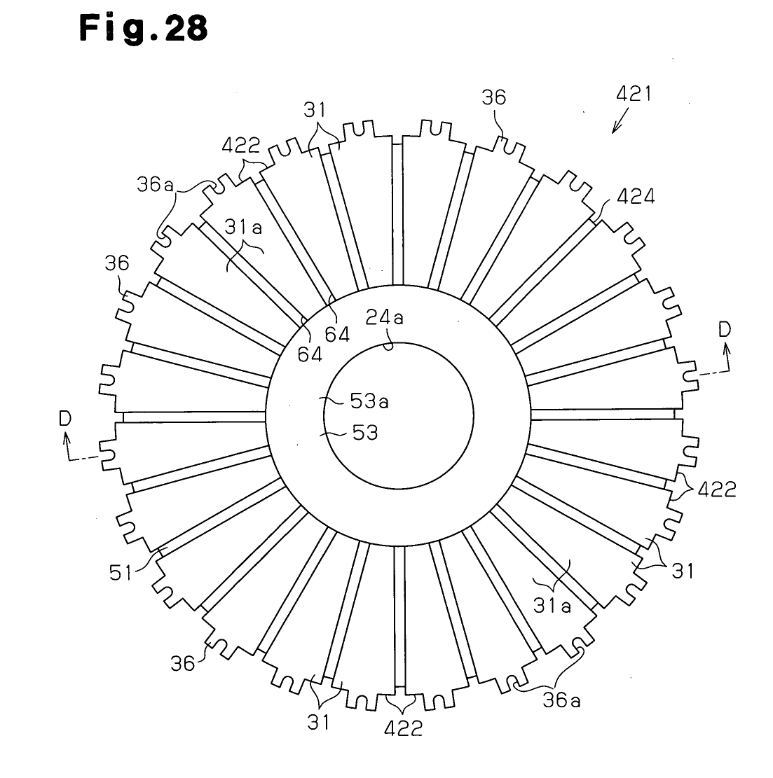

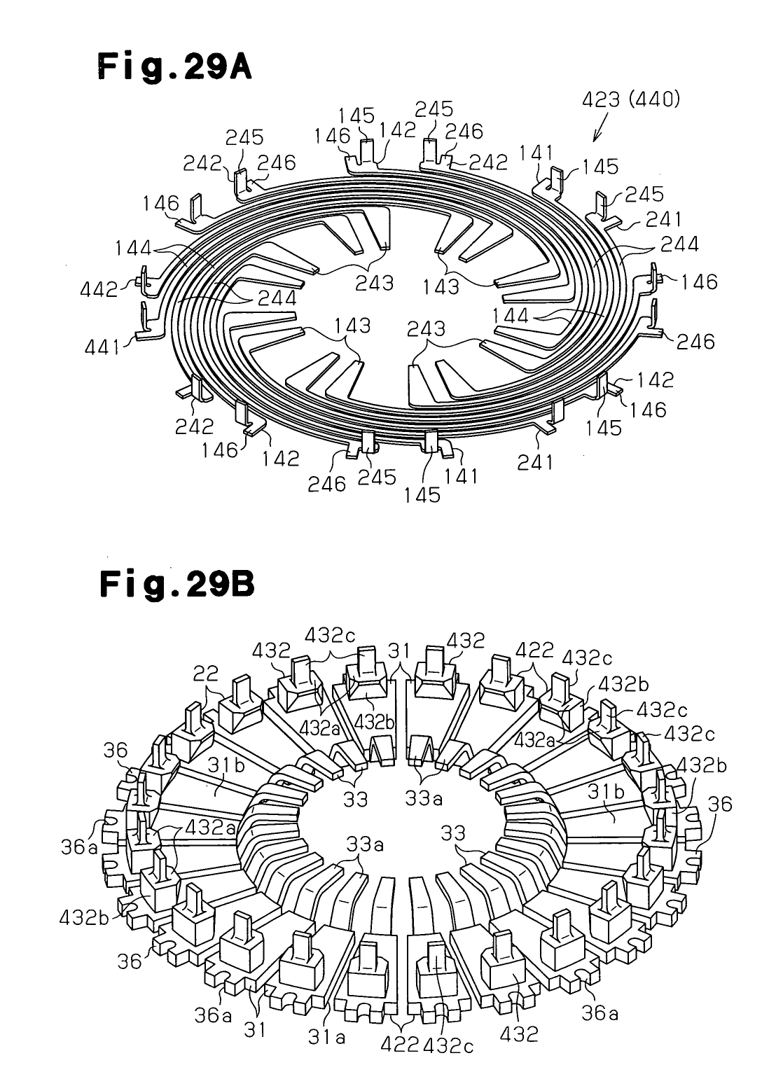

As shown in FIGS. 28 and 29B, each of the segments 422 is provided with the segment main body 31, an outer connection portion 432, the inner connection portion 33, and the coil connection portion 36. The segment main body 31 and the inner connection portion 33 are the same as those shown in FIGS. 7 and 11B. The coil connection portion 36 is the same as that shown in FIG. 14.

The outer connection portion 432 is close to the radially outer end of the segment main body 31. The outer connection portion 432 includes a substantially rectangular parallelepiped base portion 432b protruding from the bonded surface 31b, and a connection projection 432c protruding to an opposite side to the slidable contact surface 31a from the base portion 432b. As shown in FIG. 29B, the dimension in the circumferential direction of the base portion 432b is smaller than the dimension in the circumferential direction of the corresponding portion of the segment main body 31. The base portion 432b has an outer connection surface 432a which is parallel to the slidable contact surface 31a. The connection projection 432c is formed in a strip shape, and extends to an opposite side to the slidable contact surface 31a from a substantially center of the outer connection surface 432a. An inner surface in a radial direction of the base portion 432b is sloped in such a manner that the holding portion 424 is well engaged with the outer connection portion 432. Each of the outer connection surfaces 432a is arranged within the same plane as each of the inner connection surfaces 33a.

As shown in FIG. 29A, the short-circuit unit 423 includes one tabular short-circuit group 440. The short-circuit group 440 includes eight first short-circuit pieces 141, and eight second short-circuit pieces 241. In other words, eight first short-circuit pieces 141 and eight second short-circuit pieces 241 serve as totally sixteen short-circuit pieces (short-circuit lines). The first short-circuit pieces 141 and the second short-circuit pieces 241 are arranged alternately in the circumferential direction.

Each of the tabular first short-circuit pieces 141 includes a first outer short-circuit end 142, a first inner short-circuit end 143 and a first coupling portion 144.

The first outer short-circuit end 142 has a substantially rectangular tabular first contact portion 146 extending in a radial direction, and a first connection piece 145 extending perpendicularly to the first contact portion 146. In FIG. 29A, the first connection piece 145 serving as a weld portion is positioned in a clockwise side of the first contact portion 146.

As shown in FIG. 29A, as viewed in the above of FIG. 27A, the first coupling portion 144 couples the corresponding first outer short-circuit end 142 to the first inner short-circuit end 143 which is displaced by 120° in the clockwise direction from the first outer short-circuit end 142. The first coupling portion 144 has a rectangular cross-sectional. Eight first outer short-circuit ends 142 are arranged at a uniform angular interval, that is, at an interval of 45°. Eight first inner short-circuit ends 143 are also arranged at an interval of 45°.

Each of the tabular second short-circuit pieces 241 includes a second outer short-circuit end 242, a second inner short-circuit end 243 and a second coupling portion 244.

The second outer short-circuit end 242 has a second connection piece 245 and a second contact portion 246 which are line symmetrical to the first connection piece 145 and the first contact portion 146.

The second coupling portion 244 couples the corresponding second outer short-circuit end 242 to the inner short-circuit end 243 which is displaced by 120° in the clockwise direction from the second outer short-circuit end 242. Eight second outer short-circuit ends 242 are arranged at an interval of 45°. The second connection piece 245 is adjacent to the closer first connection piece 145 at an interval of 15°, and is adjacent to the far side first connection piece 145 at an interval of 30°.

The second inner short-circuit end 243 is adjacent to the closer first inner short-circuit end 143 at an interval of 15°, and is adjacent to the far side first inner short-circuit end 143 at an interval of 30°. 15° corresponds to an angle of an interval between twenty-four segments 422.

As shown in FIG. 35, each of the first contact portion 146 and the second contact portion 246 is brought into contact with the outer connection surface 432a. The outer surface in the radial direction of the first connection piece 145 is welded to the inner surface in the radial direction of the connection projection 432c. The outer surface in the radial direction of the second connection piece 245 is welded to the inner surface in the radial direction of the connection projection 432c. The short-circuit unit 423 short-circuits the segments 422 at an interval of 120° with each other.

The base portion 432b and the inner connection portion 33 protrude to an opposite side to the slidable contact surface 31a from the bonded surface 31b. Accordingly, the first coupling portion 144 is in non-contact with the bonded surface 31b. The second coupling portion 244 is also in non-contact with the bonded surface 31b.

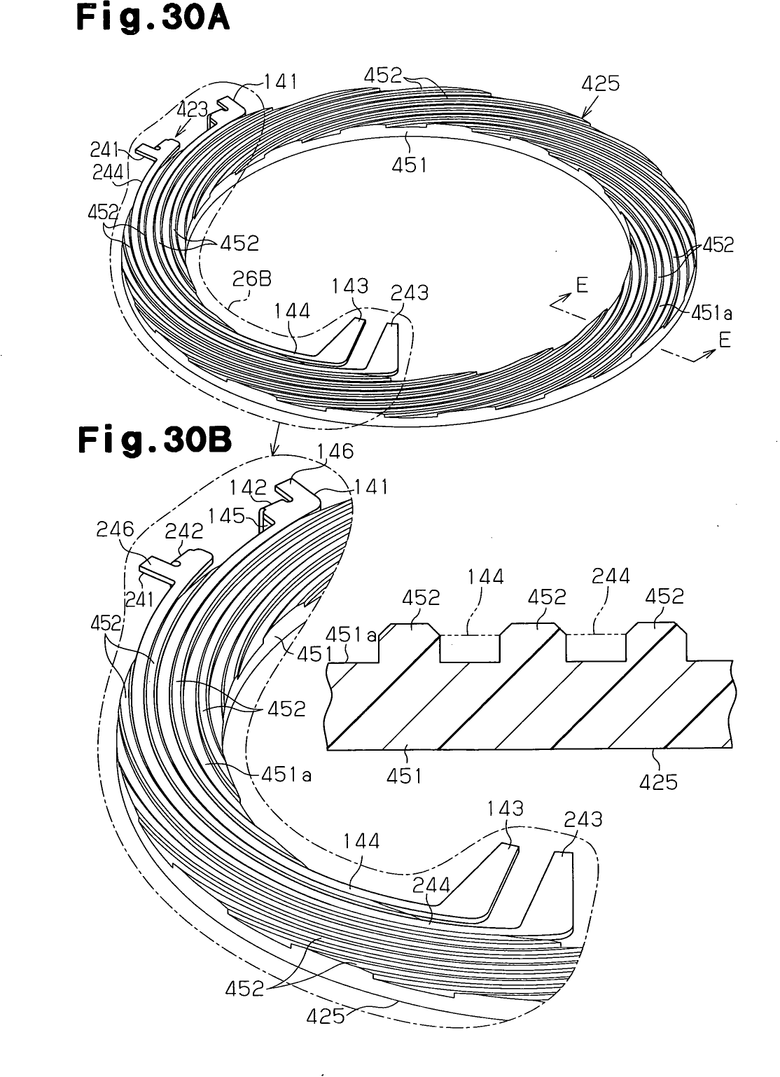

As shown in FIGS. 27A and 27B, the separating member 425 is formed in a substantially circular ring shape. The separating member 425 is assembled in the short-circuit unit 423. The separating member 425 is made of a thermosetting resin having an insulating characteristic. As shown in FIG. 30A, the separating member 425 has a circular ring tabular support plate 451, and sixteen separating protrusions 452 serving as separating projections formed on the support plate 451. FIGS. 30A and 30B show the first short-circuit piece 141 and the second short-circuit piece 241 one by one.

The support plate 451 has a size corresponding to the first coupling portion 144 and the second coupling portion 244. The outer diameter of the support plate 451 is slightly smaller than the outer diameter of the first coupling portion 144. The inner diameter of the support plate 451 is slightly larger than the inner diameter of the first coupling portion 144. The thickness of the support plate 451 is slightly larger than the thickness of the first coupling portion 144.

As shown in FIGS. 30A and 30B, each of the separating protrusions 452 is positioned on the contact surface 451a of the support plate 451. The separating protrusion 452 extends along the first coupling portion 144 and the second coupling portion 244 from an inner peripheral edge of the contact surface 451a to an outer peripheral edge. The separating protrusions 452 are arranged so as to be spaced at a uniform angular interval in the circumferential direction. The width of each of the separating protrusions 452 is equal to or slightly smaller than the gap between the adjacent first coupling portion 144 and second coupling portion 244.

As shown in FIG. 30C, each of the separating protrusions 452 has a rectangular cross section. Both of corner portions in a distal end of each of the separating protrusions 452 are chamfered. A protruding amount of each of the separating protrusions 452 is slightly larger than the thickness of the first coupling portion 144.

As shown in FIGS. 27A and 27B, the separating protrusion 452 is arranged in an opposite side to the segment 422 with respect to the short-circuit unit 423. The separating protrusion 452 gets into the portion between the adjacent first coupling portion 144 and second coupling portion 244. The separating protrusion 452 prevents the first coupling portion 144 and the second coupling portion 244 from being short-circuited with each other. The contact surface 451a is brought into contact with the corresponding first coupling portion 144 or second coupling portion 244.

As shown in FIG. 27A, the segment 422, the short-circuit unit 423 and the separating member 425 are embedded in the holding portion 424. As viewed in the axial direction, the ring plate 51 of the holding portion 424 is flush with an outer end surface in a radial direction of the base portion 432b.

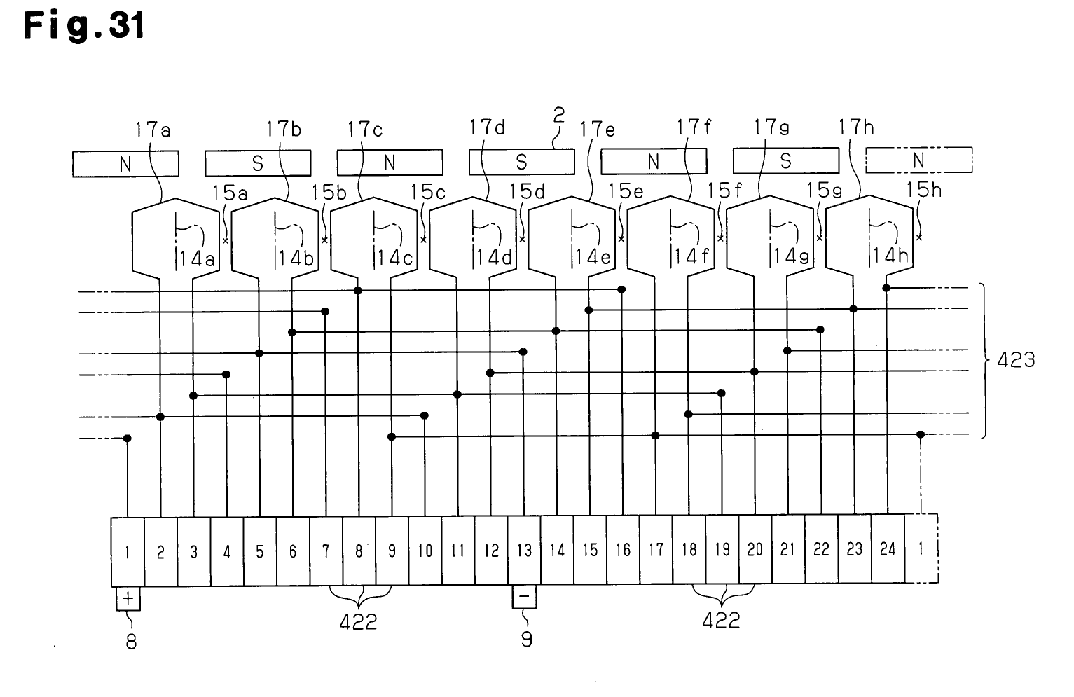

In the short-circuit unit 423 shown in FIG. 31, the number of the wirings is reduced in comparison with the short-circuit unit 423 shown in FIG. 10. Referring to FIGS. 29A and 29B, the first outer short-circuit end 142 is arranged in one of a pair of segments 422 which are adjacent to each other in the circumferential direction, and the second outer short-circuit end 242 is arranged in the other.

As shown in FIGS. 29 to 33, the fourth example can short-circuit twenty-four segments 422 by the reduced number of, or sixteen short-circuit pieces 141 and 241. For example, in the first to third example, twenty-four short-circuit pieces 41 are required.

In other words, in the case of setting the number of magnetic poles of the magnet 2 to P, the number of the segments 422 to (P/2)·n, and the number of the segments 422 to be set to the same electric potential to (P/2), the number of the short-circuit pieces can be reduced to ((P/2)−1)·n. In this case, the number (P/2) of the segments 422 is a multiple of the number (P/2) of the segments 422 to be set to the same electric potential.

Specifically, in the case shown in FIGS. 29 to 33, the number of magnetic poles N equals to 6, the number (P/2)·n of the segments 422 equals to 24, and the number (P/2) of the segments 422 to be set to the same electric potential equals to 3. In other words, a relation P=6 and n=8 is established. Accordingly, a total number of the short-circuit pieces 141 and 241 is set to ((P/2)−1)·n=16. Since the relation ((P/2)−1)·n=(P/2)·n−n is established, the total number of the short-circuit pieces 141 and 241 can be reduced at n, that is, eight in comparison with the number of the segments 422.

Sixteen short-circuit pieces 141 and 241 are connected to two segments 422 among twenty-four segments 422, are connected to the next two segments 422 while skipping over one segment 422 in the circumferential direction, and are connected to the next two segments while skipping over one segment 422, and these operations are repeated periodically.

The conducting wire 19 of each of the coils 17a to 17h is welded to the segment 422 from the outer side in the radial direction in a state of being arranged in the connection groove 36a of the corresponding segment 422.

Next, a description will be given of a manufacturing method of the commutator 421.

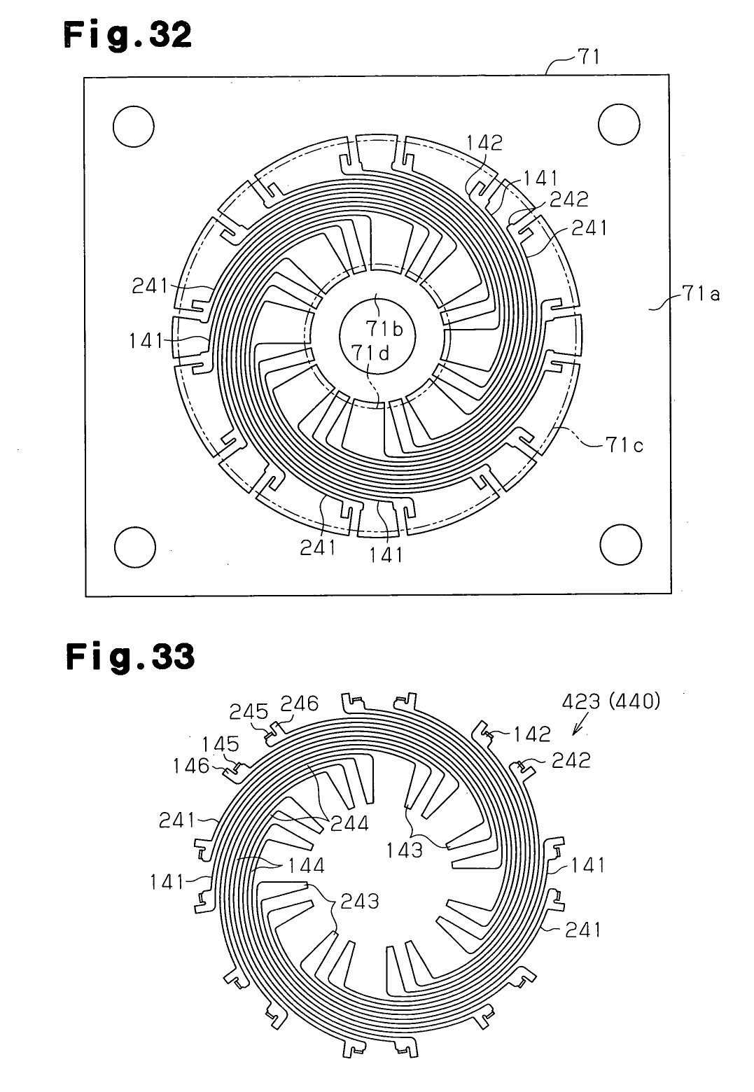

As shown in FIG. 32, eight first short-circuit pieces 141 and eight second short-circuit pieces 241 are formed by press working a conductive plate member 71 such as a copper plate. At a time of finishing the press work, the plate member 71 has an outer coupling ring 71a and an inner coupling ring 71b. The outer coupling ring 71a couples the first outer short-circuit end 142 to the second outer short-circuit end 242. The inner coupling ring 71b couples the first inner short-circuit end 143 to the second inner short-circuit end 243.

FIG. 32 shows an outer cut circle 71c by a two-dot chain line, and an inner cut circle 71d by a two-dot chain line. The first short-circuit piece 141 and the second short-circuit piece 241 are disconnected from the outer coupling ring 71a along the outer cut circle 71c, and are disconnected from the inner coupling ring 71b along the inner cut circle 71d.

As shown in FIG. 33, the first connection piece 145 and the second connection piece 245 are bent and formed. Accordingly, the short-circuit unit 423 constituted by one short-circuit group 440 is finished.

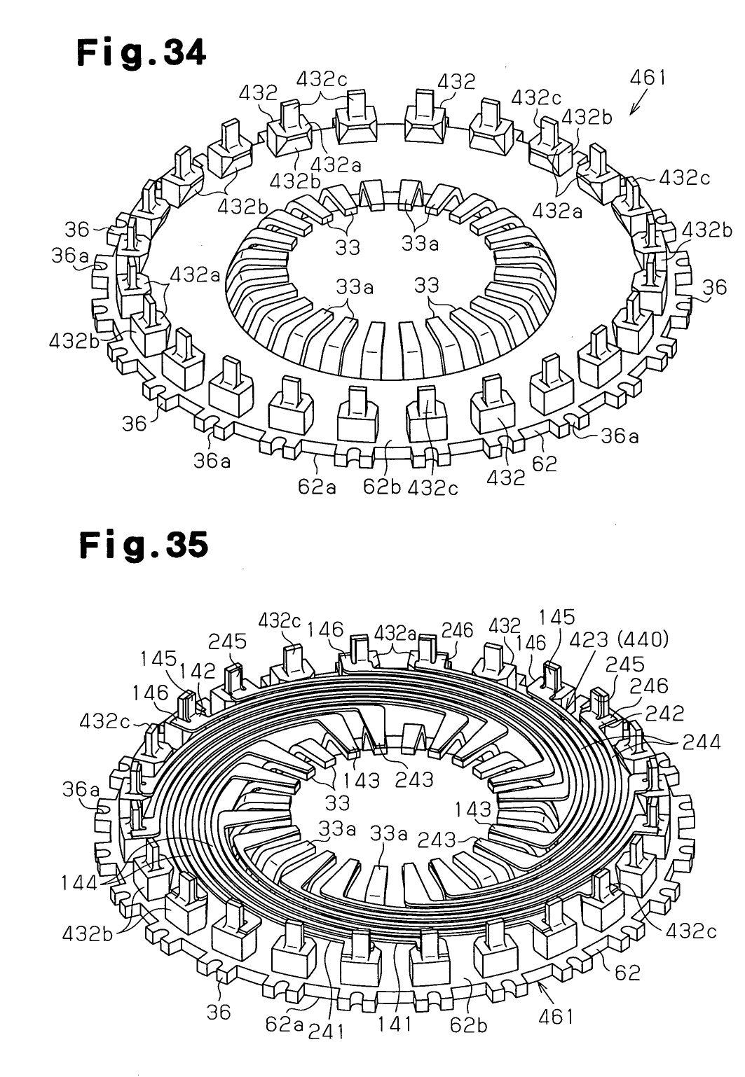

FIG. 34 shows mother members 461 of a plurality of segments 422. The mother member 461 has a circular ring tabular mother main body 62 having a flat surface 62a.

As shown in FIG. 35, the short-circuit unit 423 is arranged in the mother member 461.

The first connection piece 145 and the second connection piece 245 are respectively welded to the corresponding connection projections 432c by TIG welding. The first inner short-circuit end 143 and the second inner short-circuit end 243 are also respectively welded to the corresponding inner connection portions 33 in accordance with the TIG welding. As a result, the short-circuit unit 423 is connected to the mother member 461.

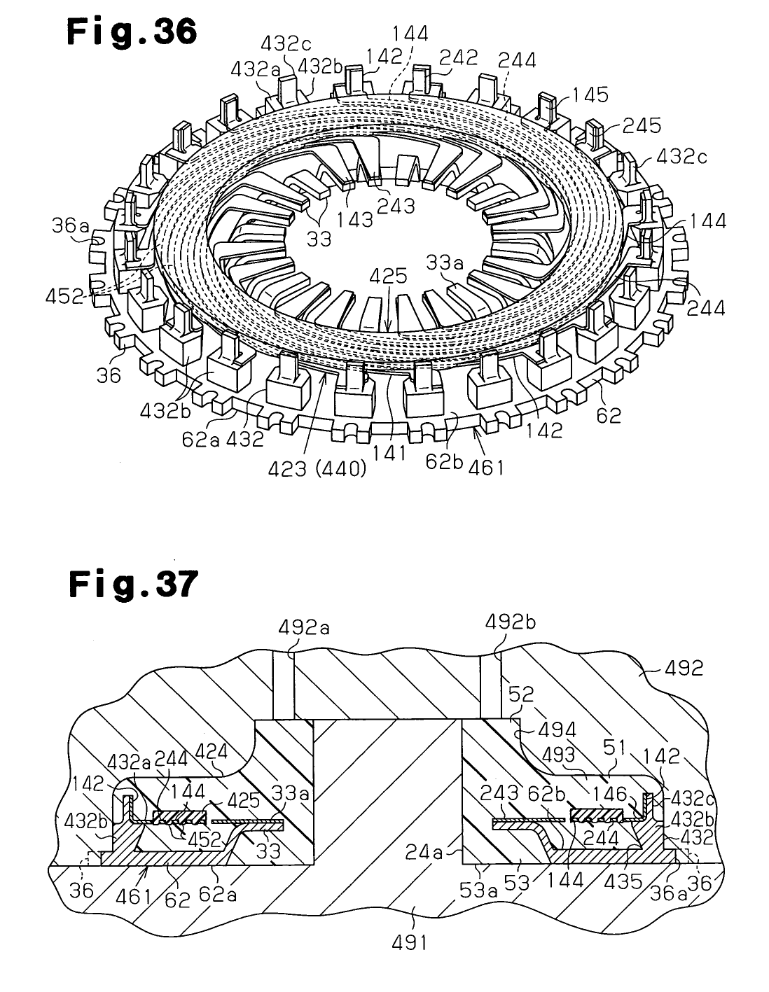

As shown in FIG. 36, the separating member 425 is arranged in the short-circuit unit 423. Sixteen separating protrusions 452 are arranged between the first coupling portion 144 and the second coupling portion 244. The support plate 451 is parallel to the flat surface 62a of the mother member 461.

As shown in FIG. 37, a lower die 491 and an upper die 492 of the forming die define a cavity 494 for forming the holding portion 424. The mother member 461 and the short-circuit unit 423 are arranged in the cavity 494. The upper die 492 has inlet ports 492a and 492b communicating with the cavity 494. The cavity 494 is filled with a molten insulative resin 493 through the inlet ports 492a and 492b. The inlet ports 492a and 492b extend in the thickness direction of the mother member 461 arranged in the cavity 494, that is, the axial direction of the short-circuit unit 423, and communicate with the cavity 494. In FIG. 37, the inlet ports 492a and 492b communicate with the cavity 494 from the above. In other words, the short-circuit unit 423 is positioned between the mother member arranged in the cavity 494, and the inlet ports 492a and 492b. Accordingly, if the insulative resin 493 in the molten state fills the cavity 494, the insulative resin 493 presses the short-circuit unit 423 toward the mother member 461. Further, the insulative resin 493 presses the separating member 425 toward the short-circuit unit 423.

The molten insulative resin 493 fills between the first coupling portion 144 and the mother main body 62, and between the second coupling portion 244 and the mother main body 62. The separating protrusion 452 is arranged between the first coupling portion 144 and the second coupling portion 244. Accordingly, it is possible to prevent the pressure of the insulative resin 493 in the molten state from deforming the first coupling portion 144 and the second coupling portion 244. In other words, it is possible to prevent the first coupling portion 144 from being short-circuited with the second coupling portion 244.

The insulative resin 493 covers the connection portion between the first and second outer short-circuit ends 142 and 242, and the outer connection portion 432. In the same manner, the insulative resin 493 covers the connection portion between the first and second inner short-circuit ends, and the inner connection portion 33.

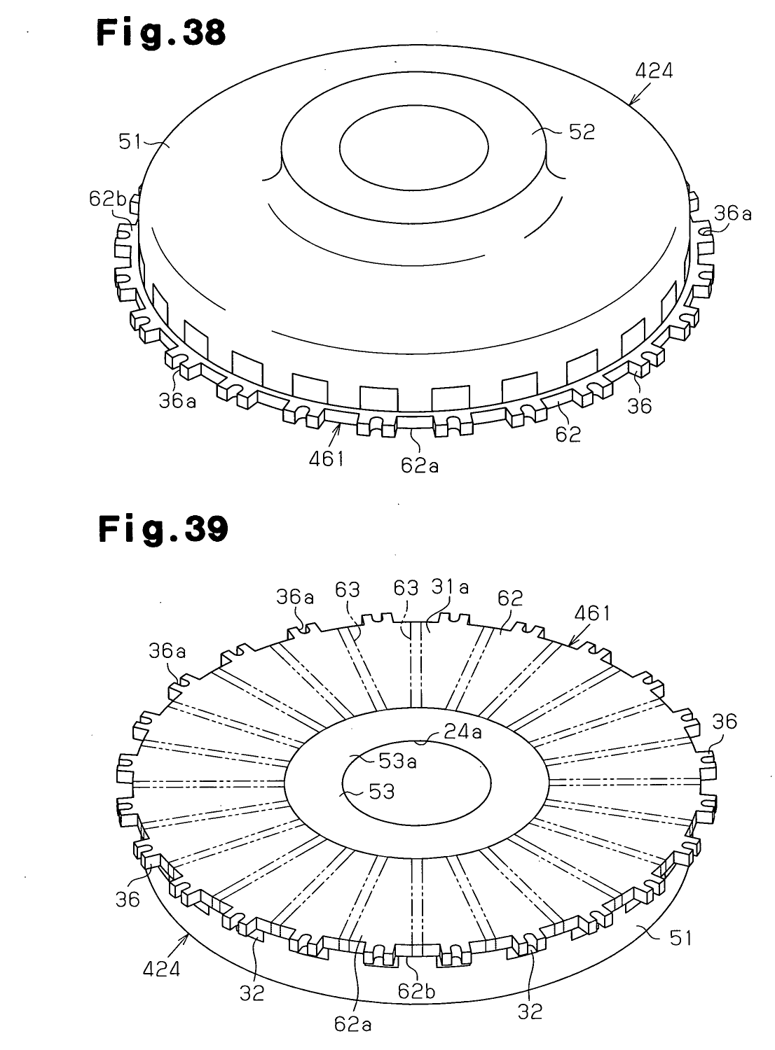

As shown in FIG. 38, when the insulative resin 493 is hardened by being cooled, the holding portion 424 is finished. The holding portion 424 is removed from the lower die 491 and the upper die 492.

Next, the mother member 461 in the state of being held by the holding portion 424 is cut, and twenty-four segments 422 are formed. The commutator 421 is finished.

The fourth example has the following advantages.

(41) The insulative separating protrusion 452 is arranged between the first coupling portion 144 and the second coupling portion 244 which are adjacent in the circumferential direction. Accordingly, even if a molding pressure of the holding portion 424 is applied to the adjacent first coupling portion 144 and second coupling portion 244, it is possible to prevent the first coupling portion 144 and the second coupling portion 244 from being short-circuited with each other. In other words, it is possible to secure the insulation between the first coupling portion 144 and the second coupling portion 244.

(42) The separating protrusion 452 extends along the first coupling portion 144 and the second coupling portion 244. Accordingly, it is easy to secure the insulation between the first coupling portion 144 and the second coupling portion 244 which are adjacent to each other in the circumferential direction.

(43) Both corner portions of the distal end of each of the separating protrusions 452 are chamfered. In other words, each of the separating protrusions 452 is narrowed toward the distal end. Accordingly, it is easy to insert the separating protrusion 452 to the portion between the first coupling portion 144 and the second coupling portion 244.

(44) The separating member 425 includes the circular ring tabular support plate 451, and the separating protrusion 452 integrally provided in the contact surface 451a of the support plate 451. Accordingly, it is possible to easily arrange the separating protrusion 452 between the first coupling portion 144 and the second coupling portion 244 by arranging the support plate 451 in the short-circuit unit 423. Therefore, it is easy to manufacture the commutator 421.

(46) The insulative resin 493 in the molten state filling the cavity 494 pressure contacts the short-circuit unit 423 with the segment 422. As a result, it is possible to more securely connect the short-circuit unit 423 to the segment 422.

(47) The formation by the lower die 491 and the upper die 492 is executed after the first connection piece 145 and the second connection piece 245 are welded to the connection projection 432c. Accordingly, it is possible to prevent the short-circuit unit 423 from being displaced from the mother member 461 at a time of forming.

(48) In a state of setting the number of magnetic poles of the magnet 2 to P, the number of the segments 422 to (P/2)·n, and the number of the segments 422 to be set to the same electric potential to (P/2), the number of the short-circuit pieces 141 and 241 is set to ((P/2)−1)·n=(P/2)·n−n. Accordingly, it is possible to set the total number of the short-circuit pieces 141 and 241 smaller than the number of the segments 422.

Each of the examples mentioned above may be modified as follows.

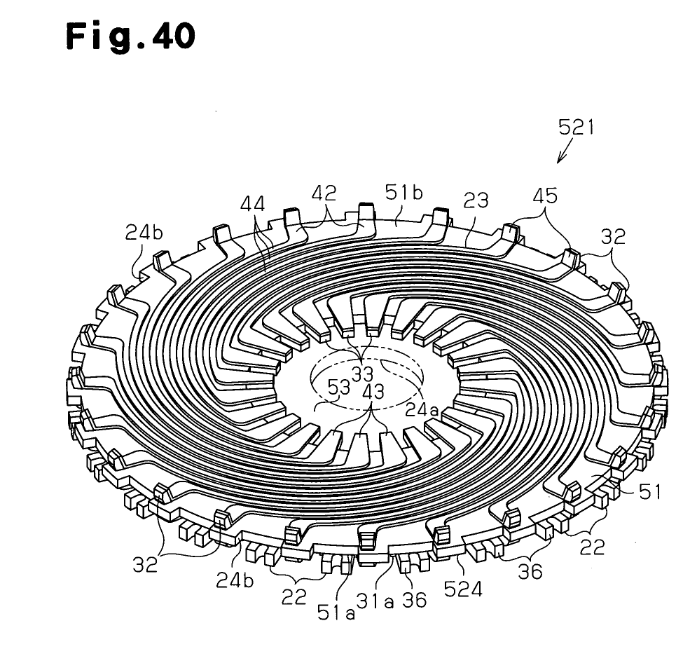

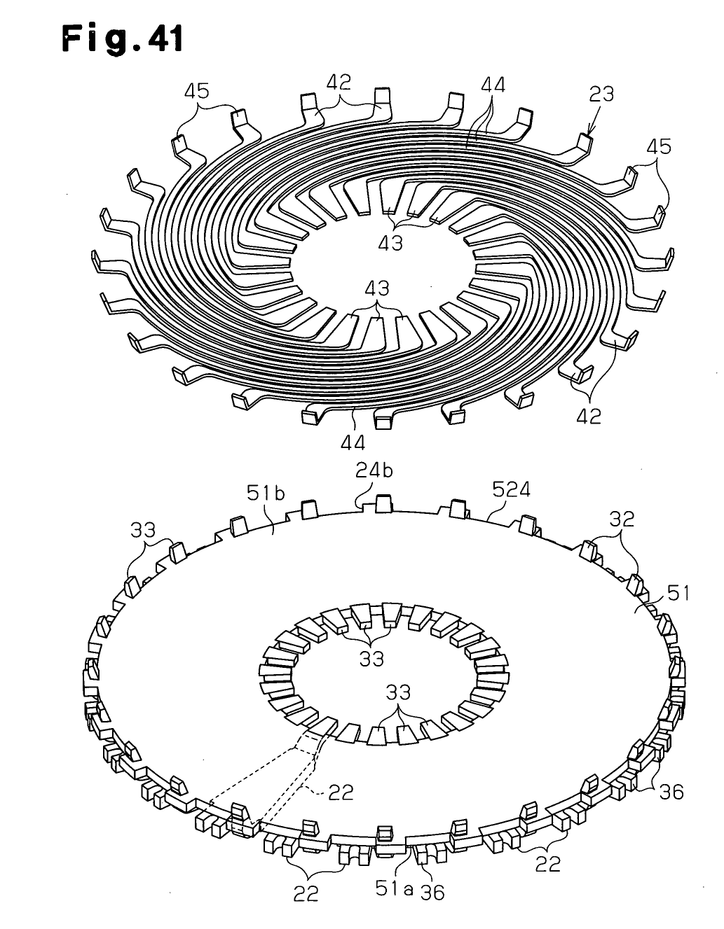

As shown in FIGS. 40 and 41, a holding portion 524 of a commutator 521 is integrally formed only with the segment 22. The holding portion 524 is not integrally formed with the short-circuit unit 23. In other words, the holding portion 524 is not limited to be integrally formed with both of the segment 22 and the short-circuit unit 23, but may be integrally formed with at least one of the segment 22 and the short-circuit unit 23. In FIG. 40, the short-circuit unit 23 is only welded to the segment 22.

As shown in FIG. 40, the disc-shaped holding portion 524 has a contact surface 51b in an opposite side to an end surface 51a. The contact surface 51b is parallel to the slidable contact surface 31a. The short-circuit unit 23 is arranged on the contact surface 51b. The holding portion 524 holds the segment 22 by embedding a part of the segment 22, particularly the proximal end of the outer connection portion 32. The outer connection portion 32 protrudes from the contact surface 51b. An outer circumferential surface of the holding portion 524 has a plurality of the guide grooves 24b.

The holding portion 524 shown in FIG. 41 is manufactured by the forming die such as the lower die 491 and the upper die 492 shown in FIG. 37, in such a manner as to be integrally formed with a plurality of segments 22. In a state in which the short-circuit unit 23 is arranged in the contact surface 51b, the short-circuit unit 23 is parallel to the slidable contact surface 31a. The connection piece 45 of the short-circuit unit 23 is brought into contact with the outer connection portion 32 of the segment 22. The inner short-circuit end 43 is brought into contact with the inner connection portion 33. The connection piece 45 is welded to the outer connection portion 32. The inner short-circuit end 43 is welded to the inner connection portion 33. The support portion 53 is formed in the center of the holding portion 524. The fitting hole 24a passes through the support portion 53.

In this case, in a state in which the holding portion 524 defines the positional relation between a plurality of segments 22, the short-circuit unit 23 is arranged on the segments 22. Accordingly, it is easy to arrange and weld the short-circuit unit 23 to a plurality of segments 22.

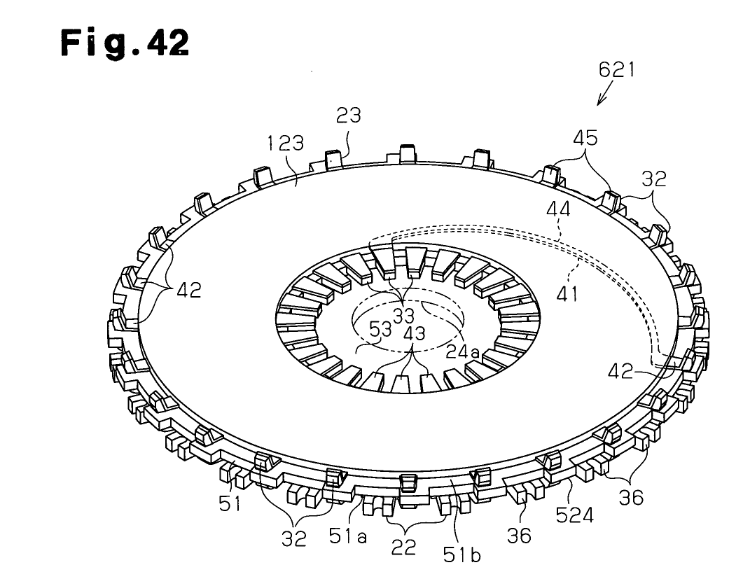

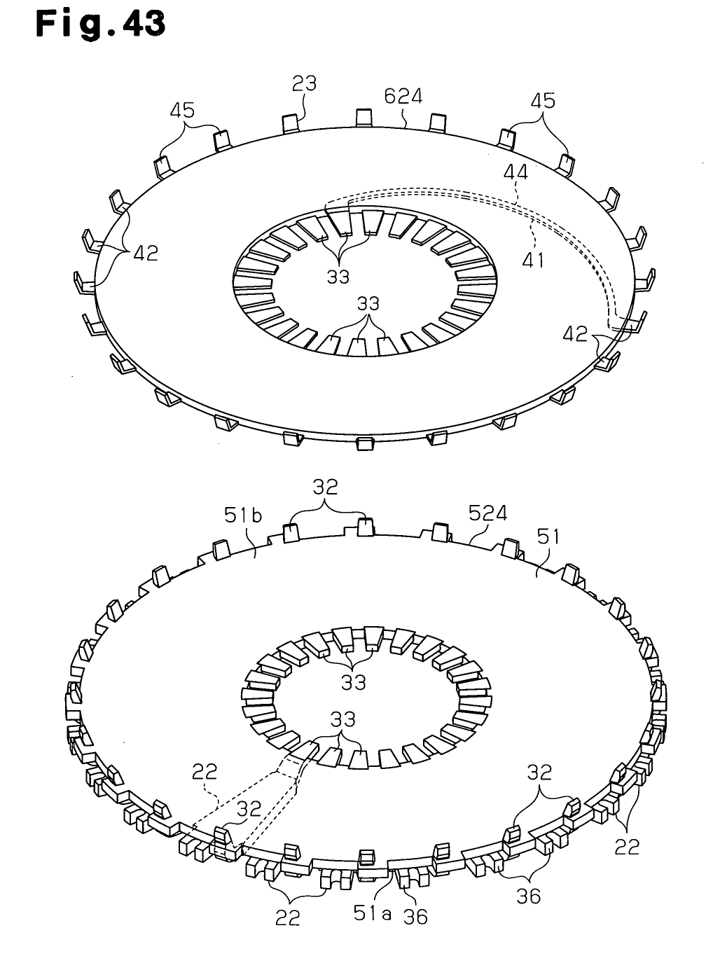

As shown in FIGS. 42 and 43, a second holding portion 624 is integrally formed with the short-circuit unit 23. A disc-shaped second holding portion 624 is assembled in the holding portion 524 in FIG. 41, whereby a commutator 621 is formed. In other words, a holding portion of the commutator 621 is divided into a holding portion 524 serving as a first holding portion holding a plurality of segments 22, and a second holding portion 624 holding the short-circuit unit 23. The second holding portion 624 is arranged on the contact surface 51b of the holding portion 524. The second holding portion 624 holds the short-circuit unit 23 by embedding at least a part of the short-circuit unit 23, that is, a plurality of coupling portions 44.

The outer diameter of the second holding portion 624 is slightly smaller than the outer diameter of the holding portion 524. The thickness of the second holding portion 624 is larger than the thickness of the short-circuit unit 23, and smaller than the thickness of the holding portion 524.

The connection piece 45 of the short-circuit unit 23 is welded to the outer connection portion 32 of the segment 22. The inner short-circuit end 43 is welded to the inner connection portion 33.

The insulative resin material of the holding portion 524 can be set in such a manner as to have a different nature from the insulative resin material of the second holding portion 624. For example, the insulative resin of the holding portion 524 is set to a higher hardness in comparison with the second holding portion 624, in such a manner as to hold the segment 22 with which the anode brush 8 and the cathode brush 9 are brought into slidable contact. The insulative resin of the second holding portion 624 is set to a lower hardness than the holding portion 524 because it is sufficient that it holds the thinner short-circuit unit 23 than the segment 22.

The insulative resin of the holding portion 524 may employ the same kind as the insulative resin of the second holding portion 624.

The second holding portion 624 is manufactured by the forming die such as the lower die 491 and the upper die 492 in FIG. 37, in such a manner as to be integrally formed with the short-circuit unit 23. The second holding portion 624 is arranged on the contact surface 51b of the holding portion 524, whereby the short-circuit unit 23 is arranged on the segments 22. The connection piece 45 of the short-circuit unit 23 is welded to the outer connection portion 32 of the segment 22. The inner short-circuit end 43 is welded to the inner connection portion 33.

In this case, the short-circuit unit 23 held by the second holding portion 624 is arranged on the segments 22 held by the holding portion 524. Accordingly, it is easy to arrange the short-circuit unit 23 in the segment 22.

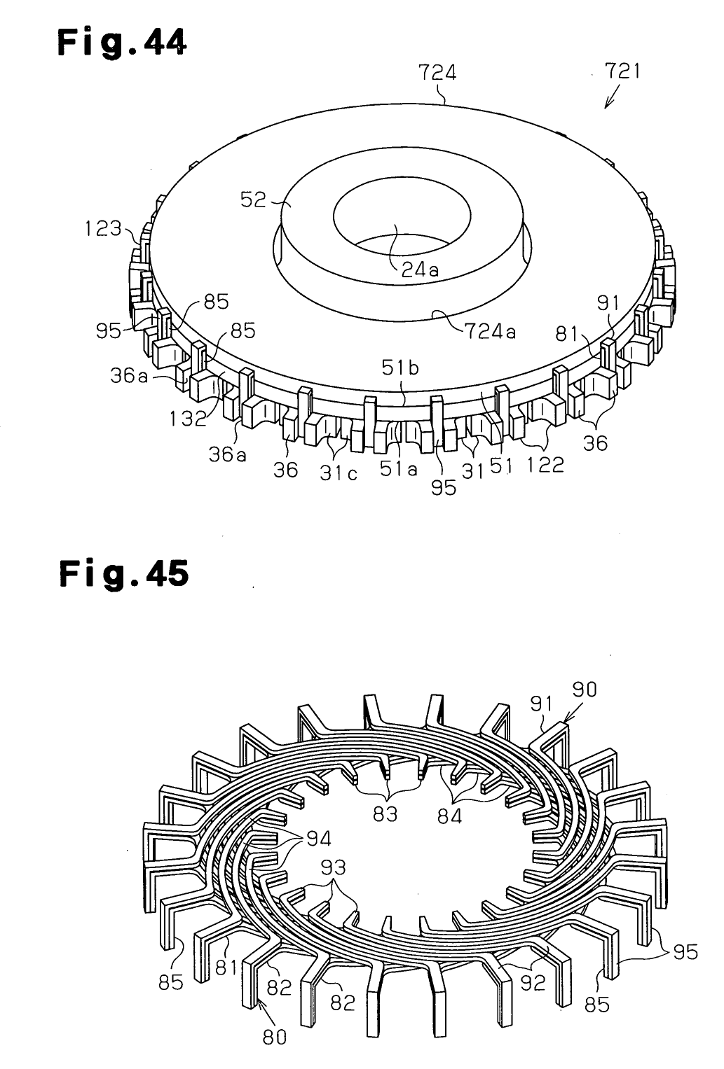

As shown in FIGS. 44 to 46, a second holding portion 724 is integrally formed with the short-circuit unit 123 in FIG. 17A. The disc-shaped second holding portion 724 is assembled in the holding portion 124 in FIG. 17B, whereby a commutator 721 is formed. In other words, the holding portion of the commutator 721 is divided into the holding portion 124 serving as the first holding portion holding a plurality of segments 22, and a second holding portion 724 holding the short-circuit unit 123. The second holding portion 724 is arranged on the contact surface 51b of the holding portion 124. The second holding portion 724 holds the short-circuit unit 23 by embedding the first short-circuit piece 81 and the second short-circuit piece 91. The first connection piece 85 and the second connection piece 95 protrude from an outer circumferential surface of the second holding portion 724.

As shown in FIG. 44, as viewed in the axial direction, the outer circumferential edge of the holding portion 124 exists at the same position as the radially outer end surface 31c of the segment main body 31. The outer diameter of the second holding portion 724 is equal to the outer diameter of the holding portion 124. The second holding portion 724 has an insertion hole 724a to which the boss portion 52 is inserted. The second holding portion 724 is arranged in the periphery of the boss portion 52 on the contact surface 51b. The first connection piece 85 and the second connection piece 95 are welded to the segment 122 in a state of being inserted to the connection groove 36a. The conducting wire 19 is welded to the segment 122, the first connection piece 85, and the second connection piece 95 in a state of being inserted to the connection groove 36a. FIG. 45 shows a view from which the insulating paper sheet 101 between the first coupling portion 84 and the second coupling portion 94 is omitted.

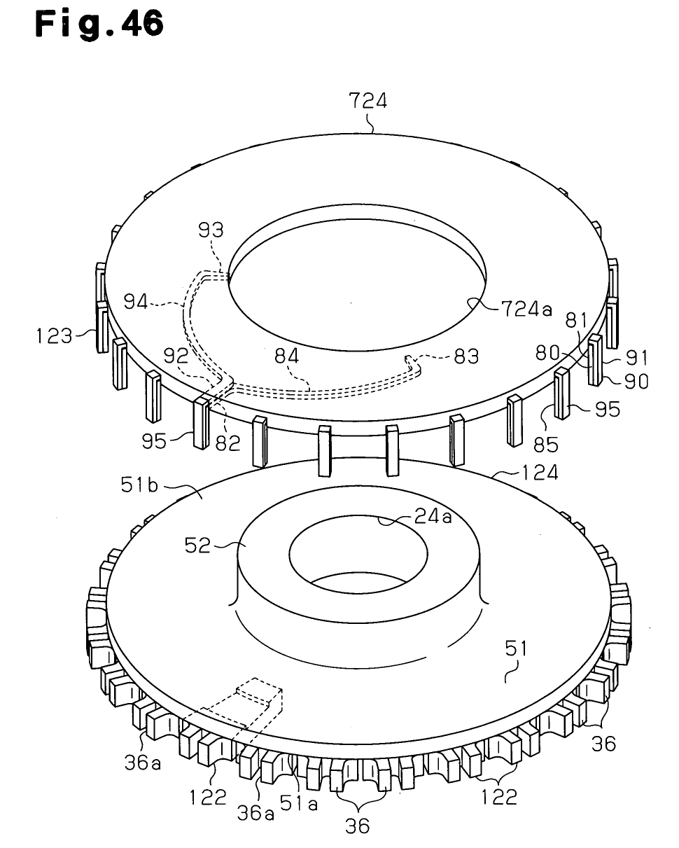

As shown in FIG. 46, the holding portion 124 and the second holding portion 724 are formed by the independent forming dies. Thereafter, the short-circuit unit 123 is arranged on the segments 122 by arranging the second holding portion 724 in the holding portion 124. The first connection piece 85 and the second connection piece 95 are inserted to the connection groove 36a. In this case, it is easy to arrange the short-circuit unit 123 in the segment 122.

The first coupling portion 84 and the second coupling portion 94 may be separated from each other by being curved slightly. For example, a recess may be formed in respective facing surfaces of the first coupling portion 84 and the second coupling portion 94.

As shown in FIG. 45, the first outer short-circuit end 82 may be welded to the second outer short-circuit end 92 before manufacturing the second holding portion 724.

A similar connection piece to the second connection piece 95 may be formed in the second inner short-circuit end 93. Further, a similar connection piece to the first connection piece 85 may be formed in the first inner short-circuit end 83.

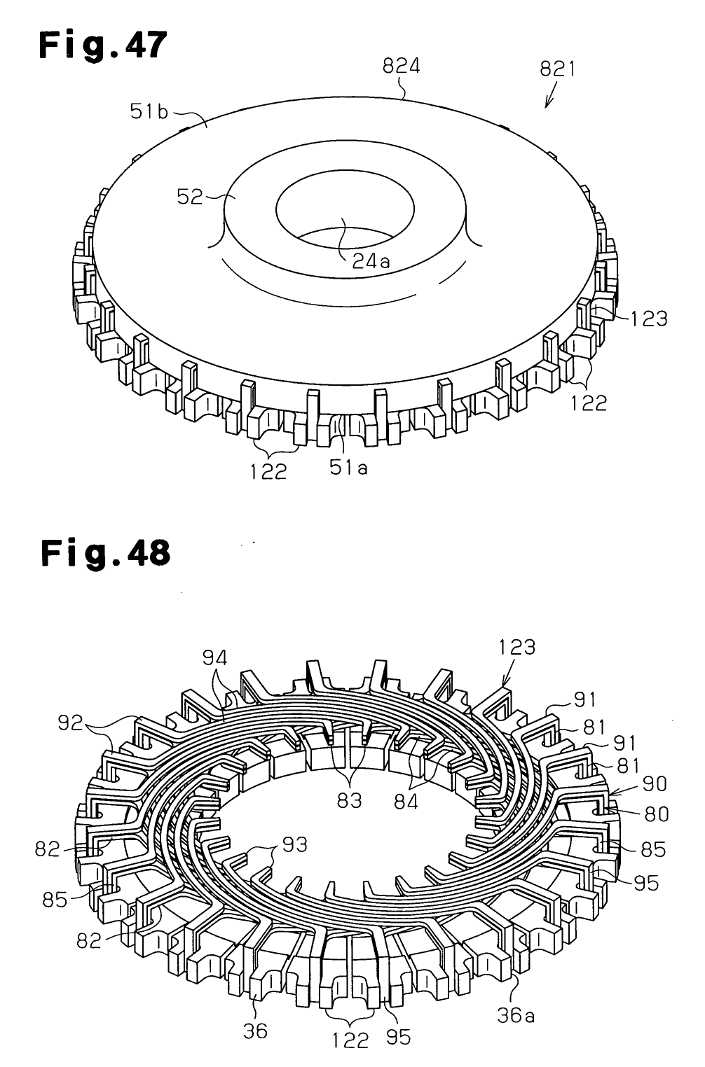

As shown in FIG. 47, a holding portion 824 of a commutator 821 is integrally formed in both of the segment 122 and the short-circuit unit 123. In other words, the holding portion 824 is thicker than the holding portion 124 in FIG. 17B in such a manner as to embed the short-circuit unit 123. The outer diameter of the holding portion 824 is equal to the outer diameter of the holding portion 124 in FIG. 17B.

As shown in FIG. 48, in a state in which the short-circuit unit 123 is arranged on the segments 122, the holding portion 824 is integrally formed by the forming die. The short-circuit unit 123 may be arranged on the segments 122 within the forming die.

In the first example, the connection piece 45 is not limited to be welded to the outer connection portion 32 by the TIG welding, but may be welded by resistance welding or may be soldered. Further, the connection piece 45 may be swaged to the outer connection portion 32, or may be electrically connected by being simply brought into contact therewith.

In the same manner, the inner short-circuit end 43 may be electrically connected to the inner connection portion 33 by being soldered, swaged or brought into contact therewith. At the same time, the first outer short-circuit end 82 may be electrically connected to the second outer short-circuit end 92 by being soldered, swaged or brought into contact therewith. The first connection piece 85 may be electrically connected to the second connection piece 95 by being soldered, swaged or brought into contact therewith.

The first connection piece 85 extending in the axial direction as shown in FIG. 17A may be formed in each of the outer short-circuit end 42 and the inner short-circuit end 43 shown in FIG. 11A. The first connection piece 85 is connected to the radially outer end surface of the segment 22 or the radially inner end surface.

The segment 122 shown in FIG. 15A may be replaced by the segment 22 shown in FIG. 11A. In this case, the first outer short-circuit end 82 and the second outer short-circuit end 92 shown in FIG. 15A are replaced by the outer short-circuit end 42 shown in FIG. 11A.

The first inner short-circuit end 83 and the second inner short-circuit end 93 shown in FIG. 15A may be connected to the segment 122.

The short-circuit unit 23 shown in FIG. 11A and the segment 22 shown in FIG. 11B may be formed to be parallel to each other. The segment 22 may be first formed and the short-circuit unit 23 may be formed later.

The outer diameter D1 of the commutator 21 shown in FIG. 5 may be smaller than the inner diameter d1 of the imaginary cylinder defined by a plurality of magnets 2 (D<d1). The closer to the outer diameter d0 of the core 13 the outer diameter D1 of the commutator 21 is, the closer to the coil connection portion 36 of the segment 22 the leading position of the conducting wire 19 of each of the coils 17a to 17h comes to. As shown in FIGS. 6B and 12, the conducting wire 19 of each of the coils 17a to 17h is led out in the axial direction from the outer circumferential surface of the core 13. Accordingly, it is possible to shorten the length of the conducting wire 19 necessary for connecting the coils 17a to 17h to the segment 22.

In the case that the outer diameter D1 of the commutator 21 is equal to the outer diameter d0 of the core 13, it is easiest to connect the conducting wire 19 of each of the coils 17a to 17h to the coil connection portion 36.

The outer diameter D1 of the commutator 21 may be smaller than the outer diameter d0 of the core 13.

In each of the examples mentioned above, the boss portion 52 may be deleted.

The short-circuit unit 23 in FIG. 11A is not limited to be structured by one short-circuit group 40, but may be structured by a plurality of short-circuit groups. For example, all the coupling portions 44 of a plurality of short-circuit groups may couple the outer short-circuit end 42 to the inner short-circuit end 43 which is displaced by 120° in the same direction.

The short-circuit unit 123 shown in FIG. 17A is not limited to be structured by the first short-circuit group 80 and the second short-circuit group 90, but may be structured by three or more short-circuit groups. For example, the outer short-circuit ends of three of more outer short-circuit groups are laminated. The inner short-circuit ends of the respective short-circuit groups are also laminated. At least a pair of short-circuit groups in three or more short-circuit groups is laminated in such a manner that the coupling portions are directed opposite to each other.

The feeding brushes (8, 9) are brought into slidable contact with the commutator 21 from the axial direction. Accordingly, as is different from the conventional commutator with which the feeding brush is brought into slidable contact from the radial direction, the thickness of the holding portions 24 and 124 in accordance with the present invention can be made smaller than the thickness of the feeding brushes (8, 9). Accordingly, even in the case that the short-circuit units 23 and 123 are structured by a plurality of short-circuit groups, it is possible to suppress the enlargement of the thickness of the commutator 21.

An angle θ corresponding to the interval between the segments 22 and 122 which the short-circuit units 23 and 123 mentioned above short-circuit is not limited to 120°.

The outer short-circuit end 42, the inner short-circuit end 43 and the coupling portion 44 of the short-circuit group 40 are not limited to be completely flat in all the positions. At least a part of the short-circuit group 40 may have an uneven shape or may be formed in a curved shape.

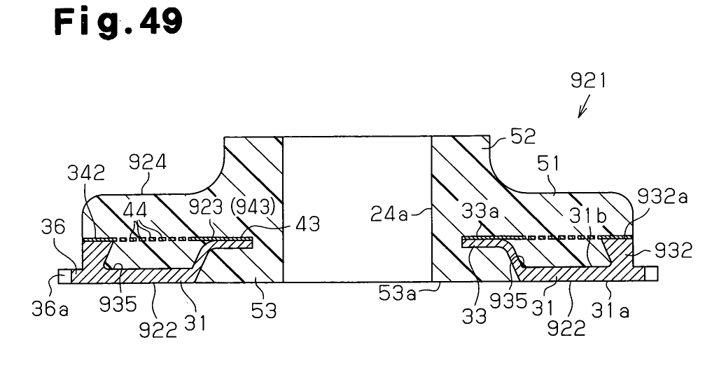

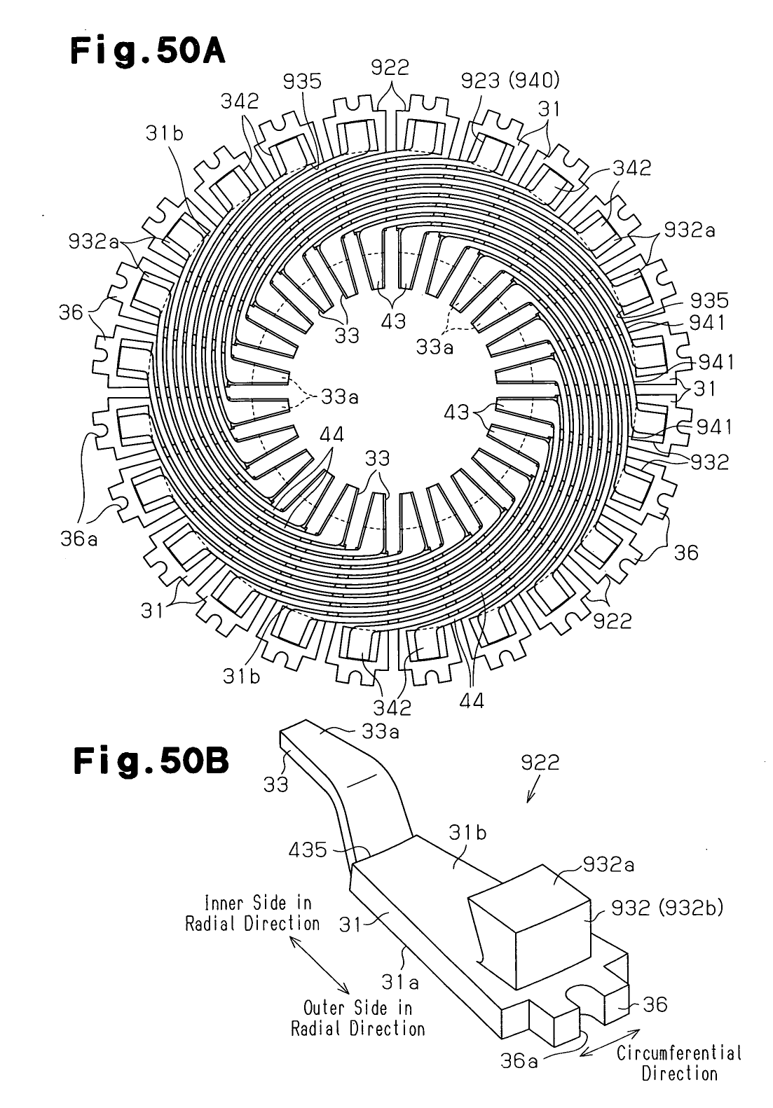

As shown in FIGS. 49 and 50A, a commutator 921 and a short-circuit unit 923 are constituted by one short-circuit group 940. The short-circuit group 940 has twenty-four short-circuit pieces 941. Each of the short-circuit pieces 941 includes the outer short-circuit end 342 in FIG. 21A, the inner short-circuit end 43 in FIG. 9, and the coupling portion 44 in FIG. 9. The short-circuit unit 923 is formed in a flat shape.

As shown in FIG. 50B, the segment 922 has the segment main body 31 and the inner connection portion 33 shown in FIG. 11B. Further, the segment 922 has an outer connection portion 932. The outer connection portion 932 is formed in a block shape protruding to an opposite side to the slidable contact surface 31a. An opposite surface to the slidable contact surface 31a in the outer connection portion 932 serves as an outer connection surface 932a. The outer connection portion 932 and the inner connection portion 33 define a separating recess 935 therebetween. An inner surface in a radial direction of the outer connection portion 932 is sloped in such a manner that the holding portion 924 is well engaged with the outer connection portion 932.

As shown in FIG. 49, in a state in which the holding portion 924 holds the segment 922, an inner end in a radial direction of each of the segments 922 is brought into contact with the support portion 53.

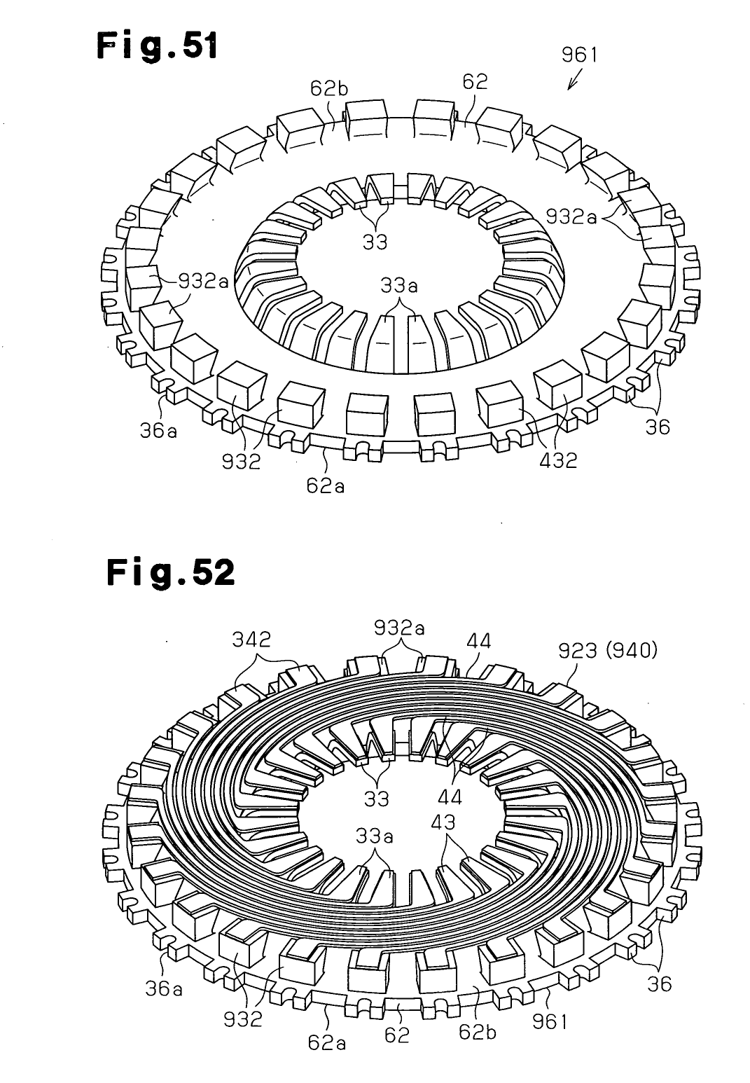

As shown in FIG. 51, a mother member 961 has the mother main body 62, and a plurality of inner connection portions 33 and a plurality of outer connection portions 432 protruding from the bonded surface 62b of the mother main body 62.

FIG. 52 shows the short-circuit unit 923 arranged in the mother member 961. The holding portion 924 is formed in such a manner as to integrally hold the mother member 961 and the short-circuit unit 923. The mother member 961 is cut into the separated segments 922.

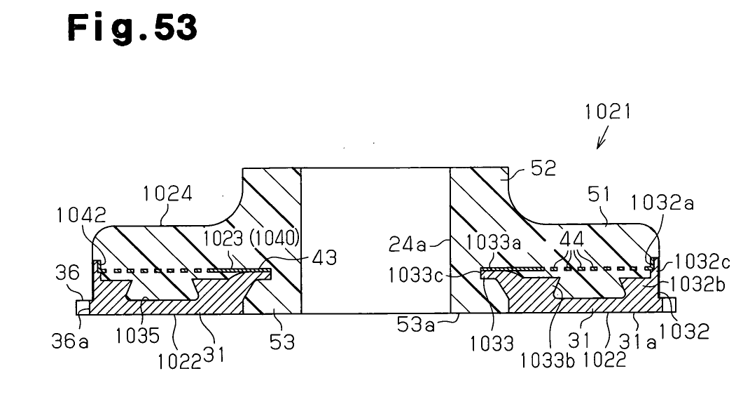

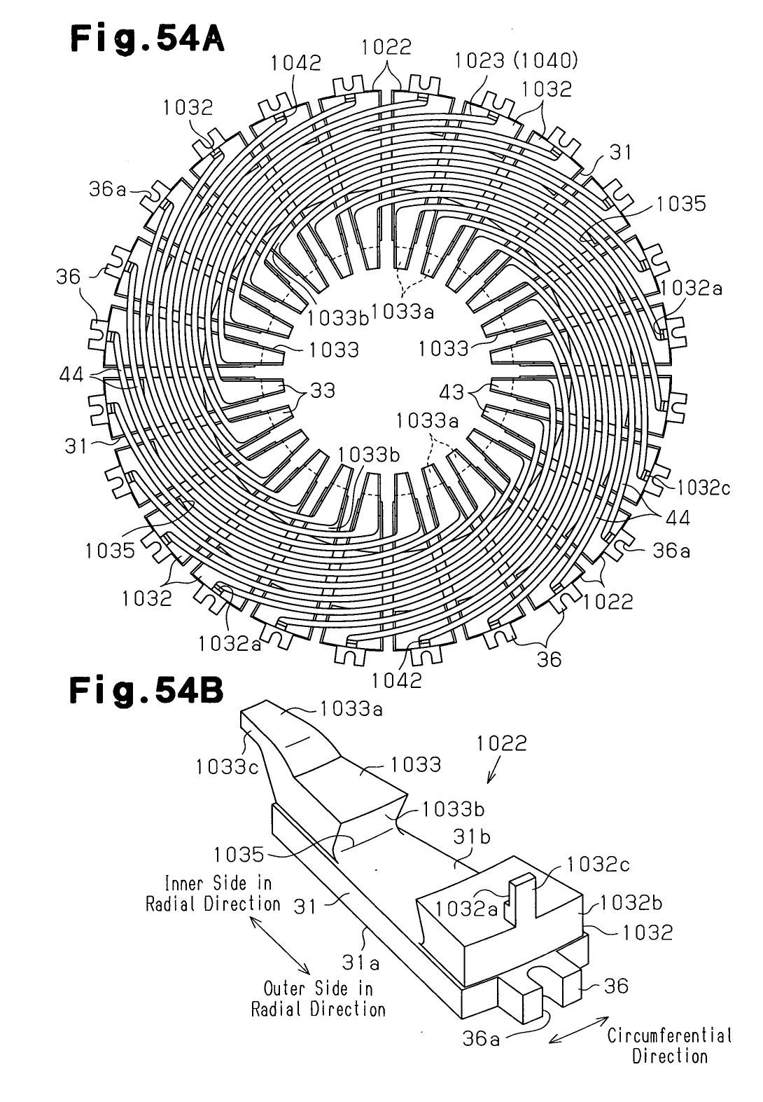

As shown in FIGS. 53 and 54A, a commutator 1021 has twenty-four segments 1022, a short-circuit unit 1023 and a holding portion 1024. The holding portion 1024 integrally holds the segments 1022 and the short-circuit unit 1023.

As shown in FIG. 54B, each of the segments 922 has the segment main body 31, an outer connection portion 1032 and an inner connection portion 1033. The outer connection portion 1032 has a base portion 1032b and a connection projection 1032c. An outer connection surface 1032a formed in an L-shaped form as viewed from the circumferential direction is formed in the connection projection 1032c. In other words, the outer connection surface 1032a has a parallel surface and a vertical surface with respect to the slidable contact surface 31a.

The inner connection portion 1033 has a base portion 1033b and a connection projection 1033c extending diagonally upward toward an inner side in the radial direction from the base portion 1033b. An outer surface in the radial direction of the base portion 1033b is formed diagonal in such a manner that the holding portion 1024 is well engaged with the inner connection portion 1033. The connection projection 1033c has an inner connection surface 1033a which is parallel to the slidable contact surface 31a. The inner connection surface 1033a is formed in a trapezoidal shape in which the dimension in the circumferential direction becomes smaller toward the inner side in the radial direction, as viewed in the axial direction. The inner connection surface 1033a exists within the same plane as the parallel surface of the outer connection surface 1032a.

The outer connection portion 1032 and the inner connection portion 1033 define a separating recess 1035 between both the elements.

As shown in FIGS. 53 and 54A, the short-circuit unit 1023 is constituted by one short-circuit group 1040. The short-circuit group 1040 has twenty-four segments 1022. Each of the segments 1022 has an outer short-circuit end 1042, the inner short-circuit end 43 and the coupling portion 44.

Each of the outer short-circuit ends 1042 has an L-shaped form which is brought into contact with the parallel surface and the vertical surface of the outer connection surface 1032a. The dimension in the circumferential direction of each of the outer short-circuit ends 1042 is equal to the dimension in the circumferential direction of the outer connection surface 1032a, that is, the dimension in the circumferential direction of the connection projection 1033c.

The outer short-circuit end 1042 is welded to the outer connection portion 1032. The inner short-circuit end 43 is welded to the inner connection portion 1033.

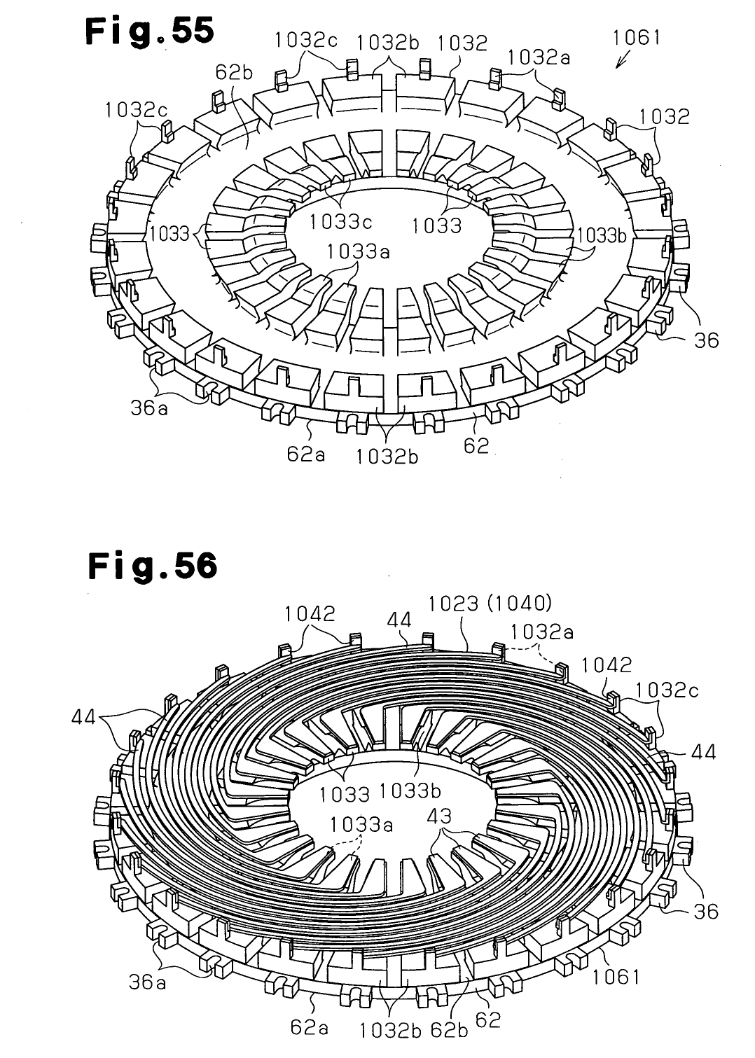

As shown in FIG. 55, the mother main body 62 of the mother member 1061 is provided with twenty-four outer connection portions 1032, and twenty-four inner connection portions 1033.

As shown in FIG. 56, the short-circuit unit 1023 is arranged in the mother member 1061. The holding portion 1024 is formed in such a manner as to integrally hold the short-circuit unit 1023 and the mother member 1061. The mother member 1061 is cut into twenty-four separated segments 1022.

The coil connection portion 36 may be provided at other positions than the radially outer end of the segment main body 31.

The distal end surface 53a of the support portion 53 is not limited to exist within the same plane as the slidable contact surface 31a. The distal end surface 53a may be retracted to an inner side of the holding portion 24 in comparison with the slidable contact surface 31a.

The distal end surface 53a may protrude to an outer side of the holding portion 24 in comparison with the slidable contact surface 31a. In this case, a contact area between the outer circumferential surface of the rotary shaft 12 and the inner circumferential surface of the holding portion 24 becomes enlarged. In other words, the commutator 21 is further stably fixed to the rotary shaft 12.

The mother member 61 may be formed by press working the conductive plate member.

The mother member 61 may be formed by using a forging die. In this case, the forging is executed in such a manner that a pressure is applied to the conductive metal corresponding to the material of the mother member 61 from the axial direction of the mother member 61.

In the lower die 491 and the upper die 492 shown in FIG. 37, the filling direction of the insulative resin 493 in the molten state to the cavity 494 is not limited to the thickness direction of the mother member 161.

A part of the connection portion to the outer connection portion 32 in the outer short-circuit end 42 may be exposed from the holding portion 24. In other words, the holding portion 24 may cover at least a part of the connection portion. A part of the connection portion to the inner connection portion 33 in the inner short-circuit end 43 may be exposed from the holding portion 24. In other words, the holding portion 24 may cover at least a part of the connection portion.

The support plate 451 of the separating member 425 may be formed in a loop shape, or a polygonal shape in addition to the circular ring shape.

The support plate 451 of the separating member 425 is not limited to be formed in the ring shape, but may be formed in an arcuate shape. One ring may be structured by a plurality of arcuate shaped support plates.

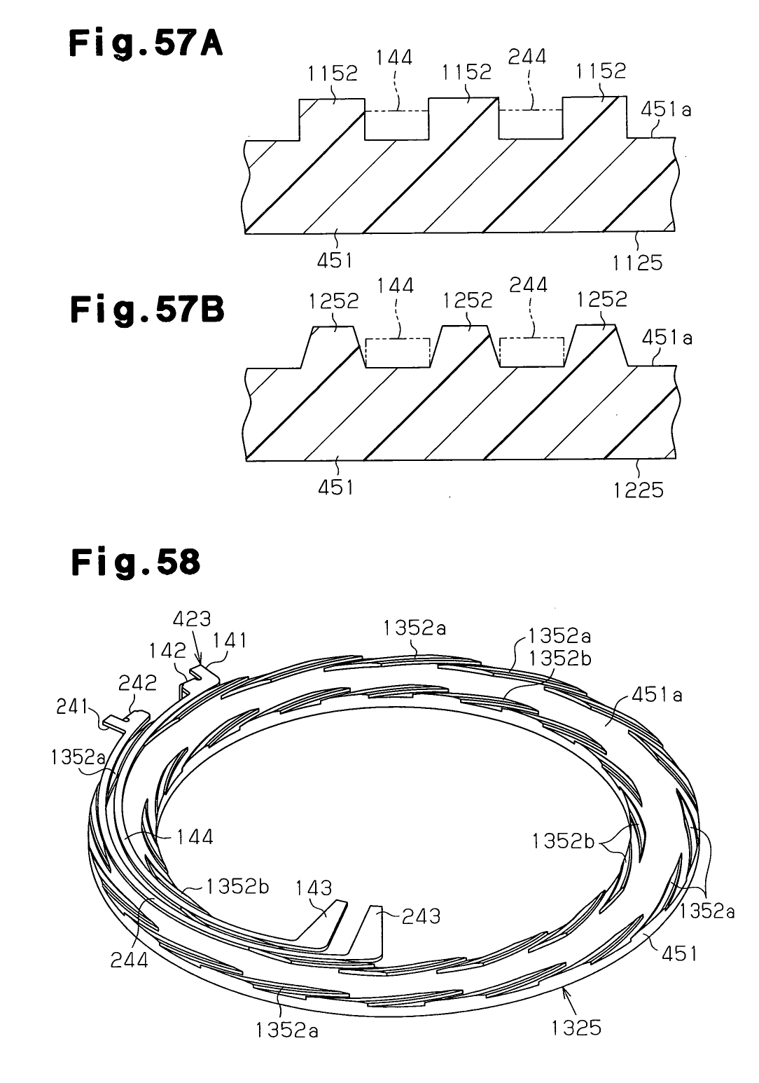

As shown in FIG. 57A, a separating member 1125 may have a separating protrusion 1152 having a rectangular cross-sectional shape.

As shown in FIG. 57B, a separating member 1225 may have a separating protrusion 1252 provided with a width which becomes gradually smaller toward the distal end from the contact surface 451a.

As shown in FIG. 58, a separating member 1325 may have a plurality of first separating protrusions 1352a which are arranged in the circumferential direction in a radially outer end of the support plate 451, and a plurality of second separating protrusions 1352b which are arranged in the circumferential direction in a radially inner end of the support plate 451. The number of the first separating protrusions 1352a is totally sixteen, and the number of the second separating protrusions 1352b is totally sixteen. Each of the first separating protrusions 1352a isolates the first short-circuit piece 141 from the second short-circuit piece 241. Each of the second separating protrusions 1352b also isolates the first short-circuit piece 141 from the second short-circuit piece 241. FIG. 58 shows only a pair of first short-circuit piece 141 and second short-circuit piece 241.

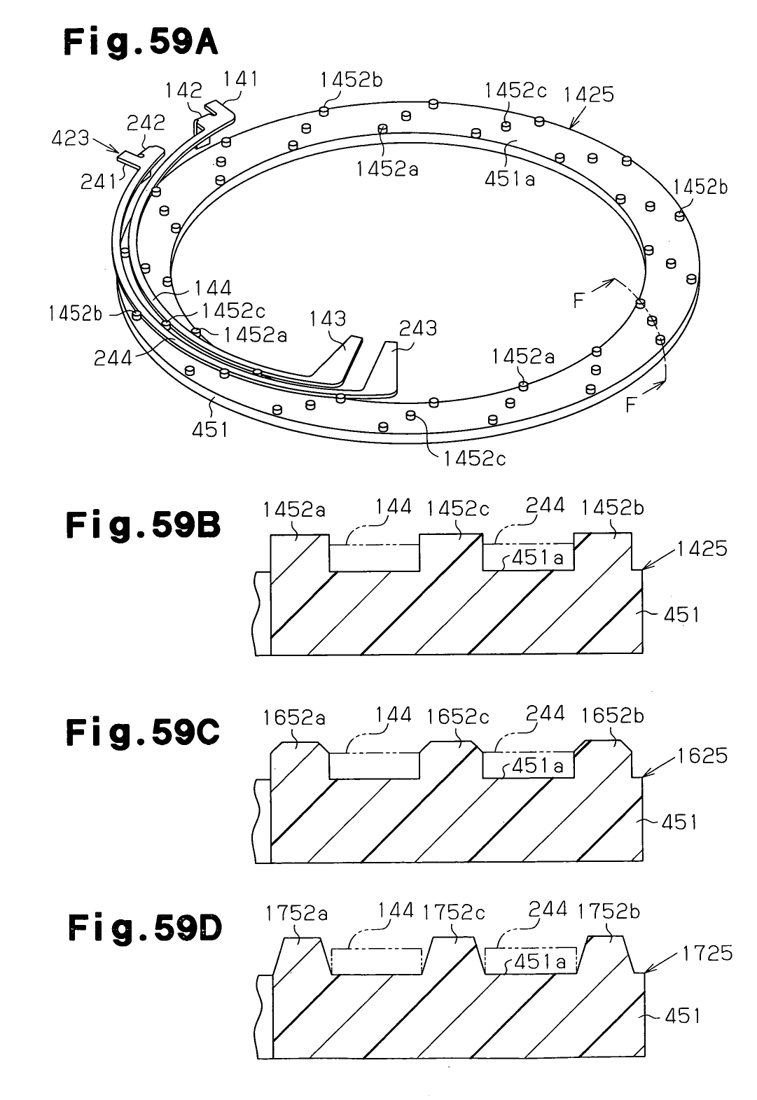

As shown in FIGS. 59A and 59B, a separating member 1425 may have an inner separating projection 1452a protruding from the contact surface 451a of the support plate 451, an outer separating projection 1452b, and an intermediate separating projection 1452c. Each of the inner separating projection 1452a, the outer separating projection 1452b and the intermediate separating projection 1452c is formed in a columnar shape.

The inner separating projection 1452a is positioned in the radially inner end of the support plate 451. The outer separating projection 1452b is positioned in the radially outer end of the support plate 451. The intermediate separating projection 1452c is positioned in the intermediate portion with respect to the radial direction of the support plate 451. The inner separating projection 1452a, the outer separating projection 1452b and the intermediate separating projection 1452c are arranged on an involute curve. In other words, the inner separating projection 1452a, the intermediate separating projection 1452c and the outer separating projection 1452b are arranged in this order between a pair of first coupling portion 144 and second coupling portion 244.

As shown in FIG. 59C, a separating member 1625 may have an inner separating projection 1652a, an outer separating projection 1652b and an intermediate separating projection 1652c, in which both corners of distal ends are chamfered respectively.

As shown in FIG. 59D, a separating member 1725 may have an inner separating projection 1752a, an outer separating projection 1752b and an intermediate separating projection 1752c, which respectively have a width being smaller toward the distal end from the contact surface 451a.

Each of the inner separating projection 1452a, the outer separating projection 1452b and the intermediate separating projection 1452c is not limited to the columnar shape, but may be formed in a rectangular columnar shape.

The number of the separating projections (1452a to 1452c) arranged on one involute curve mentioned above is not limited to three, but may be two or less, or may be four or more.

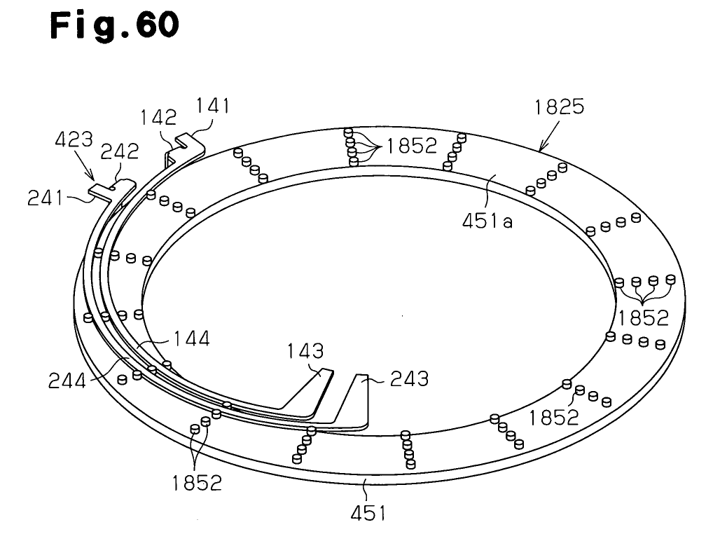

As shown in FIG. 60, in a separating member 1825, a plurality of separating projections 1852 may be arranged in a radial pattern. Four separating projections 1852 are arranged in the radial direction of the support plate 451.

The material of the separating member 425 is not limited to the thermosetting resin having the insulating characteristic, but may be constituted by a thermoplastic resin having an insulating characteristic. In this case, the material of the thermoplastic resin is prepared in such a manner as to prevent the separating member 425 from being softened in the cavity 494.

The short-circuit unit 23 mentioned above may be formed in a completely flat tabular shape provided with neither bent position nor curved position.

The number of the magnetic poles of the magnet 2 provided in the direct-current motor M mentioned above is not limited to six, but may be set to even numbers equal to or more than four. The number of the coils 17a to 17h may be appropriately changed in correspondence to the number of magnetic poles of the magnet 2. The number of the segments 22 is not limited to twenty-four, but may be set to be equal to twelve or more. The number of the segments 22 is desirably set to a least common multiple of the number of magnetic poles of the magnet 2 and the number of the teeth.

Although the multiple examples have been described herein, it will be clear to those skilled in the art that the present invention may be embodied in different specific forms without departing from the spirit of the invention. The invention is not to be limited to the details given herein, but may be modified within the scope and equivalence of the appended claims.

1. A commutator against which a power supplying brush slides, and the commutator defining an axial direction, comprising:
a plurality of segments placed around the axis, wherein a first circumferential direction and a second circumferential direction which is opposite to the first circumferential direction are defined in terms of the circumferential direction, each of the segments has a radially outer end, a radially inner end, and a sliding surface, the power supplying brush slides against the sliding surface, the sliding surface is perpendicular to the axial direction, a segment center line and a radial line are defined for each of the segments in such a manner that the segment center line extends from the center in the circumferential direction of the radially outer end to the center in the circumferential direction of the radially inner end, the radial line extends in the radial direction and passes through the center in the circumferential direction of the radially outer end, and a portion of the segment center line which includes the center in the circumferential direction of the radially inner end is inclined in the first circumferential direction relative to the radial line; and
a short-circuit member for connecting segments to be at the same potential from among the of segments, wherein the short-circuit member has a plurality of connection pieces, each of the connection pieces has an outer short-circuit end, an inner short-circuit end, and a coupling portion, the outer short-circuit end is connected to the radially outer end, the inner short-circuit end is connected to the radially inner end, and the coupling portion links the outer short-circuit end to the inner short-circuit end, which is shifted in the second circumferential direction from the outer short-circuit end.

2. The commutator according to claim 1, wherein each of the segments has an end in the circumferential direction which extends in the form of a straight line.

3. The commutator according to claim 1, wherein each of the coupling portions extends along an involute curve.

4. A direct current motor comprising:
a power supplying brush; and
an armature which defines an axial direction, wherein the armature has a commutator to which power is supplied from the power supplying brush, and the commutator includes:
a plurality of segments placed around the axis, wherein a first circumferential direction and a second circumferential direction which is opposite to the first circumferential direction are defined in terms of the circumferential direction, each of the segments has a radially outer end, a radially inner end, and a sliding surface, the power supplying brush slides against the sliding surface, the sliding surface is perpendicular to the axial direction, a segment center line and a radial line are defined for each of the segments in such a manner that the segment center line extends from the center in the circumferential direction of the radially outer end to the center in the circumferential direction of the radially inner end, the radial line extends in the radial direction and passes through the center in the circumferential direction of the radially outer end, and a portion of the segment center line which includes the center in the circumferential direction of the radially inner end is inclined in the first circumferential direction relative to the radial line; and
a short-circuit member for connecting segments to be at the same potential from among the segments, wherein the short-circuit member has a plurality of connection pieces, each of the connection pieces has an outer short-circuit end, an inner short-circuit end and a coupling portion, the outer short-circuit end is connected to the radially outer end, the inner short-circuit end is connected to the radially inner end, and the coupling portion links the outer short-circuit end to the inner short-circuit end, which is shifted in the second circumferential direction from the outer short-circuit end.

5. The direct current motor according to claim 4, wherein the power supplying brush has an end in the first circumferential direction and an end in the second circumferential direction, which respectively extend parallel to the radial line in a state where the radial line passes through the center of the brush, and
wherein each segment has an end in the first circumferential direction and an end in the second circumferential direction, which are respectively inclined relative to the radial line in a state where the radial line passes through the center of the brush.
